(19) United States
(12) Patent Application Publication
(10) Pub. No.: US 2026/0134202 A1
(43) Pub. Date: May 14, 2026

(54) Methods And Systems Of Providing Graphical Representations Of Logical Formulas

(71) Applicant: Northeastern University, Boston, MA (US)

(72) Inventors: Wolfgang Gatterbauer, Brookline, MA (US); Diandre Miguel Sabale, Bothell, WA (US)

(21) Appl. No.: 19/390,059

(22) Filed: Nov. 14, 2025

Related U.S. Application Data
(60) Provisional application No. 63/720,267, filed on Nov. 14, 2024.
(60) Provisional application No. 63/865,916, filed on Aug. 18, 2025.

(51) Int. Cl. G06F 40/177; G06F 40/169; G06F 40/58

(52) U.S. Cl. CPC G06F 40/177; G06F 40/169; G06F 40/58

(57) ABSTRACT

Embodiments provide graphical representations of logical formulae. An example embodiment includes, based on logical scopes from a logical formula, partitioning a graphical space using one or more graphical elements. Tables are placed in the graphical spaced partitioned. At least one table placed includes a table reference based on the logical scopes and a table attribute based on predicates from the logical formula. Based on the predicates and the logical scopes, at least one connection is displayed between the tables placed. The at least one connection indicates a given predicate, and a logical scope of the given predicate is independent of endpoints of the at least one connection. The graphical space partitioned, the tables placed, and the at least one connection displayed provide a graphical representation of the logical formula. Embodiments may provide diagrammatic representations of queries including disjunctions, aggregations, or assignments for human and machine use.

### RELATED APPLICATIONS

This application claims the benefit of U.S. Provisional Application No. 63/720,267, filed on Nov. 14, 2024, and U.S. Provisional Application No. 63/865,916, filed on Aug. 18, 2025. The entire teachings of the above applications are incorporated herein by reference.

### GOVERNMENT SUPPORT

This invention was made with government support under Grant No. NSF CISE U.S. Pat. No. 1,762,268 as awarded by the National Science Foundation. The government has certain rights in the invention.

### BACKGROUND

Visual representations of relational queries, i.e., formulas, have been investigated since the early days of relational databases. While the history of visual query languages is long and rich [13, 38](numbers indicated within brackets correspond to the listing of references included hereinbelow), the challenge of faithfully representing complex logical constructs remains. Already in 1996, Ioannidis [50] lamented that most visual database interfaces may be “ad hoc solutions” and that “there are several hard research problems regarding complex querying and visualization that are currently open.”

### SUMMARY

Embodiments solve these problems.

A fundamental problem that may remain unsolved to this day is the question of how to faithfully represent any relational pattern, e.g., logical disjunction, grouping, aggregate, etc., in a graphical language. An example logical formula that may be represented using embodiments is a logical formula that involves disjunctions. Just like conjunction, disjunction is a fundamental logical operator to combine logical statements, e.g., “color=‘red’ or color=‘blue’”. It is easy in text, but far harder (and unsolved in its full generality) to represent graphically. This may be referred to as the disjunction problem of visual query representations.

Disclosed herein are methods and systems for solving the deficiencies of existing methods, e.g., the disjunction problem of diagrammatic query representations for first-order logic. Embodiments of a method can, given a well-formed Tuple Relational Calculus (TRC) query, produce a diagram that (i) faithfully encodes the query's semantics, (ii) preserves the query's relational structure (i.e., the table references, patterns of joins, and attribute bindings), and (iii) admits an unambiguous and lossless reconstruction of the original query. Prior diagrammatic representation may not satisfy all three properties once disjunctions and/or aggregates are allowed.

An example embodiment is directed to a method of providing a graphical representation of a logical formula. An example embodiment of a method includes, based on logical scopes from a logical formula, partitioning a graphical space using one or more graphical elements. The method further includes placing tables in the graphical space partitioned. At least one table placed includes a table reference based on the logical scopes and a table attribute based on predicates from the logical formula. Based on the predicates and the logical scopes, at least one connection is displayed between the tables placed. The at least one connection indicates a given predicate, where logical scope of the given predicate is independent of endpoints of the at least one connection. The graphical space partitioned using the one or more graphical elements, the tables placed, and the at least one connection displayed provide a graphical representation of the logical formula.

According to an embodiment, the method can further include at least one of (a) parsing the logical formula to (i) extract the logical scopes and (ii) determine a hierarchy of the logical scopes, (b) identifying the tables from the logical formula, and (c) identifying the predicates from the logical formula. In such an embodiment, the partitioning can be based on the logical scopes and the hierarchy.

According to another embodiment, the method can further include translating an initial logical formula into the logical formula. The logical formula may be a canonical logical formula. The logical formula can be well-formed and the graphical representation can be unambiguously translatable into the logical formula.

According to an embodiment, the at least one connection includes at least one annotation. In another embodiment, the method can further include, based on the predicates and the logical scopes, identifying the endpoints of the at least one connection and the logical scope of the given predicate and adding the at least one annotation to the at least one connection displayed based on the endpoints and logical scope of the given predicate identified. In a further embodiment, the adding the at least one annotation can include positioning, based on the endpoints and the logical scope of the given predicate identified, the at least one annotation in the graphical space partitioned. According to another embodiment, the at least on annotation can include a label, an anchor, a line style, or an arrowhead. In another embodiment, the at least one annotation can indicate the given predicate is a join predicate, a selection predicate, an aggregation predicate, or an assignment predicate.

According to an embodiment, the method further includes applying a non-constitutive simplification to the graphical representation provided. The non-constitutive simplification unambiguously preserves semantics of the graphical representation.

According to another embodiment, a given table placed can include a constant based on the predicates from the logical formula. In an embodiment, the constant can include a relation, e.g., less than, greater than, equal to, etc., with respect to the constant.

Another example embodiment further comprises translating the logical formula from a first language to a second language.

According to an embodiment, the at least one connection displayed represents a logical relationship between a first table and a second table of the tables placed.

In another embodiment, each logical scope can be an existential scope, a negation scope, a disjunction scope, or an aggregation scope.

According to an embodiment, each predicate can be a selection predicate, a join predicate, an aggregation predicate, or an assignment predicate.

According to another embodiment, each table placed can be a base table, a virtual table, or an output table.

In another embodiment, the graphical representation can preserve a semantic and a relational pattern of the logical formula.

According to an embodiment, the graphical representation uses a higraph notation. The higraph notation may include a Unified Modeling Language (UML) notation diagram.

According to another embodiment, the logical formula includes a disjunction. In yet another embodiment, the logical formula is a Structured Query Language (SQL) statement.

Another embodiment is directed to a method of providing a graphical representation of a logical formula. Such an embodiment includes, based on logical scopes from a logical formula, partitioning a graphical space using one or more graphical elements. The method further includes placing tables in the graphical space partitioned. At least one table placed includes a table reference based on the logical scopes and a table attribute based on predicates from the logical formula. Based on the predicates and the logical scopes, at least one connection is displayed between the tables placed. The at least one connection (i) indicates a given predicate and (ii) includes at least one annotation unambiguously representing the given predicate as an aggregation predicate or an assignment predicate. The graphical space partitioned using the one or more graphical elements, the tables placed, and the at least one connection displayed provide a graphical representation of the logical formula.

Another embodiment is directed to a computer-implemented system for providing a graphical representation of a logical formula. An example embodiment of a computer-implemented system includes a processor and a memory with computer code instructions stored thereon. The processor and the memory, with the computer code instructions, are configured to cause the computer-implemented system to implement any embodiments or combination of embodiments described herein.

Yet another example embodiment is directed to a computer program product for providing graphical representations of logical formulas. The computer program product includes a non-transitory computer-readable medium with computer code instructions stored thereon. The computer code instructions are configured, when executed by a processor, to cause an apparatus associated with the processor to implement any embodiments or combination of embodiments described herein.

It is noted that embodiments of the methods, systems, and computer program products may be configured to implement any embodiments or combination of embodiments described herein.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is a flowchart of an example embodiment of a method of providing a graphical representation of a logical formula.

FIG. 2A illustrates a prototypical prior approach for representing disjunctions via edges.

FIGS. 2B and 2C illustrate graphical representations of alternative interpretations of the ambiguously represented query of FIG. 2A, according to example embodiments.

FIG. 2D illustrates a graphical representation of a query generated using Relational Diagrams.

FIG. 2E illustrates a graphical representation of query generated using an embodiment.

FIG. 2F illustrates a graphical representation generated using Relational Diagrams preserving semantics of the query of FIG. 2E.

FIG. 3A illustrates an abstract syntax tree representation of a query containing a disjunction.

FIG. 3B illustrates a graphical representation of the query of FIG. 3A, according to an example embodiment.

FIGS. 4A-4J illustrate prior conceptual approaches for representing disjunctions for a given query.

FIG. 5 illustrates an abstract syntax tree representation of a tuple relational calculus query with nested disjunctions

FIGS. 6A and 6B illustrate example representations for selection predicate “R.A<4” with unary anchor relations, according to example embodiments.

FIGS. 6C and 6D illustrate example representations for join predicate “R.A<S.B” with binary anchor relations, according to example embodiments.

FIGS. 6E-6H illustrate placement of operator labels in relational diagrams, according to example embodiments.

FIG. 7A illustrates a pattern-preserving diagrammatic representation with anchor relations, according to an example embodiment.

FIG. 7B illustrates a Relational Diagram of a non-disjunctive fragment of a logical formula.

FIGS. 8A-8I illustrate corresponding graphical representations generated using Relational Diagrams (FIG. 8E) and example embodiments (FIGS. 8A-8D, 8F-8I).

FIGS. 9A and 9B illustrate graphical representations of a query without or with Peirce shading, respectively, according to an example embodiment.

FIGS. 10A-10D illustrate graphical representations of queries without (FIGS. 10A and 10C) or with Peirce shading (FIGS. 10B and 10D), according to an example embodiment.

FIGS. 11A and 11B illustrate graphical representations with Peirce shading applied for queries formulated using TRC^{¬∃∧} and TRC^{¬∃∧∨}, respectively, according to example embodiments.

FIG. 12 illustrates example DeMorgan-fuse boxes with or without Peirce shading, according to an example embodiment.

FIG. 13 illustrates graphical features used in example embodiment and their correspondence with a larger context of visual grammar.

FIGS. 14A-14F illustrate graphical representations generated for conventionally challenging queries using prior representation functionality (FIGS. 14A and 14E) and example embodiments (FIGS. 14B-14D and 14F).

FIG. 15 illustrates results for a fraction of pattern-isomorphic representations among 58 queries, including using an example embodiment.

FIGS. 16A-16C show representations of well-formed TRC queries, according to an example embodiment.

FIGS. 17A-17F illustrate graphical representations of well-formed tuple relational calculus (TRC) queries (FIGS. 17A-17C) and their corresponding abstract syntax trees (ASTs) (FIGS. 17D-17F), according to an example embodiment.

FIGS. 18A-18D illustrate ASTs of logically identical queries.

FIGS. 19A-19D illustrate four variants of graphical representations of a query.

FIGS. 20A and 20B illustrate graphical representations of queries generated using Relational Diagram functionality and an example embodiment, respectively.

FIGS. 20C and 20D illustrate corresponding ASTs of the graphical representations of FIGS. 20A and 20B, respectively.

FIGS. 21A and 21B illustrate sizes of graphical representations of a query of a given size k=4 generated using an example embodiment and Relational Diagrams, respectively.

FIGS. 21C and 21D illustrate AST representations corresponding to the graphical representations of FIGS. 21A and 21B, respectively.

FIGS. 22A-22D illustrate graphical representations, generated using example embodiments for a query with a disjunction, with different visual anchors or features.

FIGS. 23A-23I illustrate representations of queries from textbook benchmarks that Relational Diagrams cannot pattern-represent, according to an example embodiment.

FIGS. 24A and 24B illustrate graphical representations and corresponding queries for a common problem of finding “sailors who reserved all red boots,” according to an example embodiment.

FIG. 25 illustrates an example query and a corresponding graphical representation with grouping and aggregation, according to an example embodiment.

FIG. 26 is a flowchart of an example embodiment of a method for providing a graphical representation of a logical formula.

FIGS. 27A and 27B illustrate a query with an aggregation and a graphical representation generated thereof, according to an example embodiment.

FIGS. 28A-28D illustrate graphical representations and corresponding SQL queries of logical formulae including aggregation predicates and assignment predicates, according to an example embodiment.

FIG. 29 illustrates an example embodiment of a workflow for processing user-input schemas and queries.

FIG. 30 illustrates a table of grammar supported by a tool for generating graphical representations of a logical formula, according to an example embodiment.

FIG. 31 is a diagram of relationships between query languages.

FIGS. 32A and 32B illustrate a corresponding simplified abstract language higraph (ALH) and diagrammatic higraph representation, respectively, of a query, according to an example embodiment.

FIGS. 33A and 33B illustrate SQL queries that have corresponding logical formulae formulated using nested generalized tuple relational calculus (G-TRC), according to an example embodiment.

FIG. 34 illustrates a higraph graphical representation of a G-TRC query, according to an example embodiment.

FIG. 35 illustrates a pattern-preserving higraph graphical representation of a query, according to an example embodiment.

FIGS. 36A and 36B illustrate an abstract syntax tree representation and corresponding higraph representation, respectively, of a query with recursion, according to an example embodiment.

FIGS. 37A and 37B illustrate SQL queries with null behavior, according to an example embodiment.

FIGS. 38A and 38B illustrate a SQL query and corresponding higraph representation, respectively, of a query with an outer join, according to an example embodiment.

FIG. 39 illustrates a higraph representation of a query with arithmetic predicates, grouping, and aggregates, according to an example embodiment.

FIGS. 40A-40F illustrate queries (FIGS. 40A-C) and corresponding graphical representations (FIGS. 40D-F) of count bugs, according to an example embodiment.

FIG. 41 illustrates an abstract language higraph representation of the query represented in FIG. 40F.

FIG. 42 is a schematic view of a computer network in which embodiments may be implemented.

FIG. 43 is a block diagram illustrating an example embodiment of a computer node in the computer network of FIG. 42.

### DETAILED DESCRIPTION

A description of example embodiments follows.

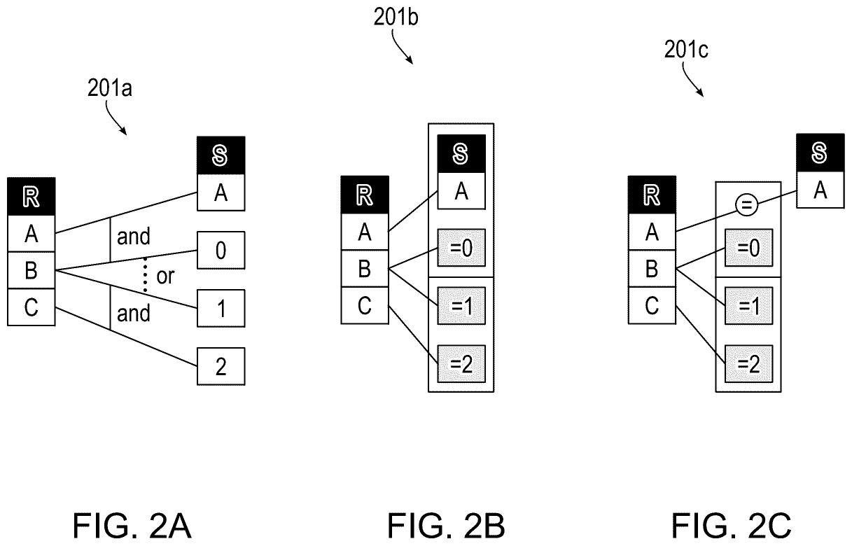

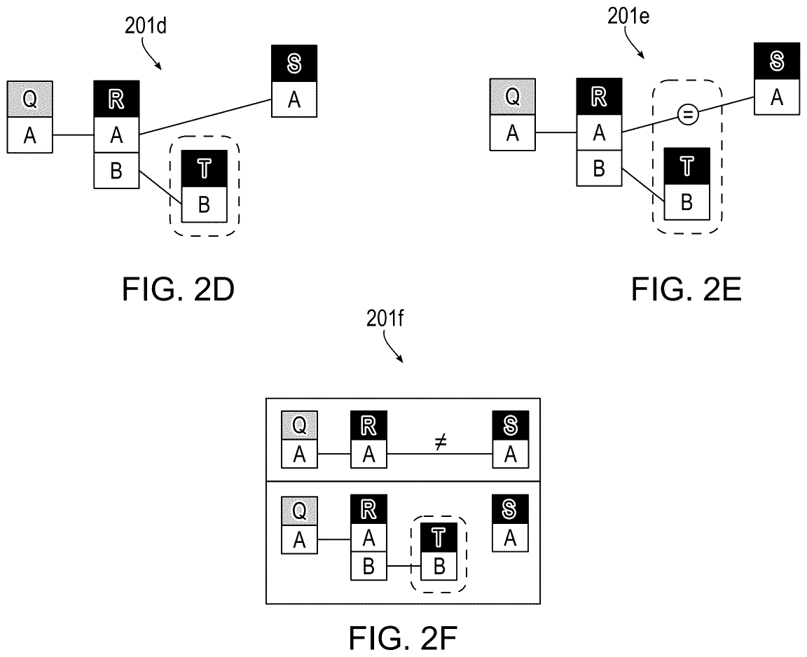

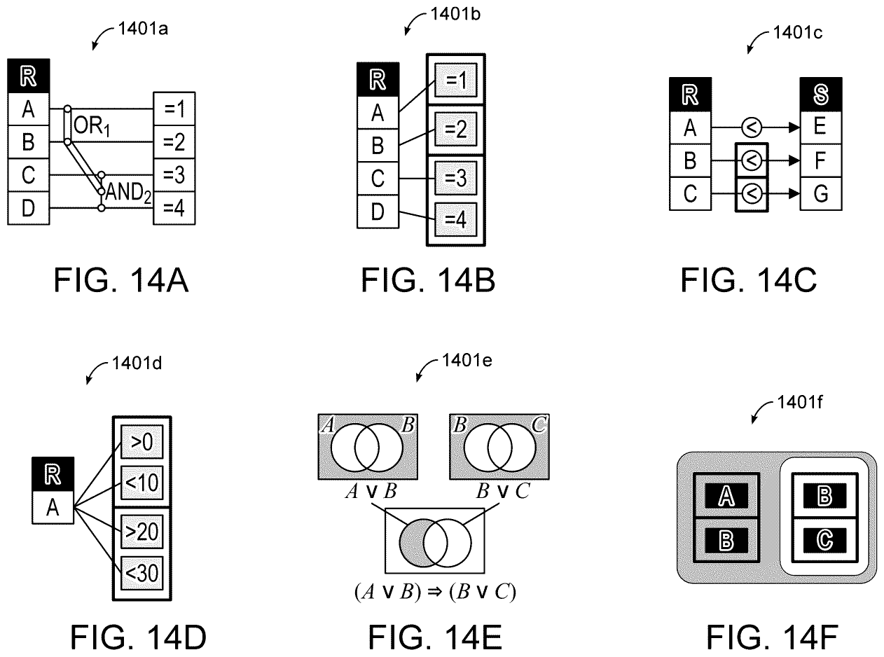

The disjunction problem has vexed researchers for centuries, even for basic First-Order Logic (FOL), which may be similar to relational calculus and thus equivalent in logical expressiveness to relationally complete languages. Peirce [63] mentions the problem in his work regarding Venn diagrams: “It is only disjunctions of conjunctions that cause some inconvenience”. Gardner [35] discusses the challenging disjunction (A∨B)→(B∨C) and concludes that “there seems to be no simple way in which the statement, as it stands, can be diagramed” [35]. Shin [71] in her work on the logic of diagrams writes, “any form of representation for disjunctive information-whether a sign is introduced or not-is bound to be symbolic”. Englebretsen [32], in a review of Shin [70], writes: “In her discussion of perception she shows that disjunctive information is not representable in any system.” Thalheim states [78, 79] that “There is no simple way to represent Boolean formulas” and gives a challenging example (that may be identical to FIG. 14A described hereinbelow up to renaming of constants): R.A=1∨R.B=2∨(R.C=3∧R.D=4). A recent tutorial on visual query representations [38] lists several open problems and the following query, as further described herein with reference to FIG. 2A described hereinbelow, as a challenge: (R.A=S.A∧R.B=0)∨(R.B=1∧R.C=2). A recent paper [39] states in its conclusions that “it is not clear how to achieve an intuitive and principled diagrammatic representation for arbitrary nestings of disjunctions, such as R.A<S.E ∧(R.B<S.F ∨R.C<S.G) or (R.A>0∧R.A<10) ∨ (R.A>20∧R.A<30).”

Intuitively, the disjunction problem may be represented as follows: given any well-formed Tuple Relational Calculus (TRC) query q, construct a diagram Φ(q) such that the following conditions hold: (1) Completeness: every safe TRC query must yield a corresponding valid diagram Φ(q); (2) Soundness: translating Φ(q) back must yield a logically equivalent query Φ⁻¹(Φ(q))≡q (no loss, no ambiguity); (3) Pattern preservation: the diagram Φ(q) must reference the same set of tables as q (this criterion can represent a compactness requirement: the size of the diagram should scale proportionally with the query size, i.e., |Φ(q)|O(|q|)); and (4) Safety preservation: disjunctions in q must be explicitly represented in <Φ(q). The latter point may enable syntactic safety to be determined directly from the diagram as is, without requiring any mental transformations of the diagram.

Disclosed herein is a solution, which may be referred to as “RepresentationB”, to the disjunction problem that can unify, generalize, and overcome shortcomings of prior graphical approaches for disjunction. RepresentationB, according to an embodiment, is a diagrammatic representation of well-formed Tuple Relational Calculus (TRC) that can preserve the relational pattern and the safety of a query. Such embodiments can generalize Relational Diagrams and may generate representations for disjunction-free queries that are identical to representations generated by existing methods. Moreover, embodiments can provide representations that are more general and exponentially more concise. Embodiments can also preserve the safety conditions of TRC, and may be useful for achieving 100% pattern coverage on recently proposed textbook benchmarks.

As used herein, disjunction functionality of embodiments may solve the problem of showing diagrammatically a logical or (either A or B is true), for example, find me cars that are either blue or red. Embodiments may additionally be helpful for showing diagrammatically inclusive disjunctions, wherein one or all parts of a logical statement are true.

As used herein, an aggregation functionality may build upon the disjunction functionality and solve a larger fragment. For example, find students at a university who took more than five classes last semester. This query may require a grouping operator (find all classes taken by each student and group them together) and an aggregation operator (count the number of classes per student).

An example embodiment, e.g., RepresentationB, can proceed in two steps: a rigorously defined representation is given that replaces join and selection predicates with anchor relations and uses DeMorgan to replace disjunctions. This approach can solve the disjunction problem (because it can provide anchors to predicates and, therefore, precise meaning in arbitrary nestings). However, it can result in a cluttered representation that can lose the safety conditions of TRC. The anchor relations can then be substituted with prior visual formalisms (while keeping the formal semantics of anchor relations) and a box-based visual shortcut can be added for disjunction that brings back the safety conditions. Definitions of boxes as disclosed herein can allow disjunctions at any nesting level, while prior box-based approaches restrict disjunctions to be at a root level. It may be noted that, as defined, RepresentationB enables placement of predicates in arbitrary scopes (a scope of a predicate may be different from scopes of table attributes of the predicate).

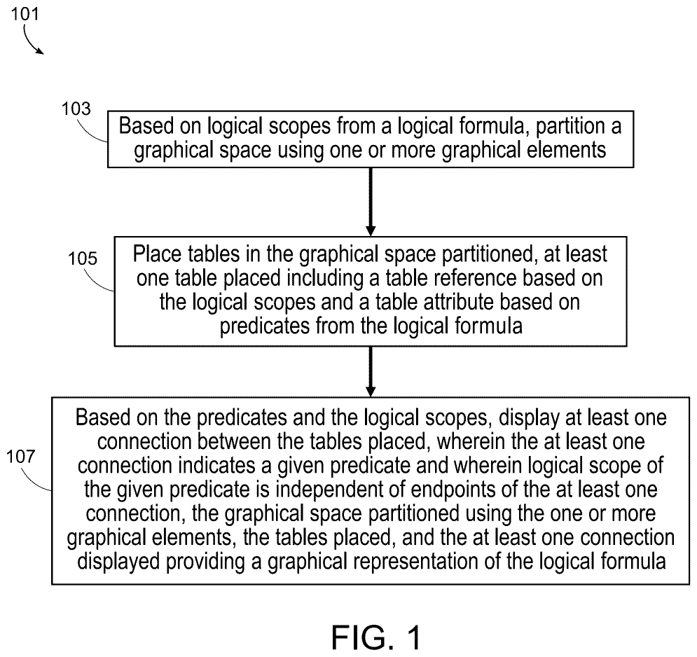

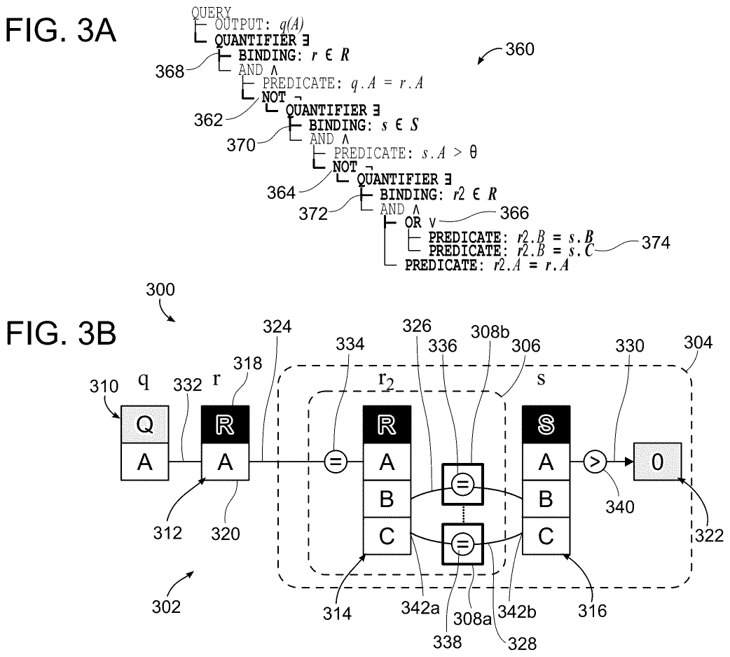

FIG. 1 is a flowchart of an example embodiment of a method 101 of providing a graphical representation of a logical formula. According to the example embodiment, the method 101, e.g., RepresentationB, may be carried out for a given query, e.g., the query 360 described herein with respect to FIG. 3A, (i.e., logical formula) by, based on logical scopes from a logical formula, partitioning 103 a graphical space using one or more graphical elements. The method 101 further includes placing 105 tables in the graphical space partitioned. At least one table includes a table reference based on the logical scopes and a table attribute based on predicates from the logical formula. The method 101 further includes, based on the logical scopes and the predicates, displaying 107 at least one connection between the tables placed. The at least one connection indicates a given predicate and logical scope of the given predicate is independent of endpoints of the at least one connection. For example, a predicate may include operands, which may be table attributes, and an operator, which may indicate a relation between the operands. According to an embodiment, a logical scope of the operator can be in a different scope of the logical scopes from the endpoints, e.g., the operands or table attributes. For example, the operator itself may belong to a more nested scope in a hierarchy of the logical scopes than the tables, as illustrated herein by the annotation 336 of the graphical representation 300 of FIG. 3B. The graphical space partitioned using the one or more graphical elements, the tables placed, and the at least one connection displayed provide a graphical representation of the logical formula.

As used herein, a graphical space, e.g., the graphical space 302 of FIG. 3B, can be a space or canvas used for a graphical or visual representation.

A graphical element, e.g., the graphical elements 304, 306, 308a, 308b of FIG. 3B, can be a representation of a partition. Non-limiting examples of a graphical element can include a box, a circle, or a line. In some embodiments presented herein, the graphical element can be a box with rounded corners and solid, dashed, or double lines.

Tables, e.g., the tables 310, 312, 314, 316, 322 of FIG. 3B, can include elements placed within the graphical representation. Tables can include table references, e.g., table reference 318 of FIG. 3B (for example, a quantified reference to a base, virtual or output table in a query expression, which may also be referred to as an existential scope, e.g., the quantifiers 368, 370, 372 of FIG. 3A), table attributes, e.g., the table reference 320 of FIG. 3B (for example, an operand of a predicate, e.g., the predicate 374 of FIG. 3A, which may be an instance or variable of a given table reference), or constants.

A connection, e.g., the connections 332, 324, 326, 328, 330 of FIG. 3B, can be a graphical feature that indicates an association between tables. For example, with reference to FIG. 3B, the connection 328 connects to the table 314 and the table 316 at the endpoints 324a, 324b. According to some embodiments, a connection can be a line or a line with an annotation, e.g., the annotations 334, 336, 338, 340 of FIG. 3B.

According to an embodiment, the method 101 can further include at least one of (a) parsing the logical formula to (i) extract the logical scopes and (ii) determine a hierarchy of the logical scopes, (b) identifying the tables from the logical formula, and (c) identifying the predicates from the logical formula. In such an embodiment, the partitioning 103 can be based on the logical scopes and the hierarchy.

According to another embodiment, the method 101 can further include translating an initial logical formula into the logical formula. The logical formula may be a canonical logical formula. The logical formula can be well-formed and the graphical representation can be unambiguously translatable into the logical formula.

According to an embodiment, the at least one connection includes at least one annotation. In another embodiment, the method 101 can further include, based on the predicates and the logical scopes, identifying the endpoints of the at least one connection and the logical scope of the given predicate and adding the at least one annotation to the at least one connection displayed based on the endpoints and logical scope of the given predicate identified. In a further embodiment, the adding the at least one annotation can include positioning, based on the endpoints and the logical scope of the given predicate identified, the at least one annotation in the graphical space partitioned. According to another embodiment, the at least on annotation can include a label, an anchor, a line style, or an arrowhead. In another embodiment, the at least one annotation can indicate the given predicate is a join predicate, a selection predicate, an aggregation predicate, or an assignment predicate.

According to an embodiment, the method 101 further includes applying a non-constitutive simplification to the graphical representation provided. The non-constitutive simplification unambiguously preserves semantics of the graphical representation.

In an embodiment of the method 101, a given table placed can include a constant based on the predicates from the logical formula. In an embodiment, the constant can include a relation, e.g., less than, greater than, equal to, etc., with respect to the constant.

Another example embodiment further comprises translating the logical formula from a first language to a second language. For example, mapping from natural language to a query language, e.g., Structured Query Language (SQL), may be difficult. Queries may be mapped, for example, from natural language into a graphical representation of a logical formula and subsequently into another language, e.g., SQL or TRC.

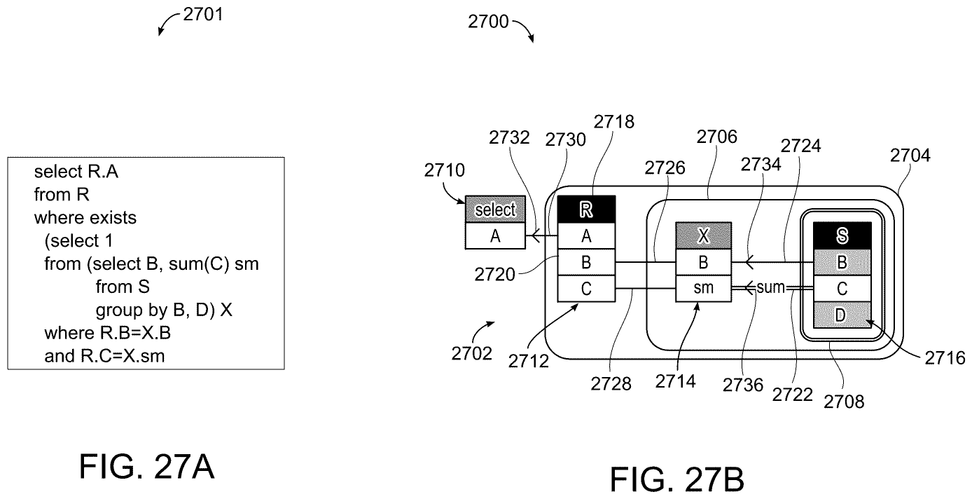

According to an embodiment, the at least one connection displayed represents a logical relationship between a first table and a second table of the tables placed. In another embodiment, each logical scope can be an existential scope, a negation scope, a disjunction scope, or an aggregation scope. According to an embodiment, each predicate can be a selection predicate, a join predicate, an aggregation predicate, or an assignment predicate. According to another embodiment, each table placed can be a base table (e.g., the tables 2712, 2716 described herein with respect to FIG. 27B), a virtual table (e.g., the table 2714 described herein with respect to FIG. 27B), or an output table (e.g., the table 2710 described herein with respect to FIG. 27B).

In another embodiment of the method 101, the graphical representation can preserve a semantic and a relational pattern of the logical formula.

According to an embodiment of the method 101, the graphical representation uses a higraph notation. The higraph notation may include a Unified Modeling Language (UML) notation diagram.

According to another embodiment, the logical formula includes a disjunction. In yet another embodiment, the logical formula is a Structured Query Language (SQL) statement.

FIG. 2A illustrates a graphical representation 201a generated using a prototypical prior approach for representing disjunctions via edges. The prior approach is represented using a query as referenced herein from [38]: (R.A=S.A∧R.B=0)∨(R.B=1∧R.C=2). Such edge-based approaches are incomplete as they leave details of quantification ambiguous (as illustrated and described below) and additionally require symbolic annotations to determine precedence of operators.

FIGS. 2B and 2C illustrate graphical representations 201b and 201c, respectively, of alternative interpretations of the ambiguously represented query of FIG. 2A, according to example embodiments. The graphical representations 201b and 201c include precise semantics and can pattern-represent any well-formed TRC query. Unlike FIG. 2A, which may be ambiguously quantified as either query (19) or query (20) described hereinbelow, embodiments, e.g., method 101, for providing graphical representations of a logical formula can distinctly and unambiguously represent query (19) (FIG. 2B) and query (20) (FIG. 2C).

A summary of a method (e.g., RepresentationB), according to an embodiment, of providing a graphical representation of a logical formula is provided herein prior to providing a more in-depth overview of diagrammatic representations.

FIG. 2D illustrates a graphical representation 201d of a query generated using Relational Diagrams. In particular, the query is: {q(A)|∃r ∈ R, s ∈ S[q.A=r.A∨r.A=s.A∨¬(∃t ∈ T[t.B=r.B])]}. It may be noted that prior approaches, including relational diagrams, may be capable of representing such a query. Predicates, e.g., q.A=r.A, can be shown as long as the predicates are in the same logical scope as one of their end points (in particular, the more nested logical scope). Here, r.A=s.A is in the same scope as r/R and s/S.

FIG. 2E illustrates a graphical representation 201e of query generated using an example embodiment. In particular, the query is: {q(A)|∃r ∈ R, s ∈ S[q.A=r.A∨¬(∃t ∈ T[r.A=s.A∨t.B=r.B])]}. Prior methods of providing a graphical representation of a logical formula may not be capable of generating a diagrammatic representation of the foregoing query in a pattern-preserving way (i.e., using the same number of tables as in the query). The predicate r.A=s.A can now lie in a different logical scope (a nested negation) than both of its end points r/R and s/S.

FIG. 2F illustrates a graphical representation 201f generated using Relational Diagrams preserving semantics of the query of FIG. 2E. To preserve the semantics of the above query using a logically equivalent query (but with a different pattern), prior work may need to transform the query into a union of two queries. In particular, an updated query visualized in FIG. 2F is: {q(A)|∃r ∈ R, ∃s ∈ S[q.A=r.A ∧r.A≠s.A]}∪{q(A)|∃r ∈ R, ∃s ∈ S[q.A=r.A ∧¬(∃t ∈ T[t.B=r.B])]}. In each of these two queries joined by the union, every predicate now lies within the logical scope of at least one of the two end points of the predicate. The resulting logically equivalent query has a different pattern (it uses a different number of tables than the original query).

FIG. 3A illustrates an abstract syntax tree representation 360 of a formula, i.e., query, containing a disjunction: {q(A)|∃r ∈ R[q.A=r.A ∧¬(∃s ∈ S[s.A>0 ∧¬(∃r₂ ∈ R[((r₂. B=s. B)∨(r₂.C=s.C))∧r₂. A=r.A])])])]}.

FIG. 3B illustrates a graphical representation 300 of the formula 360 of FIG. 3A, according to an example embodiment. The graphical representation 300 includes a graphical space 302 partitioned using graphical elements 304, 306, 308a-b based on logical scopes from a logical formula. As illustrated, negation scopes (not) can be illustrated using dashed lines 304, 306 and disjunctions can be represented as fuse boxes 308a-b. Other scopes may further be represented using other graphical elements. Range variables, e.g., q, r, r2, and s may be illustrated for clarity but may not be needed as part of the graphical representation 300.

The graphical representation 300 further includes tables 310, 312, 314, 316, 322 placed within the graphical space 302. At least one table, e.g., the table 312, includes a table reference 318 based on the logical scopes and a table attribute 320 based on predicates from the logical formula. The table 322 also includes a constant 0. The tables 310, 312, 314, 316 can be placed in the graphical space 302 based on a logical scope to which each table belongs. Table 310 is an example of an output table which indicates output of the query 360.

The graphical representation further includes displaying connections 324, 326, 328, 330, 332 which can indicate a relationship between a given predicate and a given logical scope. The connections can further include annotations 334, 336, 338, 340. The annotations 336, 338, for example, indicate that the equality predicates r2.B s.B and r2.C s.C belong within the disjunction graphical element 308b. Annotations may include, for example, operators of predicates, including equality (=), greater than (>), or less than (<). In some embodiments, annotations may include other functions such as aggregation or summation.

In some embodiments, the tables 312, 314, 316, 322 may be placed with respect to the graphical elements 304, 306, 308a, 308b based upon a hierarchy of logical scopes of the query 360. For example, the query 360 includes negation scopes 362, 364 (as indicated by “NOT ¬”) and a disjunction scope 366 (as indicated by “OR V”). With respect to a hierarchy of the logical scopes, the disjunction scope 366 is nested within the negation scope 364, which is in turn nested within the negation scope 362.

The tables 312, 314, 316, 322, which may be declared using quantifiers and bindings 368, 370, 372, may be placed in the scope based their respect with the scopes of query 360. For example, quantifier 368 exists outside of the negation scopes 362, 364 and the disjunction scope 366. Accordingly, the table 312 is placed outside the graphical elements 304, 306, 308a, 308b. Similarly, the table 314 corresponds with the quantifier 370 and the table 316 with the quantifier 372.

The connections 332, 324, 326, 328, 330 and, in particular, the annotations 334, 336, 338, 340, may indicate a given predicate and a logical scope of the predicate can be independent of the endpoints 342a, 342b of the predicate. For example, the predicate 374 corresponds with the connection 328 that includes endpoint 342a connecting to table attribute C of table 314 and endpoint 342b connecting to table attribute C of table 316. The connection 328 connects the corresponding table attributes of the table 314 and the table 316. However, the predicate 374 lies within the disjunction scope 366 (as indicated by the graphical element 308a, 308b), whereas table 314 lies within the negation scope 364 (as indicated by the graphical element 306) and the table 316 lies within the negation scope 362 (as indicated by the graphical element 304). The annotation 338 of the connection 328 can be placed within the graphical element 308a to indicate the appropriate relation. Such a feature allows predicates to be placed within arbitrary or arbitrarily nested logical scopes.

The description herein discloses: (1) background and problem definitions; (2) classes of prior approaches for presenting disjunctions and discusses the challenges; (3) a notation developed for Tuple Relational Calculus (TRC), its safety conditions, the notion of pattern expressiveness based on an Abstract Syntax Tree (AST) representation of TRC, the AST being in a 1-to-1 correspondence to later introduced diagrammatic representations; (4) a preliminary solution to the disjunction problem, the solution relying upon anchor relations that represent constants and built-in predicates, and a DeMorgan-based transformation of TRC. While complete, it can be practically unsatisfying due to its visual clutter and the fact that it may not preserve explicit safety conditions of TRC; (5) replacing the anchor relations with prior visual formalisms yet keeping rigorous and principled semantics. As disclosed herein, visual symbols for disjunctions called DeMorgan-fuse box can allow explicit checks regarding the safety of a query. This addition leads to example embodiments, e.g., RepresentationB; (6) perceptual choices and how fuse boxes can unify and generalize prior approaches for disjunction; (7) solutions to the challenging queries and a demonstration of 100% pattern coverage over a database textbook benchmark.

While prior work may show that diagrammatic representations can help users understand relational structures faster and more reliably [39, 54, 60], such a claim may not be a goal or the only goal of the representations described herein. However, the presentations generated by embodiments provide feasibility and expressiveness, which may be similar to other work within the community studying what can or cannot be achieved in diagrammatic representations [11, 15, 18, 34, 55]. Embodiments described herein may provide pattern-preserving diagrammatic representation of TRC and, thus, a complete solution to the disjunction problem (Theorem 7, as described herein). The embodiments may further provide an exponentially more concise representation than prior work (Proposition 10, as described herein).

### Formal Background and Problem Statement

The notion of a diagrammatic representation may be used synonymously with one that is visual, graphical, or non-symbolic (in contrast to textual or symbolic). A logical diagram, according to a non-limiting embodiment, may be defined as follows:

Definition 1 (Logical Diagram). A logical diagram is a graphical representation of a logical formula in which the topological relationships between its elements represent logical relationships between the elements of the formula.

Topological relationships can be spatial relations that remain invariant under continuous deformations, such as connectivity, containment, and adjacency. Intuitively, in order for a representation to be called diagrammatic, it may need to show joins (i.e., the relationships between tables) as edges between the respective table attributes, and it cannot contain non-atomic logical sentences that require symbolic interpretation of logical connectives, such as “A=1 V A=2”. This definition may capture an essence of many prior definitions of diagrams. For example, prior definitions may include:
“Diagram: a simplified drawing showing the appearance, structure, or workings of something; a schematic representation” [52].
“Diagram: a graphic design that explains rather than represents; especially: a drawing that shows arrangement and relations (as of parts)” [58].
“The relationships established between two sets of elements constitute a diagram” [9].
“Logic diagram: a two-dimensional geometric figure with spatial relations that are isomorphic with the structure of a logical statement” [35].

While the relationships between elements can be captured diagrammatically, the elements themselves can be represented as text. This is because relation names and attribute names may not constitute relational information themselves. For example, the string “Sailor” can still be used to represent the name of a relation called “Sailor” (instead of an icon with domain-specific interpretation) and similarly with an attribute named “name”. However, the fact that “Sailor” is the name of a relation, and the fact that “name” is one of its attributes can constitute relationships. This separation of information carried by individual elements via text from relational information that can be read diagrammatically may constitute a key motivation of diagrammatic representations and visualizations in general. In the case of diagrams, topology may focus on the relations between elements rather than the individual elements themselves. Scott McCloud's work on understanding comics [57] shows that using text to convey part of the information can free up the image to focus on other content, and vice versa. In the case of diagrams, it may be the topology that focuses on the relations between elements rather than the individual elements themselves. Hearst's discussion [47] of the complex interactions when combining text with visualizations and many references therein may also be relevant.

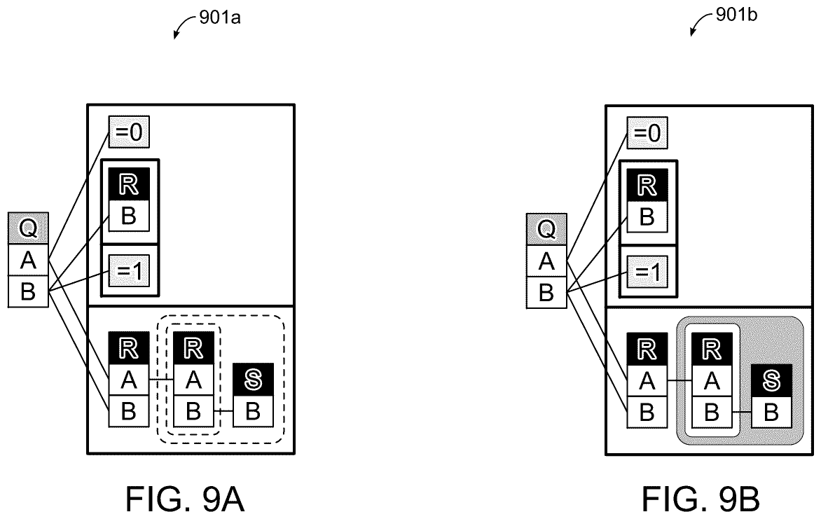

De Toffoli [80] distinguishes between “constitutive” and “enabling” features of a notational system. Constitutive features can have precise mathematical meaning and can be essential to interpret the notation correctly (e.g., topological relationships). Enabling features can facilitate interpretation and may not be essential (e.g., colors or relative sizes). This distinction may be helpful for discussing non-essential features of a given representation, such as those described herein with respect to FIGS. 9A-B, 10A-D, 11A-B, and 12. Similar distinctions have been made many times throughout history, e.g., by Manders [56] who contrasts “co-exact” attributes of a diagram (in essence, topological attributes) from “exact” attributes (geometric attributes that are unstable under perturbations, like size and shape), and by Green and Petre [45] who contrast “formal semantics” from “secondary notation” (such as color and grouping of related statements) that “have no place in the formal semantics” yet “could make a substantial difference in the readability.”

A goal of the work disclosed herein includes finding an unambiguous diagrammatic representation of logical formulas that can preserve a structure of the diagrammatic representation, even with arbitrary disjunctions. To formalize this problem, the notion of a query's relational pattern [40], which can give precise meaning to a query's relational structure, can be used. A table reference can be denoted as any quantified reference to a base table in a query expression. For example, the SQL query “SELECT . . . FROM R as R1, R as R2 WHERE . . . ” can have two table references “R” to the same base table R. A signature S of a query q can be denoted as the set of all the query's table references. Each table reference can be treated as a reference to a distinct base table (i.e., a fresh input table) and the resulting query can be called the dissociated query q′ over the dissociated signature S′. The above SQL query can therefore be converted as “SELECT . . . FROM R1 as R1, R2 as R2 WHERE . . . ”. Finally, the logical function defined by q′ can be defined as the relational pattern of q:

Definition 2 (Relational pattern [40]) according to a non-limiting example embodiment. Given a query q with signature S. The relational pattern of g is the function defined by its dissociated query q′ (S′).

The intuition behind this formalism may include the dissociated query defining a logical function that maps the relation values represented by a set of table references (not just a set of base tables) to an output table (an output relation value). For the SQL example presented hereinabove, the dissociated query can describe a function mapping any database instance with two tables R1 and R2 to an output table. Thus, the dissociated query can be a semantic definition of a relational query pattern that can be applied to any relational query language and that can be used to compare the relative pattern expressiveness of different languages. Two relational queries q₁ and q₂ then can use the same relational pattern (they are pattern-isomorphic) if their dissociated queries are logically equivalent, up to renaming and reordering of their relation variables and constants (i.e., there is a mapping between the relation variables of their dissociated queries that preserves logical equivalence). In that case, q₂ can be considered a pattern preserving representation of q₁, and vice versa(v.v).

These notations enable the conditions (1)-(3 with respect to completeness, soundness, and pattern preservation described hereinabove to be reformulated:

Definition 3 (Disjunction problem) according to a non-limiting example embodiment. The disjunction problem of diagrammatic query representations is to find a pattern-isomorphic diagrammatic representation for any valid First-Order Logic (FOL) formula, with precise and unambiguous bidirectional translations.

A given solution to the first problem may have no dedicated symbol for disjunctions and can express them indirectly with DeMorgan representation. However, although not strictly necessary, a disjunction operator may be useful as replacing it with double-negations in logic and language can complicate understanding. With regards to disjunctions and diagrams, having an explicit symbol for disjunction could be useful for avoiding otherwise nested negations.

Another case for having an explicit disjunction symbol can include safety restrictions being defined via syntactic criteria. Ullman's safety criteria [84] may not be invariant under equivalence and may be applied directly to the formula as written. Ullman's safety criteria [84] do not require any transformation and may thus also be referred to as syntactic safety [42]. As a minimum example, the query {q(A)|¬(¬(∃r ∈ R[q.A=R.A]))} is not Ullman-safe, but its logically equivalent formula {q(A)|∃r ∈ R[q.A=R.A]} is. As a consequence, a transformation of a safe formula via DeMorgan may lead to an unsafe formula. A simplified example by Ullman [84] is presented hereinbelow:

### Example 1 (Union of Queries). Consider Two Unary Tables R(A) and S(A) and the TRC Query

$$\{ q ( A ) \vert ∃ r ∈ R [ q \cdot A = r \cdot A ] ∨ ∃ s ∈ S [ q \cdot A = s \cdot A ] \} \qquad ( 1 )$$

This query is Ullman-safe [84]. The disjunction can be removed by using DeMorgan. However, the resulting query is now not Ullman-safe due to the outer negation (¬) operator [84]:

$$\{ q ( A ) \vert ¬ ( ¬ ( ∃ r ∈ R [ q \cdot A = r \cdot A ] ) ∧ ¬ ( ∃ s ∈ S [ q \cdot A = s \cdot A ] ) ) \} \qquad ( 2 )$$

Several alternative notions of safety have been proposed that may apply increasingly powerful sets of syntactic rewrite-rules before determining safety (an overview is presented hereinbelow). However, determination of safety explicitly from the formula as written, without any mental transformation (which may be similar to Ullman's), may be desirable. This may require an explicit visual device for disjunction. Condition (4) disclosed hereinabove with respect to safety preservation can thus be reformulated as:

Definition 4 (Safety preservation) according to a non-limiting example embodiment. A diagrammatic query representation preserves safety if it allows deciding a formula's syntactic safety directly from the diagram.

### Prior Works And Approaches For Disjunctions

Visual query languages for writing queries have been investigated since the early days of databases and a 1997 survey [13] has already over 150 references, with examples such as Query-By-Example (QBE) [89] and Query By Diagram (QBD) [5, 14]. Today, many commercial and open-source database systems have rudimentary graphical SQL editors, such as SQL Server Management Studio (SSMS) [75], Active Query Builder [4], QueryScope from SQLdep [65], MS Access [59], and PostgreSQL's pgAdmin3 [64]. Also, new direct manipulation visual interfaces are being developed, such as DataPlay [2, 3] and SIEUFERD [7]. More recently, visual query representations have been proposed for the inverse functionality of understanding queries, with notable examples VisualSQL [51], QueryVis [22, 54], and SQLV is [60].

Seemingly disconnected from these developments, the diagrammatic reasoning community [25, 44, 48] studies diagrammatic representations that have sound and complete inference rules. Most noteworthy may be Shin [70], which proves that a slight modification of Venn-Peirce diagrams constitutes a sound and complete diagrammatic reasoning system for monadic FOL. Many variants of diagrammatic reasoning systems have since been proposed [53]. However, neither of these proposals can represent general polyadic predicates (the maximum are dyadic relations [77], many of them may be either not sound or not complete [77], and neither of them may allow pattern isomorphic representations, even for the fragments of logic that they cover (most often, they cannot handle arbitrary disjunctions).

Recent tutorials from the International Conference on Very Large Data Bases (VLDB) and International Conference on Data Engineering (ICDE) [37, 38] surveyed diagrammatic representations within and outside the database community and listed diagrammatic representations of disjunction as an open problem.

Relational Diagrams [39] provide a relationally complete and unambiguous method for representing safe TRC. Relational Diagrams can use unified modeling language (UML) notation for tables and their attributes and can represent negation scopes with hierarchically nested dashed rounded rectangles that partition the canvas into zones (compartments). Join predicates can be shown with directed arrows and optional labels on the edges. However, Relational Diagram generated representations (like all prior diagrammatic representations) may be insufficient for faithfully representing relational patterns involving disjunctions. To represent disjunctions, Relational Diagrams first require a transformation that duplicates binding atoms (i.e., add new table references), which changes the relational pattern (Example 3 illustrates this transformation). The intuitive reason can include the fact that a negation like ¬(R.A=S.A∧ . . . ) does not apply to either of the tables R nor S, but the equality predicate as a whole. This predicate can be represented by a line, which may not be easily confined to a negation scope.

Embodiments of diagrammatic representation are described herein, which may be referenced as RepresentationB, that can represent all relational patterns of TRC (i.e., it is pattern-complete for TRC) and are backward compatible with Relational Diagrams (every Relational Diagram has an identical representation as an embodiment (e.g., RepresentationB), but not vice versa). Interestingly, this generalization may be achieved by redefining existing visual notations and giving them a stricter semantic interpretation. The present representation may not only preserve the table signature (the relation variables), but also the join and selection predicates, and thus all atoms from a given TRC query.

A summary of five prior conceptual approaches for representing disjunctions are presented herein. The approaches are exemplified using the query ∃r ∈ R[r.A=1∨r.A=2] and use a standardized and often simplified notation that focuses on key visual elements.

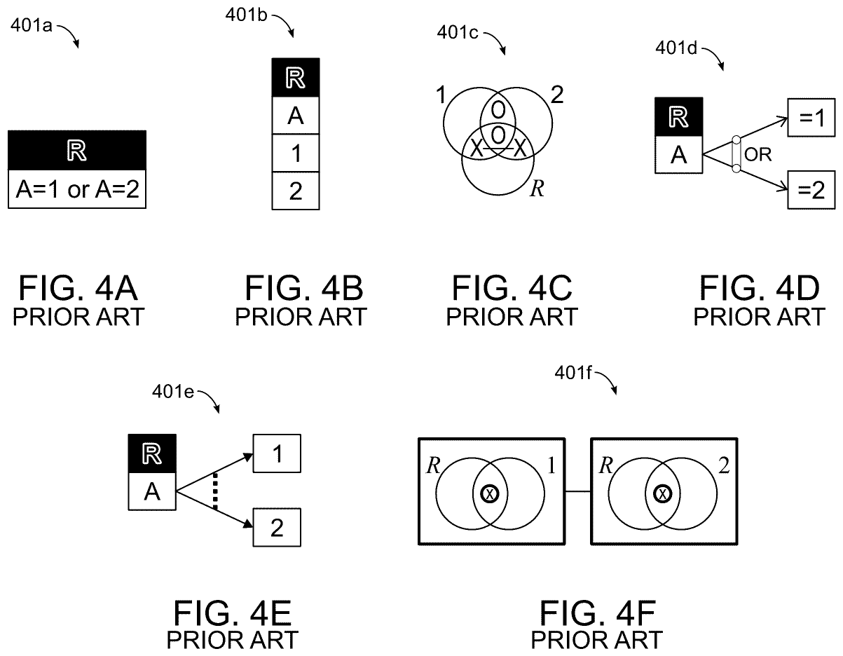

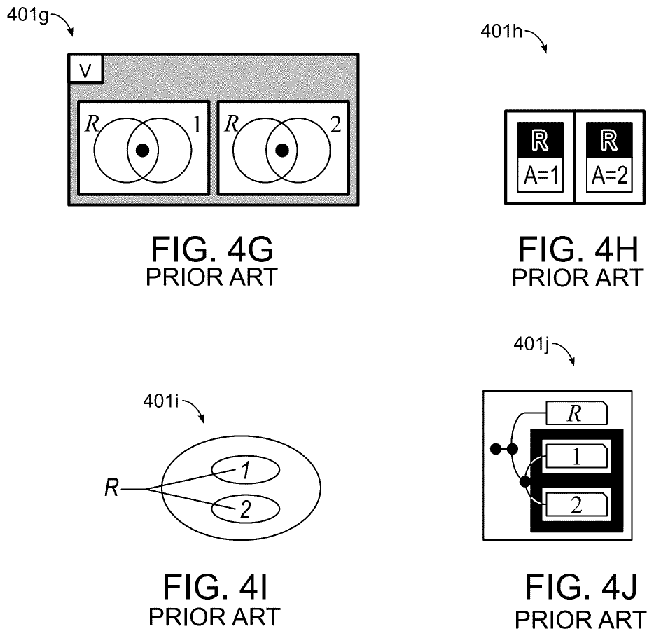

FIGS. 4A-4J illustrate prior conceptual approaches for representing disjunctions for a given query.

FIG. 4A illustrates an example representation 401a of a text-based disjunction. Logical formulas can be kept as text in text-based disjunctions. This approach is not diagrammatic and is listed herein only for completeness. Example uses are condition boxes by QBE [89] and handling of simple disjunctions by Dataplay [3].

FIG. 4B illustrates an example representation 401b of a vertical form-based disjunction. For form-based disjunctions, including the exemplified vertical form-based disjunction using QBE [89], two separate rows may be filled with alternative information. Recent visual query representations, for example, SQLV is [60], may adopt such an approach for simple disjunctions. However, this formalism may not allow disjunctions between join predicates and selection predicates (e.g., ∃r ∈ R[r.A=1∨∃s ∈ S[r.A=s.A]]) or nested disjunctions. In some embodiments, for example, Datalog [16], disjunctions may be expressed with repeated rules and each rule has a new relation variable. Thus, it does not preserve the pattern: Q: −R(1). Q: −R(2).

FIGS. 4C-4E illustrate example representations 401c-e, respectively, of edge-based disjunctions. Charles Sanders Peirce [63] extended Venn diagrams [85] with edges between “O” and “X” markers to express disjunctions. An “O” may indicate that the partition is empty (false). An “X” may indicate that there is at least one member (true). A line between two markers means that at least one of these statements is true (FIG. 4C). Connecting disjunctive predicates via lines of various forms has been suggested, e.g., by VQL [61], VisualSQL [51](FIG. 4D), and QueryViz [22](FIG. 4E). Edges may have been proposed for disjunctive filters within the same table and may be incapable of representing more complicated formulas, for example, queries (19) and (20) described hereinbelow.

FIGS. 4F-4H illustrate example representations 401f-h of box-based disjunctions. Peirce proposed another solution to disjunctions [63], putting unitary Venn diagrams into rectangular boxes and interpreted adjacent boxes as alternatives, i.e., disjuncts. FIG. 4F illustrates an example box-based disjunction 401f by Shin [70] wherein back lines can be added between boxes. FIG. 4G illustrates another example representation 401g including Spider diagrams [49], wherein the lines between boxes can be removed and are placed in a larger “box template” with explicit labels. Relational diagrams [39] can represent a union of queries via adjacent “union cells,” as illustrated by representation 401h in FIG. 4H. Prior box-based approaches may represent disjunctions as unions of well-formed diagrams. Embodiments of the methods and corresponding systems as described herein may allow and provide a well-defined semantics to disjunctions of local expressions deeply nested within diagrams.

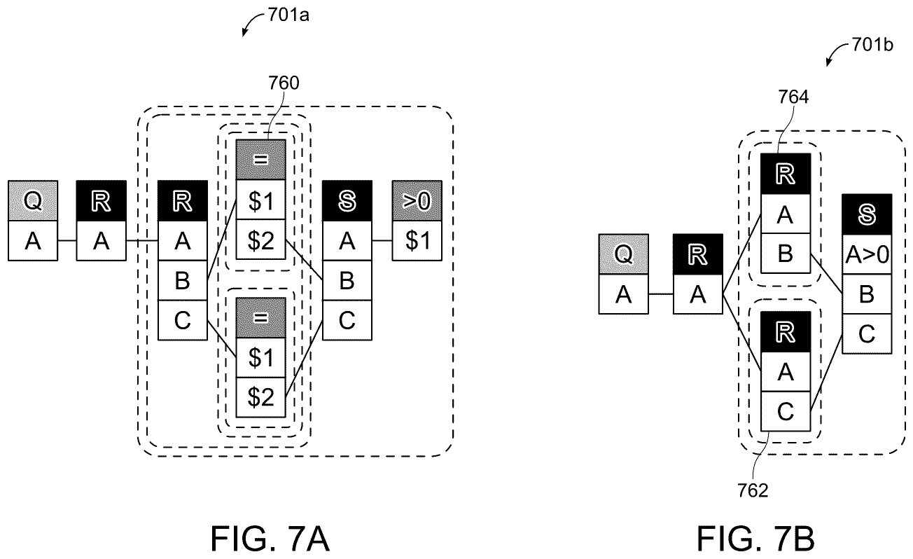

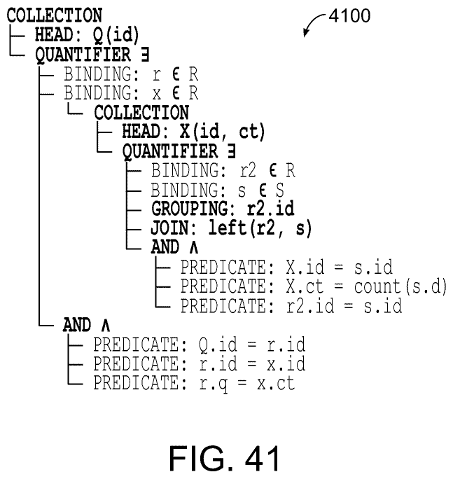

FIGS. 4I and 4J illustrate example representations 401i and 401j, respectively, of DeMorgan-based disjunctions. DeMorgan-based disjunctions may include representations that use only symbols for negation and conjunction, and apply negation in a nested way in accordance with the logical identity A ∧ B=¬(¬A ∨¬B). FIG. 41 illustrates an example Peirce's beta existential graphs [63], which utilize closed curves to express negation and juxtaposition for conjunctions. FIG. 4J illustrates another example of a DeMorgan-based disjunction as string diagrams [10, 46], wherein bound variables can be represented by a dot at the end of lines. Such prior DeMorgan-based approaches may be incapable of representing arbitrarily nested logical conditions, such as the ones presented herein, since predicates (often expressed by lines) can lack stable anchor points for negation. As described hereinbelow with reference to FIG. 7A, anchor relations may be useful for solving this problem by providing stable references for negation scopes.

### Tuple Relational Calculus (TRC)

An example method of providing a graphical representation described herein can have a direct and, hence, pattern-preserving mapping from any safe TRC query. Definitions of notions may be important for proving the foregoing statement, and formalisms used herein may be inspired by existing art [1, 30, 66, 68, 72, 84] on relational calculus and may streamline the formalisms. Example 2 as disclosed hereinbelow may provide an end-to-end example.

Well-formed TRC formulae: Given a relational vocabulary R={R1, R2, . . . }. A TRC formula can contain 3 types of atoms:
(1) Binding atoms: “r ∈ R”, where r is a tuple variable and R ∈ R is a relation.
(2) Join predicates: “r. Aθ s.B”, where r and s are tuple variables, A and B are attributes from r and s respectively, and θ is an arithmetic comparison operator from {<, ≤, =, ≠, >, ≥}.
(3) Selection predicates: “r. Aθ c”, where r, A, and θ are defined as before, and ⊏ is a constant.

A (tuple) variable may be considered to be free unless it is bound by a quantifier (3, V). (Well-formed) formulas may be built up inductively from atoms with the following 3 families of formation rules:
(1) An atom is a formula.
(2) If φ₁, φ₂, . . . , φₖ are formulas, then so are ¬(φ₁), (φ₁→φ₂), (φ₁∨φ₂ ∧ . . . ∧ φₖ), and (φ₁∧φ₂ ∧ . . . ∧φₖ).
(3) If φ is a formula and R₁, . . . , Rₖ are relations from R, then (∃r1 ∈ R₁, . . . , ∃rk ∈ Rₖ [(φ) and (∀r₁ ∈ R₁, . . . , ∀rₖ ∈ R_{K} [(φ) are also formulas.

By assuming the usual operator precedence (¬)>(∧)>(∨)>(→)>(∃,∀), parentheses may be omitted if doing so causes no ambiguity about the semantics of the formula. Without loss of generality (WLOG), no variable can be bound more than once, and no variable occurs both free and bound.

Well-formed TRC queries: A Boolean query (or sentence) can be a formula without free variables. A non-Boolean query is an expression {q(H)|φ} where q is the only free variable of formula φ, and the header H=(A₁, . . . ,Aₖ) is its schema, i.e., the list of attributes (or components) of q that appear in predicates of φ. The set builder notation defines the set of tuples that makes φ true.

The Abstract Syntax Tree (AST) of a TRC query is a tree-based representation that can encode a unique logical decomposition into subexpressions. AST can abstract away certain syntactic details from the parse tree and give a unique reversal of the inductively applied formation rules. The leaves (inputs) can be formed by atoms. Inner nodes (gates) can belong to 3 families:
(1) The root for non-Boolean queries {q(H)|φ}can be formed by a query node. Its two children are output for the output relation q(H) and formula for φ. The root of Boolean queries is formed by a formula node.
(2) ∃r₁ ∈ R₁, . . . ∃rk ∈ Rₖ [φ] and ∀r₁ ∈ R₁, . . . ∀rₖ ∈ Rₖ [φ] are represented by ∃ and ∀ quantifier nodes, respectively. Their two children are bindings (with k binding atoms as grandchildren), and formula φ.
(3) Logical connectives are nodes that have either one child (¬), two children (→), or k≥2 children (∧, ∨).

In some embodiments, it may be required that no ¬ is the child of another ¬ node (cancel double negations can be canceled by ¬¬φ=φ) and that the polyadic connectives (∧, ∨) to be “flattened” [1], i.e., they can have more than 2 children, yet no child of an ∧ is another ∧ (analogously for ∨). Similarly, quantifier nodes (∃, ∀) may not have a quantifier node of the same type as a grandchild, i.e., a ∃ quantifier node cannot have another ∃ quantifier node as child of its formula child.

A TRC formula may be considered as maximally scoped if no ∃ quantifier node is the child of an ∧ node. This is WLOG, as existential quantifiers can always be pushed before an ∧ node, as in: ∃r R[φ₁]∧∃s ∈ S[φ₂]=∃r ∈ R, ∃s ∈ S[φ1∧φ2].

Explicit safety of TRC: The goal of explicit safety may include syntactically restricting the well-formed TRC queries such that (i) safe queries are guaranteed to be domain-independent (and thus have only finitely many answers), (ii) this subset can express all possible finite queries [81], and (iii) safety can be recognized explicitly without any transformation. As used hereinbelow, a subtree of the AST in which each note is connected to the root via a path that is not blocked by any negation (¬), implication (→), nor (∀ quantifier) may be referred to as a base partition of the AST. This definition may be helpful in ensuring that Boolean queries (closed formulas) are always safe and thus domain-independent (Corollary 5). A non-Boolean TRC query {q(H)|φ} may be considered explicitly safe if it is well-formed and the following 4 conditions hold on φ:
(1) Every attribute A of the header H is bound in φ to either (i) an attribute B of an existentially quantified table ∃r ∈ R via an equijoin predicate q.A=r. B, or (ii) a constant c via an equiselection predicate q.A=c. In both cases, the equality predicate may be referred to as the binding predicate of q.A.
(2) Every binding predicate is in the base partition of the AST.
(3) If there is an ∨ operator on the unique path from a binding predicate to the root node of the AST then all child subformulas of that V node have only one free tuple variable, and it is the same variable with the same attributes defined.
(4) If there is no ∨ operator on that path from a binding attribute involving a header attribute q.A then the header attribute q.A appears in no other predicate.

A base disjunction may be considered as any disjunction that appears in the base partition. Intuitively, the foregoing conditions may ensure that safe TRC queries have an AST in which each output attribute is bound to exactly one existentially quantified table column (or a constant) in the base partition if, for all base disjunctions, all except for one subtree is removed.

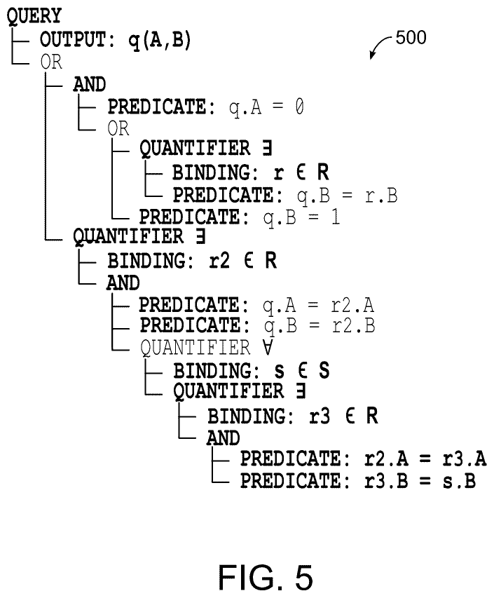

FIG. 5 illustrates an abstract syntax tree representation 500 of a tuple relational calculus query with nested disjunctions for the query described hereinbelow in Example 2.

Example 2. Consider the following safe non-Boolean TRC query:

$$\{ q ( A , B ) \vert ( q \cdot A = 0 ∧ ( ∃ r ∈ R [ q \cdot B = r \cdot B ] ∨ q \cdot B = 1 ) ) ∨ ( ∃ r ∈ R [ q \cdot A = r \cdot A ∧ q \cdot B = r \cdot B ∧ ∀ s ∈ S [ ∃ {r}_{2} ∈ R [ r \cdot A = {r}_{2} \cdot A ∧ {r}_{2} \cdot B = s \cdot B ] ] ] ) \}$$

FIG. 5 illustrates an AST 500 corresponding to the above query. Notice how the 4 safety conditions are fulfilled. In particular, the two child subformulas “∃r ∈ R[q. B=r.B]” and “q. B=1” of the lower nested disjunction have both q(B) as free variables. However, both child subformulas of the earlier disjunction in the tree have q(A, B) as free variables.

While Boolean queries in Domain Relational Calculus can be unsafe, e.g., ∃x[¬(R(x))], in the definitions disclosed herein of well-formed TRC, all relation variables (other than the output) are bound to a base table. It follows that well-formed Boolean TRC queries are always safe.

Corollary 5 (Boolean TRC safety). Every well-formed Boolean TRC as described hereinabove with respect to well-formed TRC formulae is domain-independent.

### Preliminary Solution With Anchor Relations

According to an example embodiment, disclosed herein is an extension to Relational Diagrams that can solve the disjunction problem and give the resulting representation the same pattern expressiveness as TRC. The approach may rely on anchor relations (i.e., unary and binary relations that represent constant and built-in predicates). The approach may be simple in that it does not require any novel visual syntactic devices (it uses even a smaller visual vocabulary than Relational Diagrams). However, merely relying on anchor relations, an embodiment, can be practically unsatisfying due to its additional visual clutter, and the fact that it cannot preserve the safety conditions of TRC. Such problems are addressed in subsequent sections. Described hereinbelow are two important fragments of TRC and anchor relations, along with a proof that anchor relations may be pattern-isomorphic to TRC.

The universal quantifiers ∀, material implications ¬ and disjunctions may be replaced in TRC by using only the symbols for negation ¬( . . . ), existential quantification ∃, and conjunction ∧ without changing the relational pattern. The foregoing statement may not be obvious, for example, with regard to the single connective NOR (⬇) which may also be truth-functionally complete [8]. It may be evident that NOR is not pattern preserving: ¬(φ)=φ⬇φ. While the notion that the connectives ¬, ∨ are truth-functionally complete may be known in the art [8], the more general statement that all atoms may be preserved in the AST is provided herein.

Lemma 6. Given a TRC formula φ with universal quantification, implication, or disjunction. Then there exists a logically equivalent TRC formula φ′ that (i) is pattern equivalent to φ, (ii) does not use universal quantifiers, implications, or disjunction, (iii) uses the identical set of atoms, and (iv) can be found in a polynomial time in the size of φ.

“Existential-Negation-Conjunctive TRC” (TRC^{¬∃∧}) may be referred to as the fragment of TRC that does not use the connectives ∨ and ¬nor the universal quantifier ∀. “Existential-Negation TRC” (TRC^{¬∃∧∨}) may be referred to as the variant of that fragment that allows disjunctions.

The non-disjunctive fragment of Relational Diagrams can include an extra condition requiring all predicates to be “guarded” (each predicate needs to contain a “local attribute” whose relation is quantified within the scope of the last negation). This condition leads to a reduction in logical expressiveness, which users may fix by adding a union operator as a new visual element. Such an approach may lead to cases where expressing a query requires a different relational signature. This may be in contrast to TRC^{¬∃∧∨} and TRC^{¬∃∧} which are only syntactic restrictions of non-leaf nodes of the AST.

Example 3. Consider the following TRC query that is a variation on relational division. It returns values from R.A that co-occur in R with either S.B or S.C, for all tuples from S with S.A>0:

$$\{ q ( A ) \vert ∃ r ∈ R [ q \cdot A = r \cdot A ∧ ( ∀ s ∈ S [ s \cdot A > 0 \to ( ∃ {r}_{2} ∈ R [ ( {r}_{2} \cdot B = s \cdot B ∨ {r}_{2} \cdot C = s \cdot C ) ∧ {r}_{2} \cdot A = r \cdot A ] ) ] ) ] \} \qquad ( 3 )$$

Replacing ∀ and → leads to an expression in TRC^{¬∃∧∨}:

$$\{ q ( A ) \vert ∃ r ∈ R [ q \cdot A = r \cdot A ∧ ¬ ( ∃ s ∈ S [ s \cdot A > 0 ∧ ¬ ( ∃ {r}_{2} ∈ R [ ( {r}_{2} \cdot B = s \cdot B ∨ {r}_{2} \cdot C = s \cdot C ) ∧ {r}_{2} \cdot A = r \cdot A ] ) ] ) ] \} \qquad ( 4 )$$

Further replacing ∨ leads to a query in TRC^{¬∃∧}:

$$\{ q ( A ) \vert ∃ r ∈ R [ q \cdot A = r \cdot A ∧ ¬ ( ∃ s ∈ S [ s \cdot A > 0 ∧ ¬ ( ∃ r 2 ∈ R [ ¬ ( ¬ ( r 2 \cdot B = s \cdot B ) ∧ ¬ ( r 2 \cdot C = s \cdot C ) ) ∧ r 2 \cdot A = r \cdot A ] ) ] ) ] \} \qquad ( 5 )$$

Notice that the above three expressions are not only pattern-equivalent (do not change the signature), but also all the selection predicates (e.g., “S. A>0”) and the join predicates (e.g., “r₂.C=s.C”) are identical. Only the logical connectives (¬, ∨, ∧, →), quantifiers, and parentheses have changed. In other words, all atoms are identical, and hence all leaves in their ASTs.

This is in contrast to the non-disjunctive fragment required by Relational Diagrams. Concretely, [39] suggests to use DeMorgan with quantifiers to distribute the quantifier over the disjuncts and transforming into a conjunction: ¬(∃r ∈ R[A∨B])=¬(∃r ∈ R[A]∨∃r ∈ R[B])=¬∃r ∈ R[A]∧ ¬∃r ∈ R[B]. This leads to a disjunction-free query, yet also a different signature (3 occurrences of table R) and thus a different relational pattern (as described herein with reference to FIG. 7A):

$$\{ q ( A ) \vert ∃ r ∈ R [ q \cdot A = r \cdot A ∧ ¬ ( ∃ s ∈ S [ s \cdot A > 0 ∧ ¬ ( ∃ {r}_{2} ∈ R [ {r}_{2} \cdot B = s \cdot B ∧ {r}_{2} \cdot A = r \cdot A ] ) ∧ ¬ ( ∃ {r}_{3} ∈ R [ {r}_{3} \cdot C = s \cdot C ∧ {r}_{3} \cdot A = r \cdot A ] ) ] ) ] \} \qquad ( 6 )$$

Safety can be preserved by TRC^{∃∧∨}, but not by TRC^{¬∃∧}. Recall that explicit safety is a syntactic criterion, and applying DeMorgan can render a safe query unsafe and v.v. (Example 1). Thus, removing disjunction from the vocabulary can make it impossible to represent all logical queries while preserving safety. It may be evident that the safe query from Example 1 cannot be expressed in TRC^{¬∃∧} while preserving safety: The output may need to be restricted to the union of R(A) and S(A). In the absence of disjunction V, such a restriction can only be achieved with DeMorgan, which renders the base partition empty, and the resulting query unsafe. In contrast, TRC^{∃∧∨} preserves safety since all transformations for removing ∀ and → from a safe TRC query must happen outside the base partition of its AST, and thus no binding predicate changes during the transformation.

Anchor relations can reduce the visual vocabulary but extend the pattern expressiveness of Relational Diagrams. Unary and binary anchor relations can be added to the vocabulary of Relational Diagrams, showing that this addition can enable the resulting visual representation to represent all patterns of TRC. The intuition can include that these additional tables can serve as “anchors,” which may be a visual element in a diagram that provides a stable reference for logical operations and for negation scopes and, thus, permit a direct translation from TRC^{¬∃∧∨} to such extended Relational Diagrams. An anchor may be useful for enabling unambiguously representing and composing otherwise hard-to-visualize logical constructs like negation and disjunction. Such relations may have previously been referred to as “built-in relations,” in reference to “built-in predicates” like<in SQL [84]. However, the term “anchor relations” may be preferred as they can also apply to higher-arity, non-built-in predicates such as “R.A+S.B>T.C.” Furthermore, by expressing predicates as relations, new visual elements may not need to be introduced. However, the ability to encode safety may be lost and diagrams may become more visually complex. Both issues may be addressed as described hereinbelow.

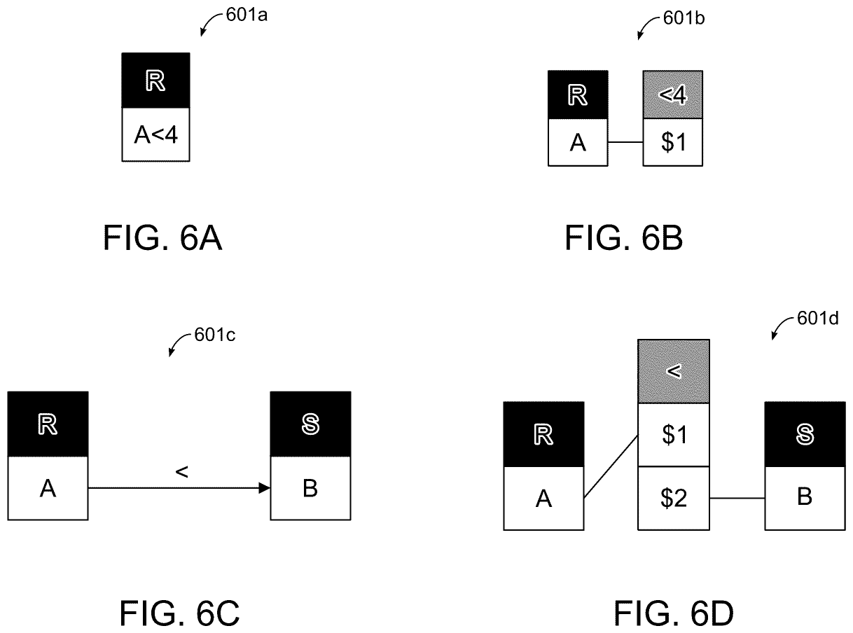

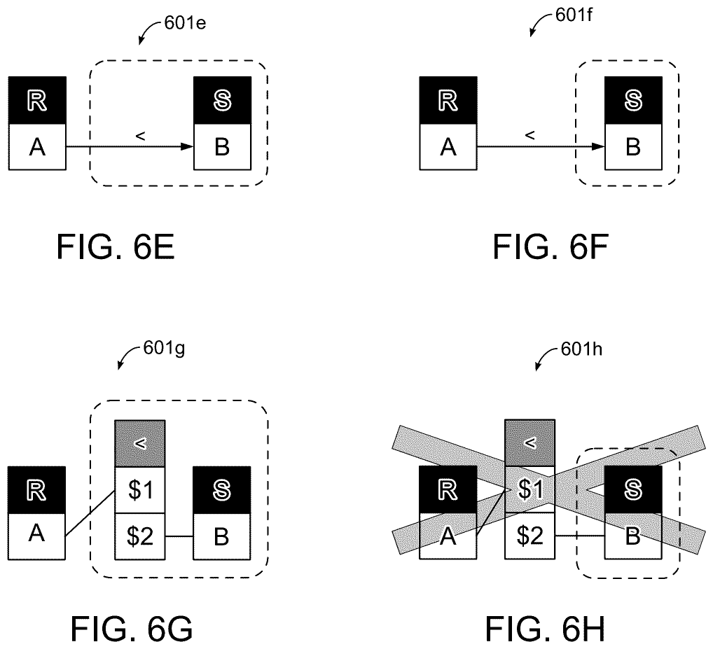

FIGS. 6A-6D illustrate anchor relations in graphical representations 601a-d, respectively of logical formulae, according to example embodiments. Unary and binary anchor relations may be added to a visual vocabulary of Relational Diagrams in order to make a resulting diagrammatic representation system pattern-complete for TRC.

Constants can be represented as unary anchor relations. For each constant c and each arithmetic comparison operator θ ∈ {=, <, ≤, >, ≥, ≠}, a new unary relation θc descriptively named “θc” may be added that contains the (possibly infinite) subset of the domain that fulfills that condition. Each selection predicate “R.Aθ c” can then be represented as equijoins with a different occurrence of that relation. When clear from the context, a table name may be used in place of a table variable. WLOG, Ullman's notation [84] may be used for the ordered, unnamed perspective to name the column $1 (for first attribute).

FIGS. 6A and 6B illustrate example representations 601a and 601b, respectively, for selection predicate “R.A<4” with unary anchor relations, according to an example embodiment. The choice of background for the unary anchor relations in FIG. 6B may be only “enabling.”

Join predicates can be represented as binary anchor relations. For each arithmetic comparison operator θ ∈ {=, <, ≤, >, ≥, ≠}, a new binary relation θ descriptively named “θ” can be included that contains the subset of the (possibly infinite) cross-product of the domain that fulfills that arithmetic comparison. Each join predicate “R.Aθ S.B” can then be represented as two equijoins of R and S with an instance of such a relation. Ullman's notation may be adopted to name the columns $1 and $2 (for first and second, respectively).

FIGS. 6C and 6D illustrate example representations 601c and 601d, respectively, for join predicate “R.A<S.B” with binary anchor relations, according to an example embodiment. The choice of background for the binary anchor relations may again be only “enabling”.

The placement of labels for anchor relations by Relational Diagrams [39] is not important since they are interpreted as labels on the edges, and the correct interpretation is guaranteed by the “guard” of each predicate (i.e., the innermost nested relations). This freedom of placement may disappear for anchor relations as defined herein.

FIGS. 6E-6H illustrate placement of operator labels in relational diagrams 601e-h, according to an example embodiment. In particular, the placement of operator labels may not matter for Relational Diagrams. However, it may matter when replacing the labels with new relations, as described hereinbelow with reference to Example 4.

Example 4. According to [39], the Relational Diagrams 601e and 601f of FIGS. 6E and 6F have the same meaning. The negation scope only applies to the enclosed table and the position of the label “<” does not alter the semantics. They both assert: “There exists a value in R.A such that there is no value in S.B that is bigger”, i.e.,

$$∃ r ∈ R [ ¬ ( ∃ s ∈ S [ r \cdot A < s \cdot B ] ) ] \qquad ( 7 )$$

After replacing the built-in predicate r.A<s.B with an anchor relation<, whether it is placed inside or outside the negation scope (FIGS. 6G and 6H) changes the diagram's meaning:

$$∃ r ∈ R [ ¬ ( ∃ s ∈ S , ∃ j ∈ “ < ” [ r \cdot A = j \cdot \$1 ∧ j \cdot \$2 = s \cdot B ] ) ] \qquad ( 8 )$$

$$∃ r ∈ R , ∃ j ∈ “ < ” [ ¬ ( ∃ s ∈ S [ r \cdot A = j \cdot \$1 ∧ j \cdot \$2 = s \cdot B ] ) ] \qquad ( 9 )$$

Query (8) (FIG. 6G) is semantically identical to (7), but query (9) (FIG. 6H) states something far more permissive: “There exists a value in R.A such that there exists a bigger value that is not in S.B.” For example, assume the database is R(1) and S(2). Then variant (8) is false (as expected), whereas variant (9) is true for the assignment: R.A=”<”.$1=1 and “<”.$2=3 (since the value 3 does not exist in S.B).

Achieving a correct translation (the expected interpretation) can be straightforward: each anchor relation may be required to be placed in exactly the negation scope that it appears in the TRC expression.

Example 5 (Example 4 continued). The exact position of the join predicate can be replaced with the anchor relation, which nests it in the correct negation scope:

$$∃ r ∈ R [ ¬ ( ∃ s ∈ S [ ∃ j ∈ “ < ” [ r . A = j . \$1 ⋀ j . \$2 = s . B ] ] ) ]$$

Relational Diagrams with anchor relations can be pattern-complete for TRC. A first key element of the present disclosure, according to an embodiment, is described hereinbelow:

Theorem 7 (Full pattern expressiveness). There is a method that translates any well-formed TRC query into Relational Diagrams extended with anchor relations. That representation has an unambiguous logical interpretation (there is another method that translates that diagram back into TRC) and has the same atoms as the original TRC query and thus has the same relational pattern.

The proof of Theorem 7 can include constructive and pattern-preserving translations from TRC to Relational Diagrams with anchor relations and back.

According to an example embodiment, a translation from well-formed TRC^{¬∃∧} queries into Relational Diagrams enhanced with built-in predicates may include four steps. This translation is inspired by the 5-step translation given in [39] for their version of Relational Diagrams. However, it may differ in crucial steps. Notably, by showing that the present translation preserves the atoms (which includes the binding predicates) for all well-formed TRC queries, embodiments of the translation as described herein can express all relational patterns of TRC. An exemplification of the translation is provided using query (5) from Example 3. The steps described herein may be similar to those of the method 100 described herein with reference to FIG. 1.

FIG. 7A illustrates a pattern-preserving diagrammatic representation 701a with anchor relations, according to an example embodiment. The diagrammatic representation 701a represents query (5), described hereinabove with reference to Example 3, via query (10), described hereinbelow.

FIG. 7B illustrates a Relational Diagram 701b of a non-disjunctive fragment of a logical formula. It may be noted that Relational Diagrams cannot preserve pattern and need to translate from disjunction-free query (6), described hereinabove with reference to Example 3, through use of DeMorgan. Unlike FIG. 7A, which includes anchor relations 760, FIG. 7B includes additional tables 762, 764.

A translation from well-formed TRC^{¬∃∧} queries into Relational Diagrams enhanced with built-in predicates, according to an embodiment, may include the following steps: Step (1) Preprocessing: First, any well-formed TRC may be translated into TRC^{¬∃∧} by preserving its atoms. Then, every join and selection predicate can be replaced with the corresponding anchor relations. Equijoin predicates (R.A=S.B) that occur in the same negation scope as one of their relations R or S may not need to be replaced (e.g., this may be the case in FIGS. 6E and 6G after replacing the “<” operator with “=”, but not in FIG. 2C and Example 9). For example, query (5) may be written as:

$$q ( A ) \vert ∃ r ∈ R [ q . A = r . A ⋀ ¬ ( ∃ s ∈ S , c ∈ “ > 0 ” [ s . A = c . \$1 ⋀ ¬ ( ∃ {r}_{2} ∈ R [ ¬ ( ¬ ( ∃ {j}_{1} ∈ “ = ” [ {r}_{2} . B = {j}_{1} . \$1 ⋀ {j}_{1} . \$2 = s . B ] ) ⋀ ¬ ( ∃ {j}_{2} ∈ “ = ” [ {r}_{2} . C = {j}_{2} . \$1 ⋀ {j}_{2} . \$2 = s . C ] ) ) ⋀ {r}_{2} . A = r . A ] ) ] ) ] \qquad ( 10 )$$

In some embodiments, it may be evident that the equijoins “q.A=r.A” and “r2.A=r.A” are not replaced with anchor relations.

Step (2) Creating canvas partitions: Similar to Relational Diagrams, The scopes of the negations in a TRC may be nested by definition. According to an example embodiment, the nested hierarchy of negation scopes (the negation hierarchy) may be translated into a nested partition of the canvas by dashed boxes with rounded corners.

Step (3) Placing input, anchor, and output relations: Relation names from each binding predicate can be placed into the canvas partition that corresponds to the respective negation scope. Notably, anchor relations can be treated identically as other relations. In particular, multiple occurrences of the same anchor relation (e.g., <) can lead to separate relations being placed in appropriate partitions. For the example based on Query (5), the binding ∃j1 ∈ “can be represented by an anchor relation=in nesting level 4 of the negation hierarchy. Inspired by Relational Diagrams, the output relation Q for non-Boolean queries and all attributes from its headers can be represented with a relation Q outside all nesting scopes, which may be referred to as the base partition in reference to the AST. Recall that for well-formed TRC queries {q(H)|φ}, φ can contain only one single free variable q.

Step (4) Placing equijoin predicates: In contrast to Relational Diagrams, both join and selection predicates can be treated identically as equijoins with appropriate anchor relations. For each equijoin R.A=S.B in the query, two attributes may be added, one for each relation R and S and connected via an unlabeled edge. For table attributes that occur in multiple equijoins, one attribute may be needed and connected using multiple edges. By this construction, the attributes of each occurrence of an anchor relation may be connected to exactly one edge. For example, “r2.B=j1.$1” is represented with an edge between attribute B of the 2nd occurrence of relation R with attribute $1 of the first occurrence of anchor relation=.

This 4-step translation can be useful for ensuring uniqueness of the following aspects: (1) nesting hierarchy (corresponding to the negation hierarchy), (2) where input and anchor relations are placed (canvas partitions corresponding to the negation scope), (3) which relation attributes participate in equijoins with what other relational attributes. Due to the unified treatment of selection and join predicates as equijoins with appropriate anchor relations, translation (after preprocessing) can be slightly simpler than the one originally proposed by the authors of Relational Diagrams [39] and, more importantly, also more general: Any well-formed TRC query can be represented in a way that preserves all atoms and thus also relational patterns.

### RepresentationB (Without Anchor Relations)

Embodiments of the foregoing preliminary solution may be useful for solving the disjunction problem. However, it may arguably include two problems: (1) the ability to use standard syntactic safety conditions to determine whether a query is domain-independent may be lost, and (2) the anchor relations and multiple nestings of negations can increase the visual complexity and make the diagrams hard to read. Two solutions introduced hereinbelow include: (1) substituting the anchor relations with visual formalisms proposed in prior literature yet keeping the rigorous and principled semantics defined hereinabove (for example, with reference to FIGS. 6F and 6H), and (2) reintroducing disjunctions as (visual) shortcuts for earlier rigorous semantics. The result may provide precisely defined pattern-preserving diagrammatic representation for any TRC query that allows visual verification of the safety conditions and that specializes into Relational Diagrams for the fragment of disjunction-free TRC.

Simpler anchors may be used for unary anchor relations. Unary anchor relations can include two boxes: the predicate (condition) name (e.g., <4) and an attribute box $1. Unnecessary indirections may be removed by substituting both boxes with one box containing the condition (e.g., <4). Visual formalisms from prior proposals may also be recovered, such as from VisualSQL [51] and VQL [61](as described herein with reference to FIGS. 4D and 4E): a selection is an equijoin between an attribute and a condition (e.g., A−<4). Such a condition can still provide an anchor and could be in a deeper nesting than the table and may be referred to as a “canonical” representation.

If the condition is in the same negation scope as the relation, a shortcut may be applied that fuses the two attributes and thereby recovers the selection formalism used by Relational Diagrams (e.g., A<4). Embodiments of formalisms for representations described herein may thus be backward compatible to Relational Diagrams yet also allow giving the condition a separate “anchor”, which may be useful for expressing certain relational patterns.

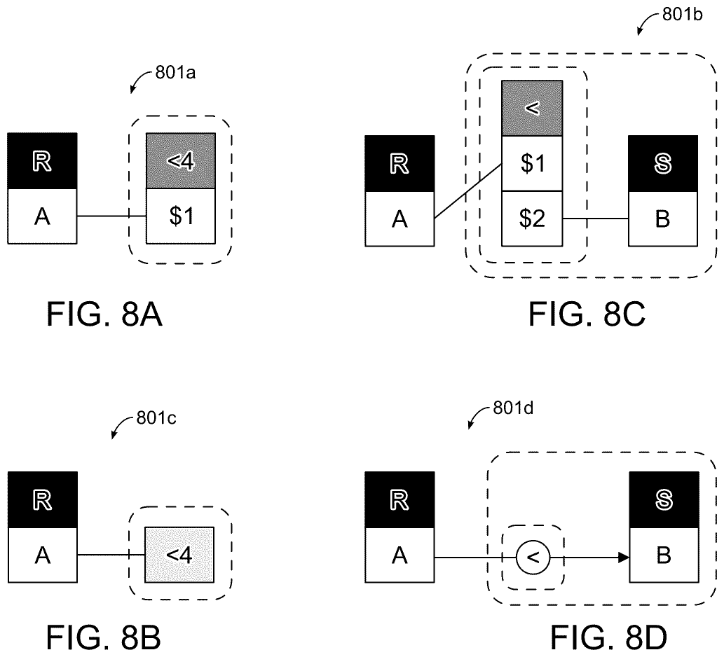

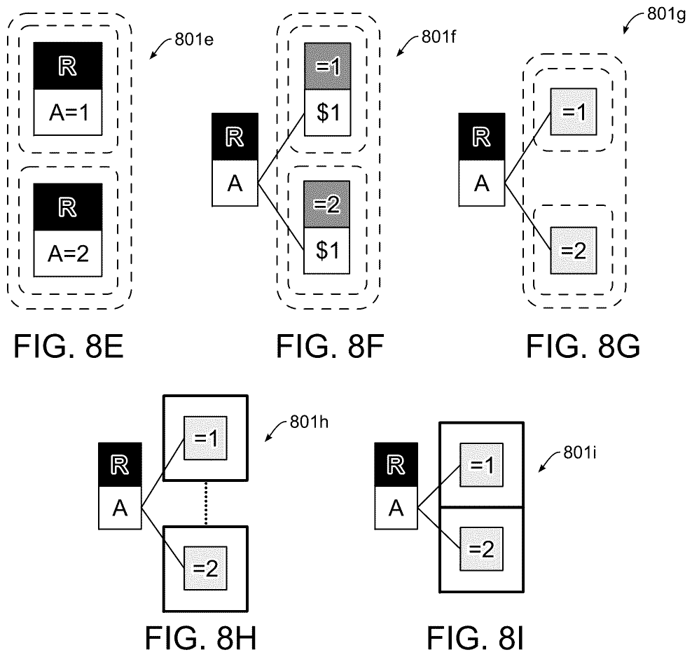

FIGS. 8A-8I illustrate corresponding graphical representations 801a-i generated using Relational Diagram functionality (FIG. 8E) and example embodiments (FIGS. 8A-8D, 8F-8I). The graphical representations 801a and 801b of FIGS. 8A and 8B represent the query ∃r ∈ R[¬(r A<4)], described herein with reference to Example 6, using example embodiments. The graphical representations 801c and 801d of FIGS. 8C and 8D represent the query ∃r ∈ R[¬(∃s E S[¬(r A<S.B)])], described herein with reference to Example 6, using example embodiments. The graphical representations 801e-i of FIGS. 8E-8I represent the query ∃r ∈ R[r.A=1∨r.A=2] described herein with reference to Example 7. FIGS. 8H and 8I leverage visual shortcuts for disjunctions, which may include DeMorgan-fuse boxes.

Binary anchor relations may include three boxes: the predicate name (e.g., <) and two attributes connected to the respective relational attributes via equijoins. The binary anchor relations can be substituted with the symbols that were originally used by Relational Diagrams as labels on directed edges (arrows). However, an explicit bounding box (e.g., <) may be added. An important difference includes that the former labels may now be treated as anchors with the full semantic interpretation developed (for example, as illustrated in FIG. 8D). These semantics can allow for explicitly placing the anchor in a deeper nesting than either of the relations joined by that comparison predicate and thereby improve upon the limited pattern expressiveness of Relational Diagrams.

Example 6 (Substituting anchor relations). Consider the Boolean TRC query ∃r ∈ R[¬(r A<4)] shown in FIG. 8B using an example embodiment, e.g., RepresentationB. The top row shows an example embodiment, e.g., Relational Diagrams with anchor relations, which correspond to ∃r ∈ R[¬(∃⊏ ∈ “<4” [r.A=c. $1])]. Next, consider the Boolean query ∃r ∈ R[¬(∃s ∈ S[¬(r A<S.B)])] shown by representation 801d in FIG. 8D (generated using an embodiment). FIG. 8C shows a representation 801c generated using another example embodiment, e.g., a Relational Diagram with anchor relations, which correspond to ∃r ∈ R[¬(∃s ∈ S[¬(∃j ∈ “<”[r.A=j.$1 ∧j.$2=s.B])])].

Frugality in primitive elements may have downsides: fewer connections may result in more difficult to understand sentences. Despite negation and conjunction being truth-functionally complete, disjunctions may be regularly used in logic and in natural language. A visual shortcut may be introduced for disjunction that may be useful for enabling recovery of a testable safety condition and generalization of the various (incomplete) approaches for disjunctions described hereinabove. An approach for the visual shortcut may include keeping the formal semantics developed thus far (that may solve the disjunction problem while allowing the visual shortcut that may be referred to as “DeMorgan-fuse boxes.” These boxes may be useful in allowing the expression of ¬(¬(φ₁) ∧ . . . ∧¬(φₖ)), k≥2 with φ₁ ∨ . . . ∨ φₖby substituting nested double negations with bold rectangles, optionally connected via dotted lines.

Definition 8 (DeMorgan-fuse boxes) according to a non-limiting example embodiment. Bold rectangular boxes that are either adjacent to each other or connected via dotted lines are interpreted as if their anchored elements were connected via disjunctions. They can be interpreted as if each of the boxes were replaced with individual negation scopes and the union of those boxes with another outer negation scope.

Example 7 (Simple disjunction). Consider the following disjunction from Section 3.2:

$$∃ r ∈ R [ r . A = 1 ⋁ r . A = 2 ] \qquad ( 11 )$$

Relational Diagrams need to show two R tables, either with union cells (as described herein with reference to FIG. 3H) or with a double negation (FIG. 8E):

$$∃ r ∈ R [ r . A = 1 ] ⋁ ∃ r ∈ R [ r . A = 2 ]$$

$$¬ ( ¬ ( ∃ r ∈ R [ r . A = 1 ] ⋁ ∃ r ∈ R [ r . A = 2 ] ) )$$

$$¬ ( ¬ ( ∃ r ∈ R [ r . A = 1 ] ) ⋀ ( ∃ r ∈ R [ r . A = 2 ] ) )$$

Relational Diagrams with anchor relations can replace the selection predicates with equijoins to two anchor relations (FIG. 8F):

$$∃ r ∈ R [ ¬ ( ¬ ( ∃ e 1 ∈ “ = 1 ” [ r . A = e 1. \$1 ] ) ⋀ ¬ ( ∃ e 2 ∈ “ = 2 ” [ r . A = e 2. \$1 ] ) ) ]$$

Embodiments can represent the statement either via De Morgan (FIG. 8G):

$$∃ r ∈ R [ ¬ ( ¬ ( r . A = 1 ) ⋀ ¬ ( r . A - 2 ) ) ]$$

or via DeMorgan-fuse boxes (FIG. 8I), optionally connected via dotted edges (FIG. 8H).

Embodiments can be pattern-complete for TRC and preserve safety. According to an example embodiment, a second key aspect of the formulation described herein includes as follows:

Theorem 9 (Pattern-isomorphism and safety of embodiments). Every Relational Diagram with built-in predicates has a pattern-isomorphic representation as embodiments (e.g., RepresentationB) and vice versa. At the same time, embodiments preserve the safety conditions of TRC, i.e., the syntactic safety conditions can be directly verified from the diagrammatic representation.

A proof of Theorem 9 may use constructive translations from TRC to an embodiment and back that are pattern preserving and safety preserving. Embodiments may thus solve both the disjunction and the safety problem. Recall that TRC^{¬∃∧∨} can preserve the relational pattern and the safety conditions. Because the translation from TRC^{¬∃∧∨} can preserve the negation scopes, the disjunctions, and all atoms from the AST, the 4 safety conditions described hereinabove can be immediately read and verified from a diagram using embodiments described herein.

FIGS. 9A and 9B illustrate graphical representations 901a and 901b of a query with (901b FIG. 9B) or without (901a FIG. 9A) Peirce shading according to an example embodiment.

Example 8 (Example 2 continued). The TRC query from Example 2 is equivalent to the following safe TRC^{¬∃∧∨} fragment:

$$\{ q ( A , B ) \vert ( q . A = 0 ⋀ ( ∃ r ∈ R [ q . B = r . B ] ⋁ q . B = 1 ) ) ⋁ ( ∃ r ∈ R [ q . A = r . A ⋀ q . B = r . B ⋀ ¬ ( ∃ s ∈ S [ ¬ ( ∃ {r}_{2} ∈ R [ r . A = {r}_{2} . A ⋀ {r}_{2} . B = s . B ] ) ] ) ] ) \} \qquad ( 12 )$$

FIG. 9B illustrates a representation 901b for this query generated using an embodiment, which may correspond to the AST from Example 2 and FIG. 5. Notice how the 4 safety conditions can be applied directly on this diagram to verify that this query is safe.

Embodiments can have a same asymptotic size as TRC. The proof may follow from the fact that the leaves of the AST (and the negation and disjunction scopes) get directly mapped to objects in the diagram. At the same time, embodiments can generate an exponentially smaller representation of TRC than Relational Diagrams. This may be because Relational Diagrams require conjunctive normal form (CNF) formulas to be first transformed into disjunctive normal form (DNF) (i.e., to have disjunctions or unions as the root, which may require an exponential blow-up in size), while the presently disclosed approach can leave disjunctions as inner operators in the AST. Restated below:

Proposition 10 (Size preservation of TRC). Representations generated using embodiments have the same asymptotic size as TRC and can be exponentially smaller than Relational Diagrams.

### Enabling Features and Perceptual Choices

According to some embodiments, enabling features may be added to representations. Justifying perceptual choices are presented hereinbelow. As described, embodiments may be useful for unifying and generalizing prior approaches for disjunction.

In some embodiments, enabling features for Representation may include shading, for example, Peirce shading. This idea was originally proposed by Peirce [63] and became known in the diagrammatic reasoning community due to Sowa [73, 74]. Zones in the diagram can be called as either positive (if nested in an even number of negation scopes, including zero) or negative (if nested in an odd number of negations). Then, to improve contrast and facilitate reading, negative areas can be shaded, e.g., in gray as shown in representation 901b of FIG. 9B, and positive areas may be kept unshaded, e.g., in white.

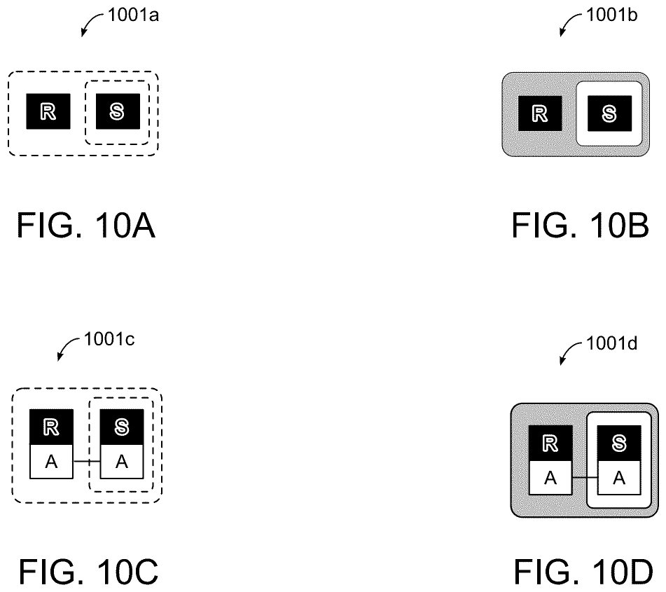

FIGS. 10A-10D illustrate graphical representations 1001a-d of queries with (1001b FIGS. 10B and 1001d FIG. 10D) or without (1001a FIGS. 10A and 1001c FIG. 10C) Peirce shading, according to an example embodiment. Peirce shading can allow alternative reading of ¬(antecedent A ¬(consequent)) as antecedent→consequent.

A fascinating aspect of Peirce shading is that Peirce shading may allow multiple readings of a given diagram and can thereby even recover universal quantifiers without a need for an additional dedicated symbol. Peirce called a nesting of a positive zone within a negative zone (as in FIG. 10B) a scroll and observed that it can be alternatively read as “either R is false or S is true” or “if R is true, then S is true.” The Peirce shading (FIG. 10B) may make the second reading more explicit.

Similarly, consider the Boolean query (FIG. 10C):

$$∀ r ∈ R [ ∃ s ∈ S [ r . A = s . A ] ] . \qquad ( 13 )$$

Without universal quantifiers, it may need to be rewritten as:

$$¬ ( ∃ r ∈ R [ ¬ ( ∃ s ∈ S [ r . A = s . A ] ) ] ) . \qquad ( 14 )$$

Applying Peirce shading to it, as in FIG. 10D, can recover the former reading more easily. FIGS. 9A and 9B provide additional exemplification of Peirce shading for a more complex query example.

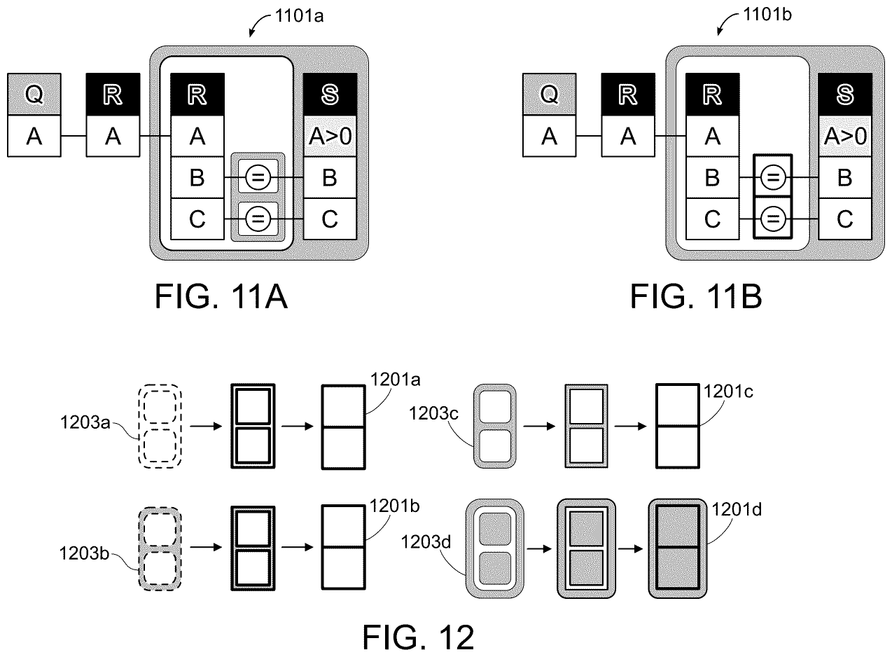

FIGS. 11A and 11B illustrate graphical representations 1101a and 1101b with Peirce shading applied for queries formulated using TRC^{¬∃∧} and TRC^{¬∃∨∧}, respectively, according to example embodiments. FIG. 11A is translated from query (5) and FIG. 11B is translated from query (4), and are further described hereinbelow in Example 9.

Example 9 (Example 3 continued). FIG. 7A showed Example 3 as a Relational Diagram with anchor relations. FIG. 11A illustrates a representation 1101a generated using an embodiment by translating from query (5) in TRC^{¬∃∧}. In contrast, FIG. 11B shows a representation 1101b generated using an embodiment by translating directly from the TRC^{¬∃∧∨} query (4) and using disjunctions. Both representations 1101a and 1101b are pattern-isomorphic representations of the original formulas.

FIG. 12 illustrates example DeMorgan-fuse boxes 1201a-b with (1201b) or without (1201a) Peirce shading, according to an example embodiment. Since the semantics of DeMorgan-fuse boxes, as described herein, can hinge on double negation, the semantics may not change the parity of a zone in which they appear. Peirce shading can therefore align naturally with disjunction, and disjunction boxes can be seen as visual shortcuts, providing a post hoc justification for the name DeMorgan-fuse boxes.

As illustrated in FIG. 12, double negations 1203a-d may be represented without Peirce shading (1203a) or with Peirce shading (1203b-d). The double negations 1203a-d can be converted into the DeMorgan-fuse boxes 1201a-d. In some embodiments, the DeMorgan-fuse box 1201d can also include Peirce shading.

Embodiments of the presently disclosed methods and formulations may be useful for providing a representation system that solves the disjunction and the safety problems with its constitutive features. The embodiments may include perceptual choices and enabling features of embodiments that may facilitate interpretation but may not be constitutive.

Chamberlin teaches in an article on SQL [17], “Our specific goals were to design a query language with the following properties: . . . user with no specialized training could, in simple cases, understand the meaning of a query simply by reading it. We called this the ‘walk-up-and-read’ property.” Diehl [29] writes: “If done right, diagrams group relevant information together to make searching more efficient, and use visual cues to make information more explicit.” The presently disclosed methods and formulations may be motivated by a goal of developing an (i) intuitive and (ii) principled diagrammatic representation for (iii) arbitrary nestings of disjunctions, (iv) with minimal additional notations. Example embodiments may be inspired by the design choices of Relational Diagrams and may meet the challenge without introducing any fundamentally novel visual symbol to the visual grammar of Relational Diagrams. However, a stricter syntactic interpretation may be presented herein for edge labels, allowing constants outside table attributes and allowing disjunction boxes used inside the diagrams.

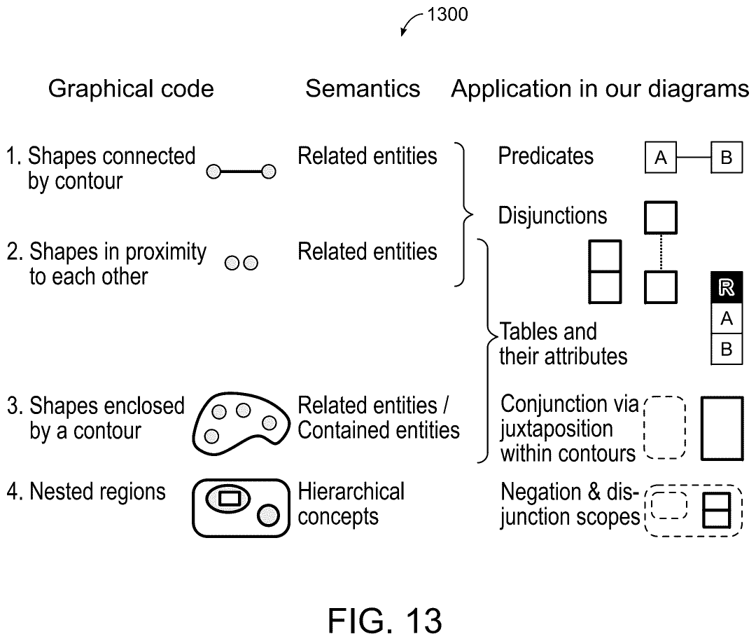

FIG. 13 is visualization 1300 illustrating graphical features used in an example embodiment and correspondence of the graphical features with a larger context of visual grammar, according to an example embodiment. More specifically, FIG. 13 may illustrate how a conservative extension with disjunctions can fit into the overall visual grammar and semantic patterns (sometimes called “codes”) of node-link diagrams and relationship representations [88]. As Ware writes, “a good diagram takes advantage of basic perceptual mechanisms that have evolved to perceive structure in the environment” [88]. Embodiments presented herein may try to follow the practice taught by Ware. Accordingly, choices of disjunctions may inherit the “nested regions” code from negation scopes and DeMorgan, while also using the “shapes in proximity” code (widely used and known from UML) and alternatively the “shapes connected by contour” code.

### Solutions to Prior Challenging Queries

FIGS. 14A-14F illustrate graphical representations 1401a-f generated for conventionally challenging queries using prior representation functionality (FIGS. 14A and 14E) and example embodiments (FIGS. 14B-14D and 14F). The word “query” can also be used for a formula, statement (i.e., a Boolean query), etc.

Example Query 1: FIG. 14B illustrates a graphical representation 1401b provided using an embodiment for the query of the visualization 1401a of FIG. 14A, a visual representation given in two presentations [78, 79] by Thalheim. The representation 1401b reads as:

$$∃ r ∈ R [ R . A = 1 ⋁ R . B = 2 ⋁ ( R . C = 3 ⋀ R . D = 4 ) ] \qquad ( 15 )$$

Example Query 2: FIGS. 14C and 14D illustrate graphical representations 1401c and 1401d generated using RepresentationB for the two challenges listed in [39] and provided hereinbelow, respectively:

$$∃ r ∈ R , ∃ s ∈ S [ r . A < s . E ⋀ ( r . B < s . F ⋁ r . C < s . G ) ] \qquad ( 16 )$$

$$∃ r ∈ R [ ( r . A > 0 ⋀ r . A < 10 ) ⋁ ( r . A > 20 ⋀ r . A < 30 ) ] \qquad ( 17 )$$

Example Query 3: Gardner in his 1958 book ‘Logic Machines and Diagrams’ [35] discusses a challenging disjunction and concludes that “there seems to be no simple way in which the statement, as it stands, can be diagrammed” [35]:

$$( A ⋁ B ) \to ( B ⋁ C ) \qquad ( 18 )$$

Gardner proposes a diagrammatic compound statement, illustrated by the visualization 1401e of FIG. 14E, that needs to repeat the individual predicates. FIG. 14F illustrates a graphical representation 1401f generated using an embodiment for query (18), which may follow from rewriting the statement as ¬((A∨B)∧¬(B∨C)). Notice atomic propositions like A can be interpreted as nullary (0-ary) relations A( ) that can be set to true or false. In other words, a symbol “A” is true if and only if “∃α ∈A”, i.e., thus table A is not empty.

Example Query 4: FIG. 2A illustrates a challenge in an earlier mentioned tutorial [38]. Within reasonable belief, the following issue of visual representation and diagrammatic reason has not been raised in corresponding literature: there may be two different ways to interpret the aforementioned figure (representation 201a of FIG. 2A).

$$∃ r ∈ R , ∃ s ∈ S [ ( r . A = s . A ⋀ r . B = 0 ) ⋁ ( r . B = 1 ⋀ r . C = 2 ) ] \qquad ( 19 )$$

$$∃ r ∈ R , [ ( ∃ s ∈ S [ r . A = s . A ] ⋀ r . B = 0 ) ⋁ ( r . B = 1 ⋀ r . C = 2 ) ] \qquad ( 20 )$$

The difference includes that query (19) is true on the database R={(9, 1, 2)}, S=∅, whereas query (20) is false. The reason is due to a different scoping of S. Embodiments of the present disclosure which implement a principled translation with DeMorgan-fuse boxes as disclosed herein may create the two distinct diagrams 201b and 201c shown in FIGS. 2B and 2C and can thus handle the distinction. To the best of the applicant's knowledge, no prior diagrammatic representation could represent and thus distinguish between those two interpretations.

The authors of Relational Diagrams [39] gathered 58 queries from the relationally complete fragment from 5 popular database textbooks [20, 23, 30, 66, 72] and made them available on Open Source Framework (OSF), referred to herein as “the textbook benchmark.” The authors of [39] evaluated the pattern expressiveness of various text-based and diagram-based languages and showed that Relational Diagrams covered 95% ( 55/58) of the queries in that benchmark.

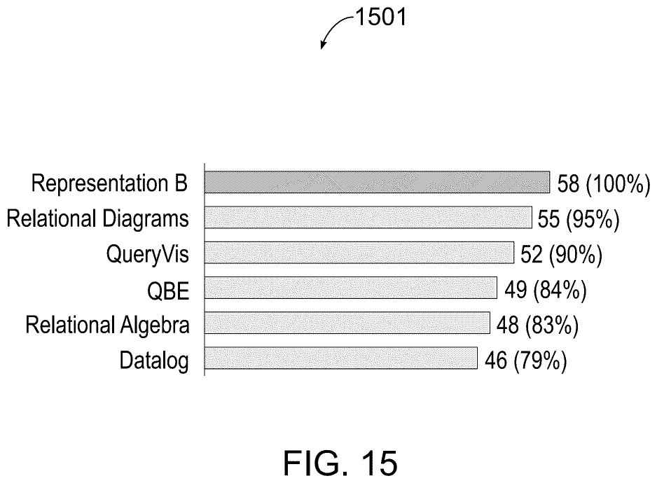

FIG. 15 illustrates results 1501 for a fraction of pattern-isomorphic representations among 58 queries, including using an example embodiment of the present disclosure, RepresentationB. Embodiments may be pattern-complete for TRC and, thus, achieve 100% pattern coverage. The three queries and their pattern-isomorphic representations generated using embodiments that Relational Diagram methods cannot pattern-represent are disclosed herein under the heading “Additional Details Regarding Example Enabling Features And Perceptual Choices.”

### CONCLUSION

Embodiments provide a diagrammatic representation system capable of pattern-representing any well-formed TRC query without altering the table signature. Amongst other benefits, embodiments may be useful for solving the disjunction problem. According to an example embodiment, this solution may be achieved by first replacing join and selection predicates with relations and then defining the semantics based on placing relations in nested negation scopes and interpreting juxtaposition as conjunction. Details behind existing visual formalisms may be hidden while redefining their semantics in the more rigorous relation-based interpretation (as described herein with reference to FIG. 6D). A box-based visual representation may be defined for disjunctions that can display explicit safety conditions and unifies, generalizes, and overcomes the shortcomings of three major prior graphical approaches for disjunctions. This may be demonstrated by showing that such disjunction boxes (originally proposed by Peirce) can be pushed from the root into the branches of an AST representation of queries, while keeping their rigorous semantic interpretation.

As large language models (LLMs) increasingly take on more of the query generation, helping users understand those queries may become increasingly important [27, 41]. Since SQL and all relational query languages have a firm foundation in mathematical logic, finding a principled solution to the disjunction problem may be important. Any future visual query representation that can handle additional functionalities (including aggregates and recursion) needs to also incorporate a solution to the more general and longer-studied disjunction problem.

### Different Well-Formed TRC Formalisms

The database literature may vastly differ in their treatment and formal definition of TRC. An abbreviated comparison is provided herein with respect to the chosen formalism and motivations. In essence, the streamlined formalization of TRC (and the resulting safety conditions based on ASTs) can be a key reason toward why the translation from TRC to embodiments can appear so natural.

Dedicated Output Variable—Several textbooks [30, 66, 72, 84] and Codd's original formulation of TRC [19] allow a tuple variable bound to a particular table to become the output variable. For example, Ramakrishnan and Gehrke [66] would allow the following notation:

$$\{ r \vert r ∈ R ⋀ r . B > 4 \}$$

This notation does not make explicit the schema of the output (in this case r (A, B)) or its arity. This could be partially fixed by always requiring showing the header of the output tuple. In contrast, another option, as used above, includes always requiring a new free output variable (which can also be required by the above notation if the output attributes are chosen from more than one table, but just not enforced when not needed) which simplifies the formation rules of well-formed formulas and also later simplifies the translation into a diagrammatic representation.

The above query can be reformulated instead as:

$$\{ q ( A , B ) \vert r ∈ R [ q . A = r . A ⋀ q . B = r . B ⋀ r . B > 4 ] \}$$

Combined variable bindings and quantification—In the definition of well-formed formulas, any bound variable can be restricted (either existentially or universally quantified) to range over a specific relation before it is used. This choice is also adopted by most textbooks, such as [66, 72]. This notation can permit a concise definition of the AST, as described hereinabove, of a TRC query because bound attributes can only be referenced within a subtree of the quantifier node in the syntax tree that binds them.

Codd's original formulation [19], and also the books by Ullman [84] and Elmasri and Navathe [30], separate the combined quantification and binding used herein (“∃r ∈ R”) into a quantification (“∃r”) and a range term (“r ∈ R”). For example, Ullman's definition [84] would allow writing above query as:

$$\{ q ( A , B ) \vert ∃ r [ q . A = r . A ∧ q . B = r . B ∧ r . B > 4 ∧ r ∈ R ] \}$$

Notice how the variable r is used in an atom (“q.A=r.A”) whose binding is defined in a sibling node (“r ∈R”) of a shared parent conjunction node A instead of a parent. This more permissive notation may not add logical expressiveness but leads to Ullman's formal safety condition [84] requiring an inductive argument about “limited variables” that are bound via possibly multiple equijoins. To see this, notice that the above query could also be written by defining an additional (and arguably unnecessary) tuple variable t that acts only as intermediary between output variable q and the bound variable r:

$$\{ q ( A , B ) \vert ∃ r , ∃ t [ q . A = t . A ∧ t . A = r . A ∧ q . B = r . B ∧ r . B > 4 ∧ r ∈ R ] \}$$

Multiple bindings of the same variable—Separation of bindings and quantifications may permit using the same tuple variable in multiple range terms as in

$$\{ q \vert q ∈ R ∧ ¬ ( q ∈ S ) \}$$

The notation used hereinabove can capture the same fragment but requires each “range term” to use a separate tuple variable, as in

$$\{ q ( A ) \vert ∃ r ∈ R [ q . A = r . A ∧ ¬ ( ∃ s ∈ S [ r . A = s . A ] ] \}$$

Named vs. unnamed perspective—According to an example embodiment, the named perspective of TRC may be used. All attribute names of relations may thus be assumed to be known and their relative order does not matter. Notable exceptions are Codd's original formulation of TRC [19] and Ullman's textbook [84] where they refer to the 2nd attribute (component) of a tuple variable r by “r.[2]” as in:

$$\{ r ( 2 ) \vert r ∈ R ∧ r . [ 2 ] > 4 \}$$

Minor notational differences—The TRC notation used hereinabove for the binding predicate “r ∈ Rᵢ” may also be used by Ramakrishnan and Gehrke [66] and Silberschatz et al. [72]. Codd [19] originally used the notation “Pᵢr”, with Pᵢ being a monadic predicate corresponding to table Rᵢ, and called it a range term. Ullman [84] and Elmasri and Navathe [30] write the binding predicate instead as “Rᵢ(r)”.

The notation “r.A” for a tuple attribute (or component) is also used by Ramakrishnan and Gehrke [66], and Elmasri and Navathe [30]. In contrast, Codd [19], Ullman [84], and Silberschatz et al. [72] use instead the notation “r[A]” or “r(A)”.

The notation “∃r ∈ R, ∃s ∈ S[r>4]” for the scope of tuple variables is similar to the notation of Ramakrishnan and Gehrke [66] and Silberschatz et al. [72]. However, brackets “[ . . . ]” may be used instead of parentheses “( . . . )” for variable scopes, parentheses may be used instead for the scope of negation ¬( . . . ). Other books [30, 84] use parentheses around the quantifiers as in “(∃r ) (∃s) (∃r ∈ R ∨ S ∈ S ∧ r>4)”.

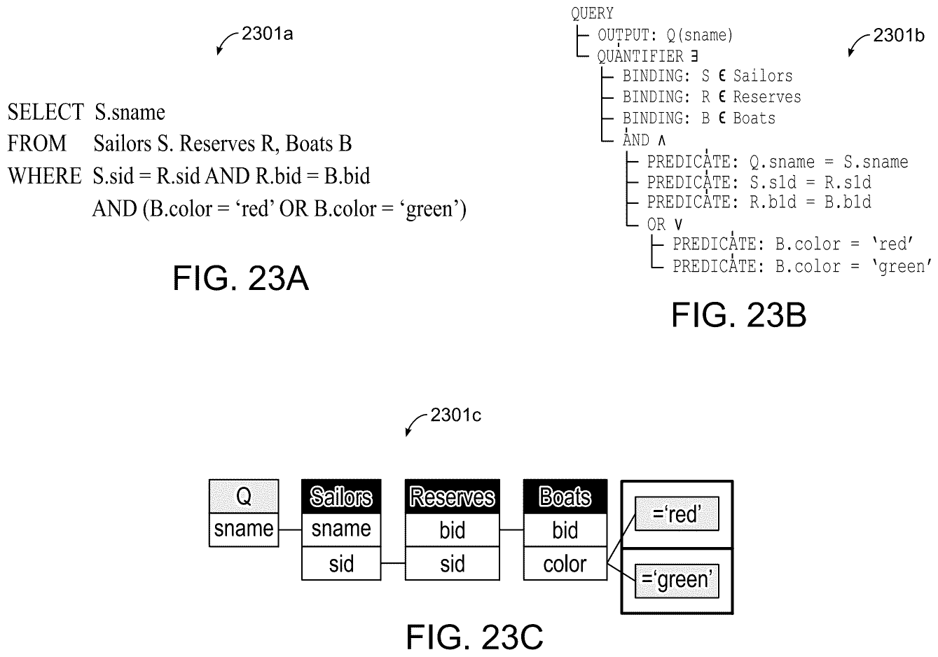

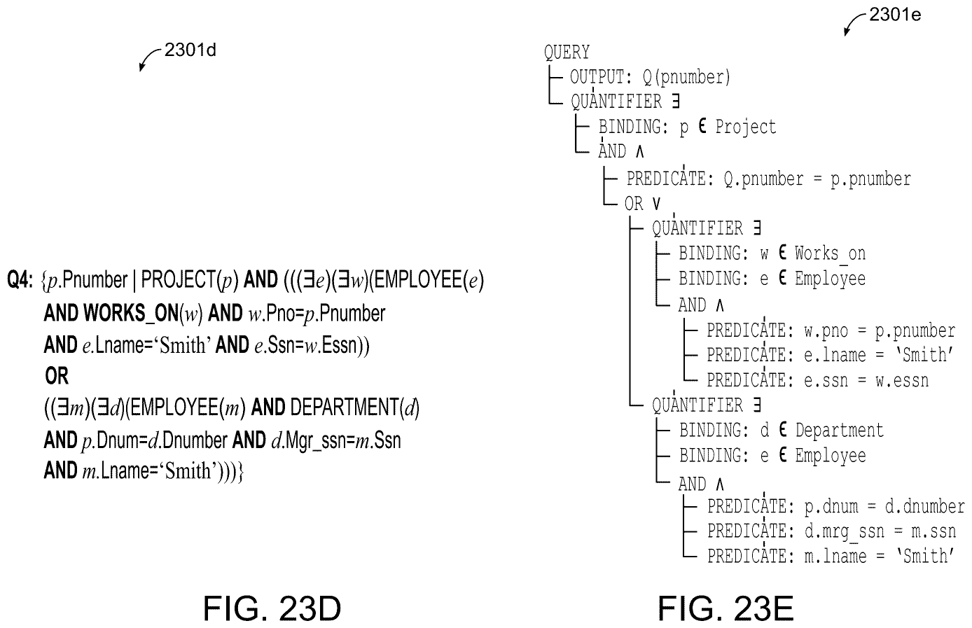

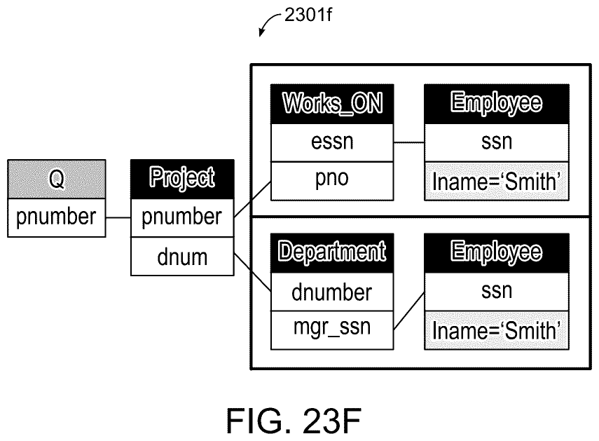

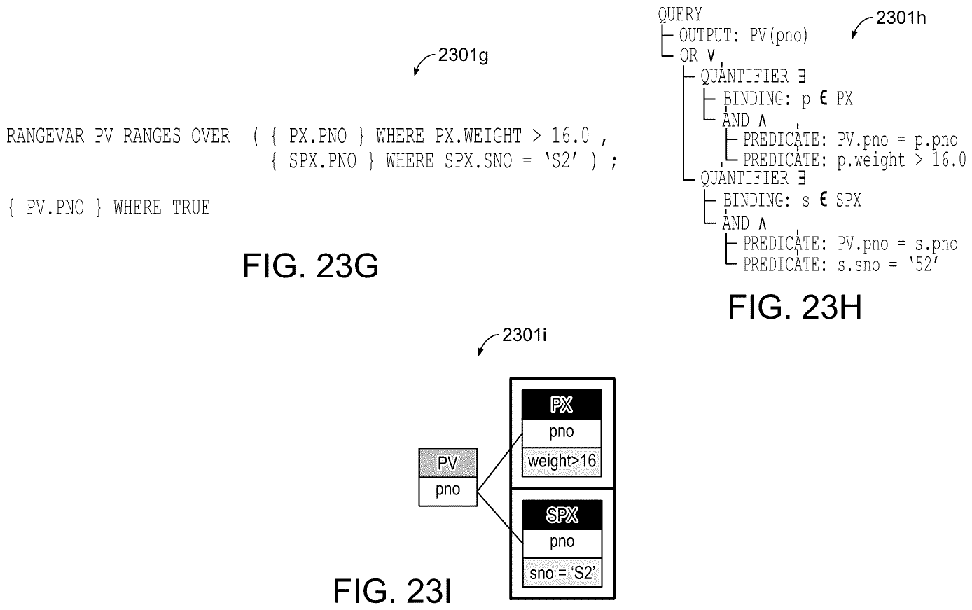

Date [23] uses a notation for “tuple calculus” that is entirely different (as described herein with reference to FIG. 23G). The book by Abiteboul et al. [1] also calls it “tuple calculus”, and the book preprint by Arenas et al. [6] does not cover TRC at all.

### Different Syntactic Safety Criteria For TRC.

The safety conditions for TRC queries (instead of the more widely used Domain RC or DRC queries) are rarely discussed in database textbooks. Abiteboul et al.'s concept of range-restricted RC queries [1] is only defined for DRC but not TRC. Ullman's definition of safety [84] extends to TRC (discussed in more detail below) but it excludes correlated nested queries (e.g., find sailors who reserved all red boats), which are allowed by SQL and which embodiments explicitly include. The books by Ramakrishan and Gehrke [66], Elmasri and Navathe [30], and Silberschatz [72] mention the concept of safety and its connection to domain-independence but do not include any syntactic definition for safety. The very recent book in progress by Arenas et al. [6] does not mention safety of RC in its current draft form. The safety definition for TRC on Wikipedia [21] may be clearly wrong (it does not make a difference between existential and universal quantifiers), and has been wrong for over 10 years, according to the revision history.

Since formal safety conditions as used herein may differ slightly from prior definitions (they can be at times more permissive and at other times more restrictive), a more extensive justification for these choices is provided herein along with a proof of them being a valid safety restriction.

Domain-independence vs. syntactic safety—A relational calculus query can be called domain-independent (or semantically safe) if its results depend only on the “active domain” (i.e., data present either in the database or the query) and not on the choice of an underlying (possibly infinite) domain [81]. Domain-independence is a semantic concept (it remains invariant under rewrites), and determining whether a query is domain-independent turns out to be undecidable, in general (it was shown to be equivalent to the class of “definite” formulas, whose membership is not recursive [42]).

For that reason, researchers developed various syntactic restrictions that guarantee domain-independence, with the permitted queries then being called syntactically safe. A constant reason for confusion on safety is that the notion of “safety” has been used throughout the database literature in inconsistent ways. Semantic safety and syntactic safety are very different concepts, and use of the word “safety” alone usually stands for syntactic safety, but is also inconsistently used for semantic safety. Even the terms “semantic safety” and “syntactic safety” were used to refer to different syntactic definitions of safety by Ullman in [42]. To be clear, safety as used herein assumes syntactic restrictions that guarantee domain-independence.

Syntactic safety rewrites vs. direct syntactic safety—Several syntactic classes have been proposed in the literature (for overviews, see [1, 42, 81]). The following four appear the most important characterizations:
(1) “Ullman-safe” formulas [84](also called “syntactically safe” in [42])
(2) “safe-range” formulas [1]
(3) “allowed” formulas [42, 82]
(4) “evaluable” formulas [26, 42](proved to be equivalent to “range-restricted” formulas)

The classes also experienced changing definitions over time, and have been referred to under different names. Importantly, these classes may differ in how broadly they capture domain-independent queries versus how simple they are to check or translate. In terms of the set of formulas accepted, they create a strict hierarchy [1, 42]:
Ullman-safe ⊏ Safe-Range ⊏ Allowed ⊏ Evaluable

Ullman's syntactic safety test is applied to the formula as written. One checks the raw formula, there are no rewrites applied. All the other safety notions are invariant under an increasingly complex set of equivalences that can be used as rewrite rules. Intuitively, the characterizations can require preliminary transformation of a formula to a normal form and can become quite complex as evidenced by following citation from [42]: “the evaluated formulas comprise the largest class, but the definition of this class by Demolombe . . . occupies three pages; its complex definition makes it unwieldy to work with . . . ”

Ullman-safe ⊏ Safe-Range: A minimum example for a formula that is safe-range but not Ullman-safe is ¬(¬(A(x))). Ullman checks the formula as written and therefore treats A(x) hidden behind two negations as “negated.” Safe-range first removes the double negation during translation into Safe-range Normal Form (SRNF), and then accepts it.

Safe-Range ⊏ Allowed: A minimum example for a formula that is allowed but not safe-range is ∃x[A(x)∧B(y)]. Safe-range demands each free variable occur positively in each disjunct of the DNF, but y is missing from the first branch. Allowed only requires y be generated somewhere inside the formula, and B(y) suffices.

Allowed ⊏ Evaluable: A minimum example for a formula that is evaluable but not allowed is ∃x, y[A(x)∧(B(x)∧C(y))]. Allowed cannot distribute ∃y inside the OR, so y is not generated in the C(x) branch. Evaluable permits the transformation to ∃x[A(x)∧B(x)]∨∃x,y[A(x)∧C(y)], so the formula becomes allowed and is accepted.

Because the set of allowed equivalences is a matter of debate, direct safety, i.e., syntactic safety criteria, similar to Ullman's, that do not require any transformations and are directly applicable to the formula as written.

Ullman's syntactic safety for DRC—Ullman [84] gives a purely syntactic safety test for DRC formulas that, in its essence, requires that all variables must be recursively range-bounded by a positive condition in the query. These criteria may be referred to as Ullman safety:
(1) No universal quantifiers V: Replace any occurrence of ∀x[φ] by ¬∃x[¬φ].
(2) Disjunctions have the same free variables: Whenever there exists φ∨ψ, the sets of free variables in φ and in ψ must coincide.
(3) Range-restriction by positive atoms or constants: Every variable x appearing free in a subformula must be “limited” by either directly appearing in at least one positive relational atom connected via a conjunction (e.g., “¬(R(x)) ∧ S(x, . . . )”), or by being connected by a set of equi-joins to a positive atom or a constant (e.g., “¬(R(x)) ∧ x=y∧S(y, . . . )”).
(4) ∧ negated subformula ¬(φ) is allowed only if every free variable in φ also appears in some positive “guard” outside that negation (i.e., it appears positively elsewhere as in rule 3).

Taken together, these rules can guarantee that any value assigned to a variable comes from a finite set derived from the database or query constants. Importantly, they can achieve domain-independence without requiring any formula rewriting.

Ullman Safety and DeMorgan—Ullman-safety for disjunctions may be treated differently than their DeMorgan equivalent of negation combined with conjunction. Interestingly both directions are possible: queries with disjunction can be safe (whose DeMorgan equivalent with negation and conjunction is not), but queries with disjunctions can also be unsafe (yet they become safe after applying DeMorgan). Examples are provided hereinbelow:
(1) With reference to Example 1 described hereinabove, where applying DeMorgan to a query with disjunction creates an unsafe query without disjunction because the first negation violates the Ullman safety conditions [84].
(2) Example 3.29 by Ullman [84] shows the DRC query

$$\{ ( x , y , z ) \vert r ( x , y , z ) ∧ ¬ ( p ( x , y ) ∨ s ( y , z ) ) \}$$

that is not “safe” according to Ullman's definitions of safety, because the subformula p(x, y) ∨ s (y, z) violates the syntactic safety condition that whenever an ∨ operator is used, the two formulas connected must have the same set of free variables. However, by applying DeMorgan on the negated subformula and then “flattening” (i.e., no ∧ node appears as a child of another ∧ in the AST) the pattern-equivalent query is derived:

$$\{ ( x , y , z ) \vert r ( x , y , z ) ∧ ¬ p ( x , y ) ∧ ¬ s ( y , z ) \}$$

which is safe because all three variables in the conjunction are limited by the positive conjunct r (x, y, z).

Comparison of the safety criterion used herein with Ullman's safety criterion-Ullman's safety criterion [83] may be notably more restrictive in an important way. It not only disallows universal quantifiers, it also includes a requirement that all free variables need to be bound to a domain for all existentially quantified subformulas, such as “∃r₁ ∈ R₁, . . . , rₖ ∈ Rₖ [φ]”. This requirement is motivated by the fact that any such safe formula has a direct and natural translation into Datalog [83] and thus also Relational Algebra (RA). However, this restriction forbids nested correlated queries that are allowed by safety conditions of embodiments and also by SQL.

For example, consider the following subformula of query (12) in Example 8:

$$¬ ( ∃ s ∈ S [ ¬ ( ∃ {r}_{2} ∈ R [ r . A = {r}_{2} . A ∧ {r}_{2} . B = s . B ] ) ] )$$

In Ullman's formalism and the notation of an example embodiment, it would be written as:

$$¬ ( ∃ s [ s ∈ S ∧ ¬ ( ∃ {r}_{2} [ {r}_{2} ∈ R ∧ r . A = {r}_{2} . A ∧ {r}_{2} . B = s . B ] ) ] )$$

The free variable r violates Ullman's safety condition in the maximal conjunction “s ∈ S ∧¬( . . . )” because r is free but not “limited”, as it only appears in the 2nd conjunct “¬(∃r₂[ . . . ])” which is negated.

As a consequence, Ullman's safe queries do not include certain relational query patterns that SQL allows (e.g., correlated nested subqueries) and that also the safety condition used herein allows. This means some SQL queries would be classified as unsafe according to Ullman-safety. On the other hand, Ullman's conditions allow using the free variables multiple times in arbitrary ways in a formula, which makes the inductive translation from RA shorter, yet does not add any pattern expressiveness.

One single binding predicate per output attribute—The definition of safety used herein may not allow an output attribute to be bound more than once, except if the multiple bindings correspond to disjunction in which case they are required. This requirement can simplify the reading since every output attribute is connected via one equality predicate to exactly one table column (for each disjunct). This requirement may not remove any expressiveness since it is always possible to remove multiple bindings except for one and replace them with join predicates, and one single binding via an equijoin is always required by safety conditions (e.g., Ullman [83] defines this condition with the notion of a “limited variable” which is bound via a sequence of equijoins to a domain).

Two illustrating examples are provided hereinbelow in Examples 10 and 11.

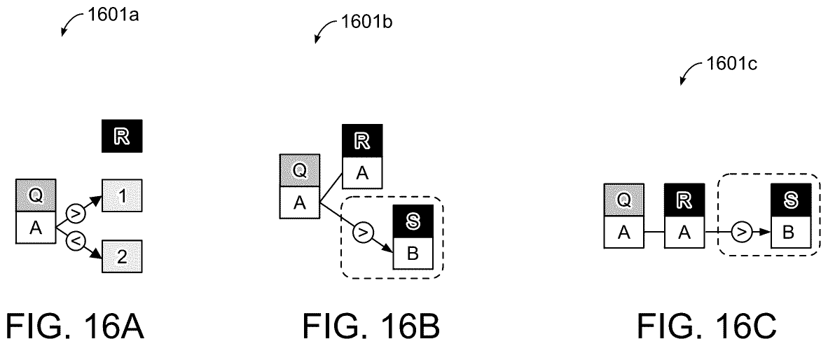

FIGS. 16A-16C illustrate representations 1601a-c, generated using embodiments, of well-formed TRC queries. The TRC queries, as described hereinbelow with reference to Example 10, may be well-formed TRC queries, but only the representation 1601c of FIG. 16C may be safe according to safety conditions defined herein.

Example 10. First, consider the following well-formed but unsafe TRC query (FIG. 16A):

$$\{ q ( A ) \vert ∃ r ∈ R [ q . A > 1 ∧ q . A < 2 ] \}$$

It is not domain-independent and returns all (possibly infinite) domain values between 1 and 2, as long as the table R is not empty. Next, consider the following unsafe but domain-independent query (FIG. 16B):

$$\{ q ( A ) \vert ∃ r ∈ R [ q . A = r . A ∧ ¬ ( ∃ s ∈ S [ q . A > s . A ] ) ] \}$$

It is unsafe according to the safety definition used herein as the output attribute q.A is referenced twice. To make it safe, one occurrence can be removed and replaced with r.A to which q.A is equated in the binding predicate (FIG. 16C):

$$\{ q ( A ) \vert ∃ r ∈ R [ q . A = r . A ∧ ¬ ( ∃ s ∈ S [ r . A > s . A ] ) ] \}$$

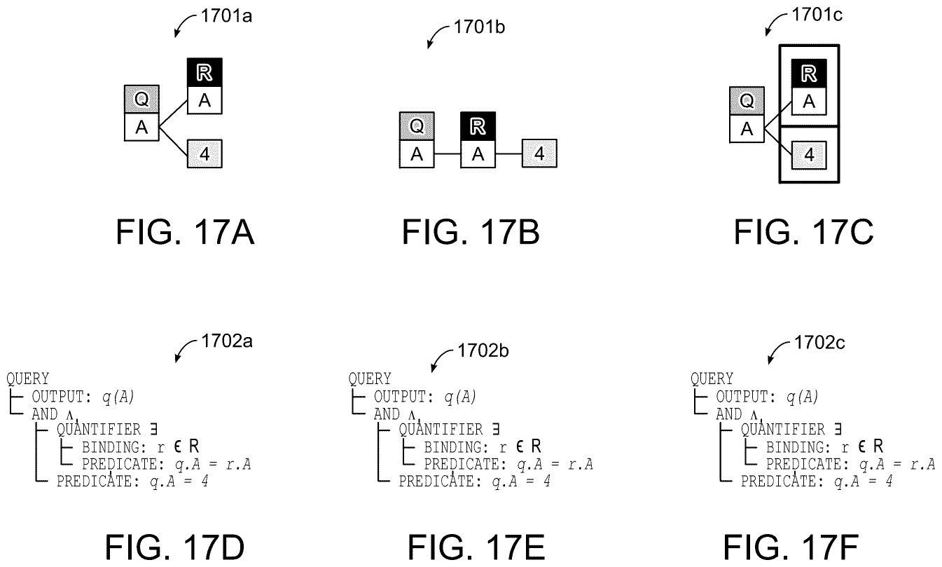

FIGS. 17A-17F illustrate graphical representations 1701a-c of three well-formed TRC queries (FIGS. 17A-17C) and their corresponding ASTs 1702a-c (FIGS. 17D-17F), according to an example embodiment. While all queries may be well-formed only the representation 1701b of FIGS. 17B (representing the AST 1702b of FIG. 17E) and the representations 1701c of FIGS. 17C (representing the AST 1702c of FIG. 17F) are safe according to safety conditions defined herein.

Example 11. Consider the following well-formed TRC query (FIGS. 17A and 17D):

$$\{ q ( A ) \vert ∃ r ∈ R [ q . A = r . A ] ∧ q . A = 4 \}$$

The query may be well-formed but not safe according to the definitions of safety as used herein because q.A is bound more than twice, and those bindings are connected in the AST. The query, however, is equivalent to the following safe query (FIGS. 17B and 17E):

$$\{ q ( A ) \vert ∃ r ∈ R [ q . A = r . A ] ∧ r . A = 4 \}$$

Notice how the single output edge from q.A may make the resulting representation generated using an embodiment easier to read. The following slight variation also binds q.A twice, but those bindings are connected via a disjunct and are thus needed (FIGS. 17C and 17F):

$$\{ q ( A ) \vert ∃ r ∈ R [ q . A = r . A ] ∨ q . A = 4 \}$$

Proof of correctness of safety definition —

Lemma 11. The four conditions given with respect to explicit safety are a valid safety restriction, i.e., the resulting safe TRC fragment is relationally complete and every safe TRC query is domain-independent.

It may suffice to prove two steps: (1) The safe fragment is relationally complete. This may be shown by giving a constructive translation of any relational algebra query into that fragment. (2) Every query expressed in that fragment is domain-independent.

(1) RA→safe TRC: The proof for this direction is an adaptation of the proof of Lemma 3.6 in [84]. It may be shown by induction on the number of operators in the relational algebra expression E that there is a TRC formula, with a single free tuple variable q, that defines the same relation as E.

The basis, zero operators, may require consideration of two cases: E is either a database relation R or (a relation of) constants. If E is a relation R of arity k and schema (A₁, . . . ,Aₖ) then formula

$$∃ r ∈ R [ q \cdot {A}_{1} = r \cdot {A}_{1} ∧ … ∧ q \cdot {A}_{k} = r \cdot {A}_{k} ]$$

suffices and is safe. If E is a constant relation, say {r₁, . . . , rₙ} with header H=(A₁, . . . ,Aₖ), consisting of n tuples of arity k, then the TRC formula can be written as

$$( q \cdot {A}_{1} = {r}_{1} \cdot {A}_{1} ∧ q \cdot {A}_{2} = {r}_{1} \cdot {A}_{2} ∧ … ∧ q \cdot {A}_{k} = {r}_{1} \cdot {A}_{k} ) ∨ ( q \cdot {A}_{1} = {r}_{2} \cdot {A}_{1} ∧ q \cdot {A}_{2} = {r}_{2} \cdot {A}_{2} ∧ … ∧ q \cdot {A}_{k} = {r}_{2} \cdot {A}_{k} ) ∨ … ( q \cdot {A}_{1} = {r}_{n} \cdot {A}_{1} ∧ q \cdot {A}_{2} = {r}_{n} \cdot {A}_{2} ∧ … ∧ q \cdot {A}_{k} = {r}_{n} \cdot {A}_{k} )$$

Notice that rᵢ.Aⱼ is a constant for all i ∈ [n] and j ∈ [k]. Thus, the above formula is safe.

For the induction, consider an expression whose outermost operator is one of 5 operators: Union ∪, difference ¬projection π, Cartesian product x, or selection σ.

Case 1: E=E1 ∪ E2: From the induction, it may be assumed that there are safe TRC formulae (φ₁ and (φ₂ for Eland E2, respectively. From the definition of the union operator, E1 and E2 must have the same arities and schemas. By renaming if necessary, the lone free tuple variable in both φ₁ and φ₂ may be assumed to be q. Because E1 and E2 have the same arity, the free tuple variables of φ₁ and φ₂ must also have the same arity, thus renaming is permitted. Then φ₁∨φ₂ is a safe TRC formula for E.

Case 2: E=E₁-E₂: As in case 1, assume there are formulas φ₁ and φ₂ for E₁ and E₂ with free variable q, respectively. By the definition of the set difference, E₁ and E₂ must have the same arities and schemas. From the induction, it may be known that each attribute q.Ai, both φ₁ and φ₂ contain binding predicates of the form q.Aᵢ=x₁i and q.Aᵢ=x₂ᵢ, respectively (here each xⱼᵢ is either a constant or an attribute in an existentially quantified relation). Let φ′₂ be the formula obtained from φ₂ by replacing every binding predicate q.Aᵢ=x₂ᵢ by x₁ᵢ=x₂ᵢ. Then φ₁∧^{¬}φ₂ is a safe TRC formula for E and its free variables only appear in the non-negated subformula cpi.

Case 3: E=π_{A}_{ᵢ₁}_{, . . . , A}_{_{id}} (E1): Let φ₁ be a safe TRC formula for E1 with a single free variable q1 of arity k, k≥d. From the induction, φ₁ contains binding predicates of the form q₁.Aᵢ=xᵢ for x ∈ [k]. Then a formula for E, with free variable q of arity d, is identical to φ₁ where every binding predicate q₁.Aᵢ=xᵢ for i ∈ [d] is replaced by q.Aᵢ=xᵢ, and every binding predicate for i ∈ {d+1, . . . , k} is removed.

Case 4: E=E1×E2: Let φ₁ and φ₂ be two TRC formulas for E₁ and E₂ with free variables q₁ and q₂ of arities k₁ and k₂, respectively. As before, q₁ and q₂ may be assumed to be bound with binding predicates q₁.Aᵢ=x₁ᵢ, i ∈ [k1] and q₂.Aᵢ=x₂ᵢ, i ∈ [k2], respectively. If necessary, the attributes of q₁ and q₂ may be renamed in their binding predicates such that they are disjoint. WLOG, q₁ then has attributes A₁, . . . ,Aₖ₁ and q₂ has attributes Aₖ₁₊₁, . . . ,Aₖ₁₊ₖ₂. The tuple variables may be renamed in the binding predicates of ‘φ₁ and’φ₂ such that they use the same variable q (i.e., q.Aᵢ=x₁ᵢ, i ∈ [k1] in φ₁ and q.Aᵢ₊ₖ₁=, x₂ᵢ ∈ [k2] in φ₂). The TRC formula for E, with lone free variable q of arity k₁+k₂, is φ₁∧φ₂. Finally, it may be assumed that whenever possible, the resulting formula φcan be reformulated to be maximally scoped (i.e., the A can be pushed behind existential quantifiers).

Case 5: E=σ_{c} (E₁): Here, ⊏ can be a logical condition that combines join and selection predicates defined over attributes from E₁ with an arbitrary nesting of logical operators ∧, ∨, ¬. Let φ₁ be a safe TRC formula for E₁ with single free variable q, and let c′ be c in which references to tables in E₁ are replaced with appropriate tuple variables from φ₁. Then a formula for E, with free variable q is φ₁ ∧c′.

(2) Every safe TRC query is domain-independent: This statement follows immediately from the definition of safety and observing that every occurrence of the single free variable q is possible only via a binding predicate, i.e., a predicate that binds attributes of q to either a column of a table or a constant, and thus to a finite set of domain values.

### Additional Details of Example Solution with Anchor Relations

Proof of Lemma 6—The proof follows from a recursive application of standard logical transformations [8] and observing that they do not change the atoms of the AST, and thus neither the predicates nor the table signature.

Let φ₁, . . . , φₖ represent any well-formed formulas. Then the following transformations can preserve the atoms:
(1) DeMorgan's law for universal quantifiers: (∀r₁ ∈ R₁, . . . , ∀rk ∈ Rₖ [φ]) ¬(∃r₁ ∈ R₁, . . . , ∃rₖ ∈ Rₖ [¬(φ)]). Notice here that the binding atoms (rᵢ ∈ Rᵢ) stay the same despite the quantifiers changing.
(2) Removing implications: ((φ₁)→(φ₂))=((¬(φ₁)∨(φ₂))
(3) DeMorgan's law for disjunctions: (φ₁)→(φ₂))=(¬(φ₁)∨(φ₂))
(4) DeMorgan's law for conjunctions: ((φ₁∧(φ₂ ∧ . . . ∧ φₖ)=¬(¬((φ₁) ∨ ¬((φ₂) ∨ . . . ∨ ¬(φₖ)
(5) Removing double negations: ¬(¬(φ₁))=(φ₁)

The transformations can be applied in order (1)→(2)→(3)→(5) from the outside inwards and thus finish in polynomial time.

A comparison of ASTs for TRC^{¬∃∧∨} and TRC^{¬∃∧} is provided hereinbelow.

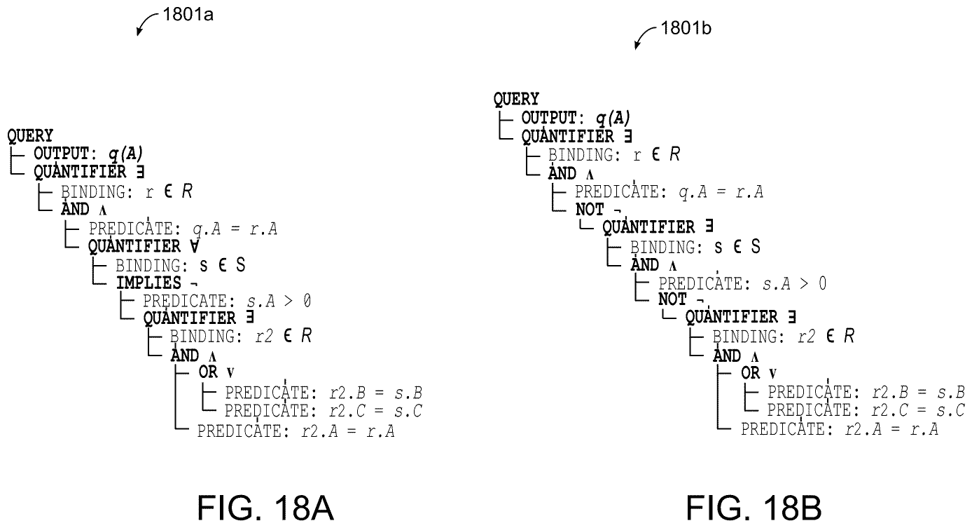

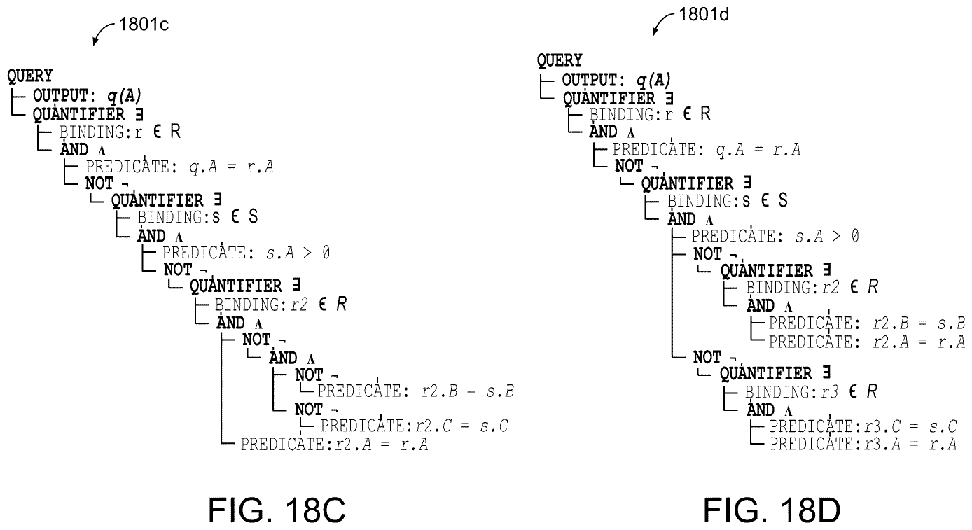

FIGS. 18A-18D illustrate ASTs 1801a-d of logically identical queries described hereinabove with reference to Example 3. FIGS. 18A-18C may include identical leaf nodes (despite having a varying vocabulary for internal nodes) and thus may also represent the same relational pattern. FIG. 18D may change the table references and thus also leaf nodes. Additionally, FIGS. 18B and 18C may use an increasingly smaller vocabulary for internal node, thus becoming bigger.

Proof of Theorem 7—Translation from Relational Diagrams with anchor relations to TRC^{¬∃∧}.

According to an example embodiment, a reverse 5-step translation from any valid Relational Diagram with anchor relations to a valid and unique TRC^{¬∃∧} expression is described hereinbelow.
(1) Determine the negation hierarchy: From the nested canvas partitions, create the nested scopes of the negation operators of the later TRC^{¬∃∧} expression, connected via conjunction whenever a partition has multiple children in the negation hierarchy. With respect to FIG. 7A described hereinabove, this interpretation can lead to φ=(¬(¬(¬(_) ∧ ¬(_))). Here and in the following “_” stands for a placeholder.
(2) Optional output table: If the diagram contains an output relation Q with non-empty header H in the base partition (which represents the only free variable), then use the set builder notation {q(A)|φ)}.
(3) Binding predicates for table variables: Each input relation in a partition corresponds to an existentially-quantified table variable. WLOG, a small letter can be used indexed by the number of occurrences for repeated tables. Quantified table variables can be added in the respective scope of the negation hierarchy. Similar to Relational Diagrams, leaves of the partition may be required to not be empty and contain at least one relation (whether input or built-in). The query may now be formulated as:

$$\{ q ( A ) \vert ∃ {r}_{1} ∈ R [ ¬ ( ∃ {s}_{1} ∈ S [ ¬ ( ∃ {r}_{2} ∈ R [ ¬ ( ¬ ( \_ ) ∧ ¬ ( \_ ) ) ] ) ] ) ] \}$$

(4) Join and selection predicates for anchor relations: For each unary built in relation θc, a selection predicate template_θc can be placed into the appropriate negation scope (here “_” is a placeholder for table attribute(s) to be added later). For each binary built in relation θ, a join predicate template “_θ_” can be placed into the appropriate negation scope. Whenever two table attributes R.A and S.B are directly connected via an edge without any built-in predicate in between, then an equijoin predicate “rᵢ.A=sⱼ.B” occurs in the same negation scope as one of their relations R or S. In this case, an equijoin predicate template “_=_” can be placed into the negation scope of either R or S, whichever one appears most deeply nested (they may also be equally nested). According to the present example, the equijoin between the two R tables (“r1.A=r2.A”) may be in the same partition as r2. Multiple such join and selection predicates can be connected via conjunctions within the same negation scope. At this point, the formula template is.

$$\{ q ( A ) \vert ∃ {r}_{1} ∈ R [ \_ = \_ ∧ ¬ ( ∃ {s}_{1} ∈ S [ \_ > 0 ∧ ¬ ( ∃ {r}_{2} ∈ R [ ¬ ( ¬ ( \_ = \_ ) ∧ ¬ ( \_ = \_ ) ) ∧ \_ = \_ ] ) ] ) ] \}$$

(5) Replace edges with table attributes: For each edge between a table attribute and an anchor relation, the table attribute reference can be added to the appropriate predicate template. For example, “_>0” gets replaced by “s2>0” and the second occurrence of “_=_” gets replaced by “r2.B=s1.B”. The final TRC query is then:

$$\{ q ( A ) \vert ∃ {r}_{1} ∈ R [ q \cdot A = {r}_{1} \cdot A ∧ ¬ ( ∃ {s}_{1} ∈ S [ {s}_{1} \cdot A > 0 ∧ ¬ ( ∃ {r}_{2} ∈ R [ ¬ ( ¬ ( {r}_{2} \cdot B = {s}_{1} \cdot B ) ∧ ¬ ( {r}_{2} \cdot C = {s}_{1} \cdot C ) ) ∧ {r}_{2} \cdot A = {r}_{1} \cdot A ] ) ] ) ] \}$$

This 5-step translation may guarantee that the resulting TRC query is well-formed and uniquely determined up to (1) renaming of the tuple variables; (2) reordering the predicates in conjunctions (commutativity of conjunctions), and (3) flipping the left/right positions of attributes in each predicate. Neither of these possible transformations changes the semantics of the query. It may follow that Relational Diagrams with anchor relations are sound, and their logical interpretation is unambiguous.

Valid Relational Diagrams with Anchor Relations

The validity conditions for Relational Diagrams with anchor relations can be similar to Relational Diagrams and follow from the conditions for each of the 5 steps of the translation to TRC. The differences are: (1) Edges contain no labels and represent equijoins. (2) Built-in predicates can be of two types (unary and binary) and have one of 6 comparison operators. (3) Edges can only happen between attributes of tables that are descendants of each other, and only between input relations, or between one input relation and one built-in predicate. (4) The optional single output table needs to be outside any negation scope and disjunction box, but each attribute can be connected to an arbitrary number of tables in any partition.

### Additional Details Regarding Embodiments

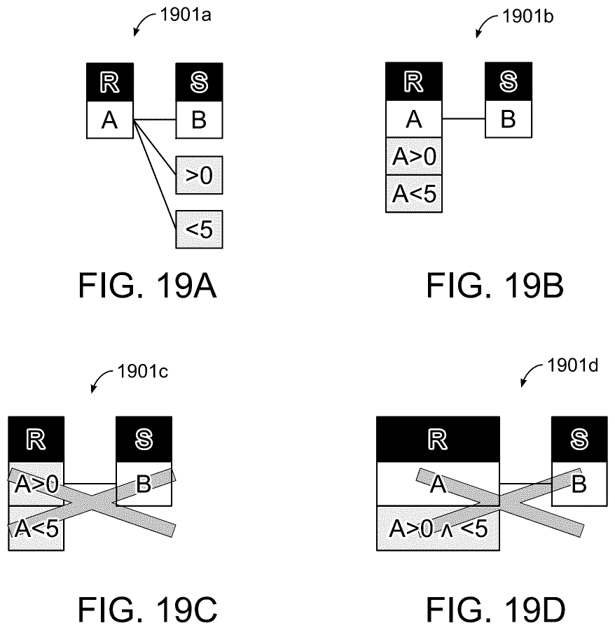

FIGS. 19A-19D illustrate four variants of graphical representations 1901a-d of a query, according to an example embodiment. In particular, FIGS. 19A and 19B illustrate valid graphical representations 1901a-b, respectively, of the query generated using an embodiment, as described hereinbelow.

### Example 12 (Canonical selections). Consider the Boolean query

$$∃ r ∈ R , ∃ s ∈ S [ r \cdot A = s \cdot B ∧ r \cdot A > 0 ∧ r \cdot A < 5 ]$$

shown in 4 variants. FIG. 19A may be a canonical representation 1901a and may be topologically uniquely determined. Representation 1901a defines formal semantics and is necessary to represent pattern-equivalent nested disjunctions. FIG. 19B may be a canonical representation 1901b for Relational Diagrams. Representation 1901b repeats the attribute of a table for every selection predicate and fuses the selections into the attributes. This representation functionality, e.g., 1901b, may be applied as a visual shortcut whenever possible. FIG. 19C may be considered as a possible further shortcut, however, the choice of the selection attribute being fused into the join is non-deterministic, which is why such a representation 1901c may not be recommended or permitted. FIG. 19D uses a symbolic representation 1901d for conjunction A and is thus not diagrammatic.

### Proof of Theorem 9—Modified Translation for Example Embodiment

Theorem 9 may be proven by giving a translation from TRC^{¬∃∧∨} to a representation generated using embodiments. The translation includes a simple adaptation of the translation from TRC^{¬∃∧} to Relational Diagrams with anchor relations with two modifications:
(1) Instead of anchor relations, visual shortcuts may be used. This may result in transforming TRC into TRC^{¬∃∧∨}, which can preserve safety conditions. Selection and join predicates can be represented directly via their shortcuts and do not need to go the full route via anchor relations.
(2) The second step of “Creating canvas partitions” can also include disjunction boxes in addition to negation scopes: each subtree rooted below a negation ¬ can receive a negation scope, and each subtree rooted below a disjunction node V can receive a disjunction box. Sibling boxes can then either be connected with a dotted line, or adjacent to each other.

The first step of “Determining the negation hierarchy” may be modified: From the nested canvas negation and disjunction partitions, the nested scopes of the negation and disjunction operators of the later TRC^{¬∃∧∨} expression can be created. For the graphical representation 901b of FIG. 9B, this interpretation may to φ=¬(¬(_ ∧ _)).

Embodiments can be exponentially more succinct than Relational Diagrams. A proof for Proposition 10 that embodiments generate exponentially more succinct representations is provided herein and may proceed in two steps: (1) showing that every Relational Diagram can be immediately interpreted as a representation generated by an embodiment (with the exception of “union cells” (or union boxes), where such an embodiment replaces multiple output relations with only one), and (2) giving a parameterized query that has an exponentially bigger size than a Relational Diagram.

Embodiments can have equal or smaller size. It may follow from the discussion of embodiments without anchor relations and the translation from Relational Diagrams with anchor relations to TRC^{¬∃∧}, described hereinabove, that every Relational Diagram without union boxes is immediately also a according to the methods of embodiments described herein. For every Relational Diagram with union boxes, all the output relations in the union boxes can be replaced with one single output relation outside the disjunction boxes to give a valid representation generated using an embodiment of the present disclosure. It can follow that for all Relational Diagrams there is a representation generated using an embodiment of equal or smaller size. An example is provided hereinbelow.

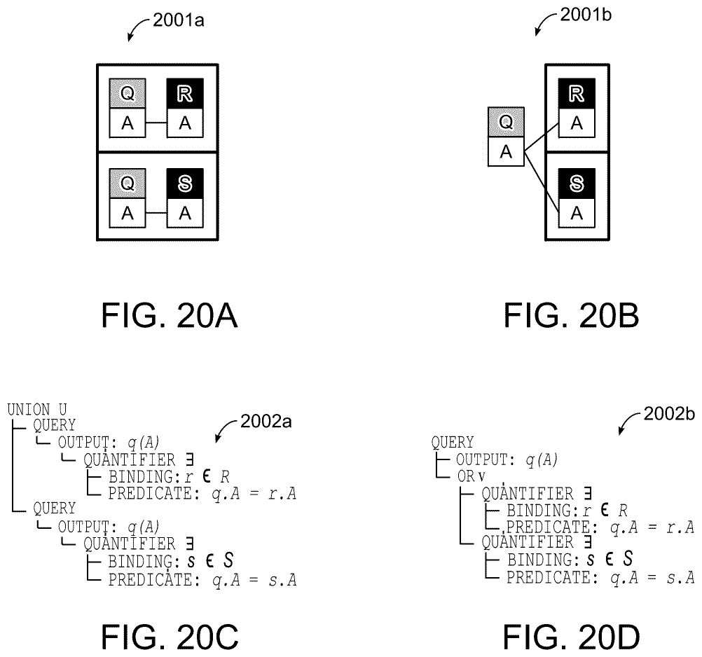

FIGS. 20A and 20B illustrate graphical representations of queries generated using Relational Diagram functionality 2001a and an embodiment 2001b, respectively.

FIGS. 20C and 20D illustrate corresponding ASTs 2002a and 2002b of the graphical representations 2001a-b of FIGS. 20A and 20B, respectively.

### Example 13 (Example 1 Continued). Relational Diagrams May Need to Transform Query (1) into a Union of Disjunction-Free Queries

$$\{ q ( A ) \vert ∃ r ∈ R [ q \cdot A = r \cdot A ] \} ⋃ \{ q ( A ) \vert ∃ s ∈ S [ q \cdot A = s \cdot A ] \}$$

As a consequence, the output table may be repeated twice, each in a separate union cell and with an identical attribute signature, just like Datalog, as shown in representation 2001a of FIG. 20A. In contrast, the representation 2001b generated using an example embodiment has maximally one output relation, similarly to TRC. Therefore, FIG. 20A may not be a valid representation according to the principles of the embodiments described herein. Instead, embodiments represent query (1) with one single output table as shown by representation 2001b of FIG. 20B. FIGS. 20C and 20D illustrate the corresponding ASTs 2002a-b of FIGS. 20A and 20B, respectively. It can be seen in FIGS. 20A-B how the Relational Diagram representation 2001a has the same atoms as the representation 2001b generated using embodiments, except for repeated output tables.

Proof Proposition 10. Consider the following parameterized Boolean TRC query:

$$∃ r ∈ R [ ( r \cdot A 1 = c 11 ∨ r \cdot A 1 = c 12 ) ∧ … ∧ ( r \cdot Ak = ck 1 ∨ r \cdot Ak = ck 2 ) ]$$

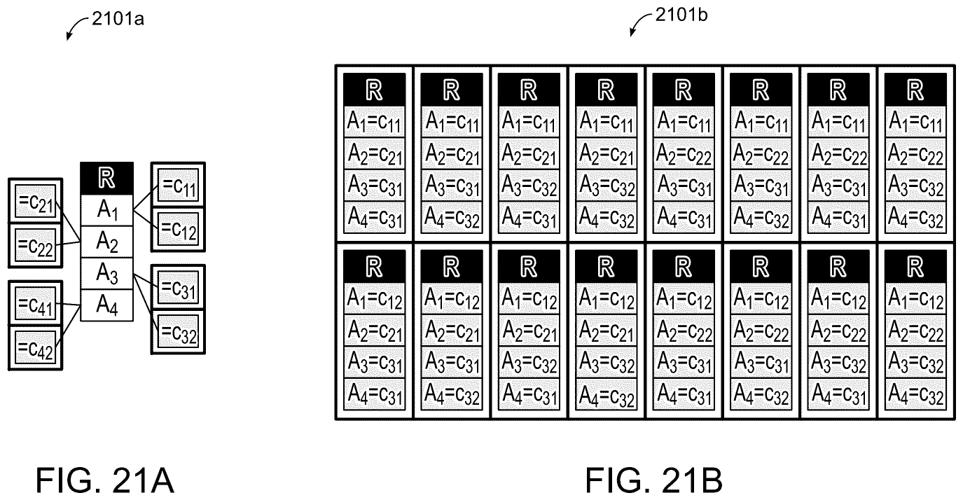

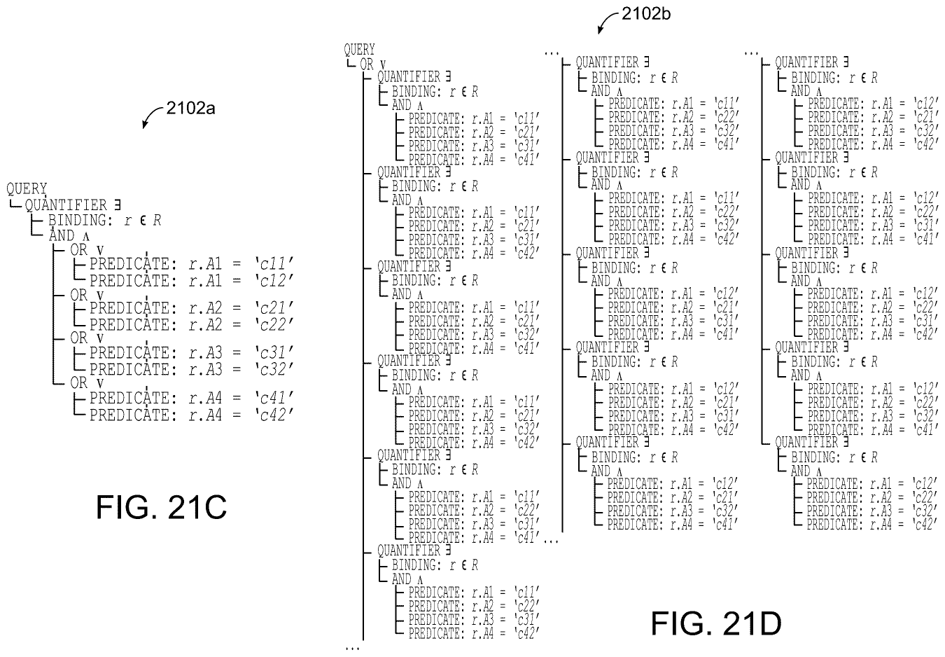

FIGS. 21A and 21B illustrate sizes of graphical representations 2101a and 2101b of a query of a given size k=4 generated using an embodiment (2101a) and Relational Diagrams (2101b).

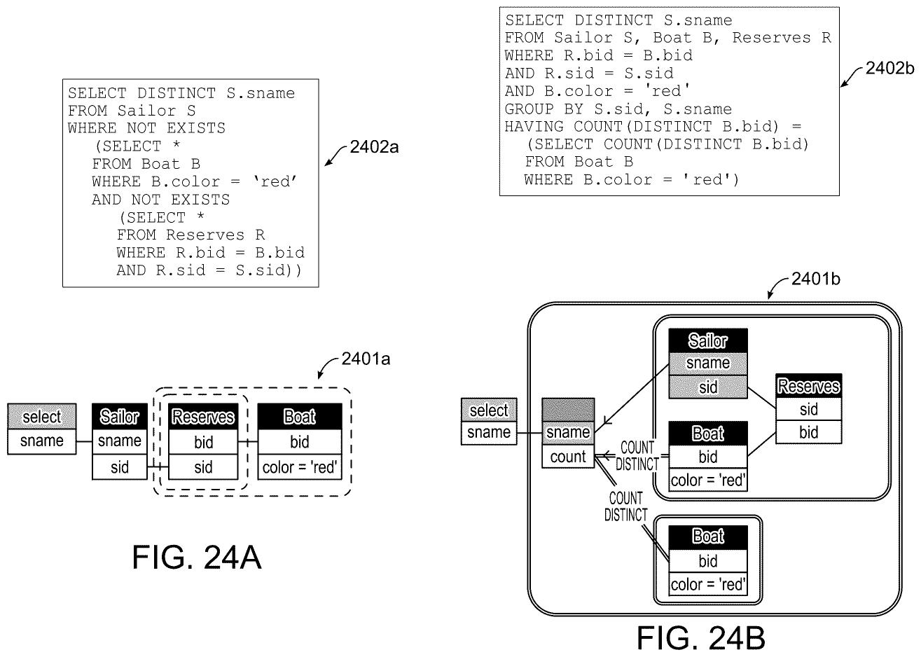

FIGS. 21C and 21D illustrate AST representations 2102a and 2102b corresponding to the graphical representations 2101a-b of FIGS. 24A and 24B, respectively.

The aforementioned query can be represented using embodiments with size Φ(k) in the number of symbols. Concretely, an example embodiment may use 5k+1 boxes and 2k edges, as exemplified by representation 2101a of FIG. 21A.

Relational Diagram functionality can represent the disjunction as DNF and thus first needs to transform the query into DNF:

$$∃ r ∈ R [ r \cdot {A}_{1} = {c}_{11} ∧ … ∧ r \cdot {A}_{k} = {c}_{11} ] ∨$$

$$∃ r ∈ R [ r \cdot {A}_{1} = {c}_{11} ∧ … ∧ r \cdot {A}_{k} = {c}_{k 2} ] ∨$$

$$…$$

$$∃ r ∈ R [ r \cdot {A}_{1} = {c}_{12} ∧ … ∧ r \cdot {A}_{k} = {c}_{k 2} ]$$

The DNF has 2k clauses and its size and also the size of the diagrams representation is thus O(2k). Concretely, Relational Diagram functionality requires (k+1)·2k boxes, as exemplified by representation 2101b of FIG. 21B.

Since every Relational Diagram is also a representation according to an example embodiment described herein (except for an inclusion of union cells), it can follow that embodiments provide an exponentially smaller representation than Relational Diagram functionality.

To demonstrate that TRC and embodiments have the same asymptotic size, the translation from TRC may succeed by first translating TRC into TRC^{¬∃∧∨} (which does not change the atoms, and hence the leaves) and then directly mapping the atoms to visual symbols: (1) binding atoms get mapped to relational tables; (2) join predicates get mapped to two attributes and a connecting line with label appropriate placed; (3) selection predicates get mapped to either one or two attribute boxes. The negation scopes and disjunction boxes are in 1-to-1 correspondences with the levels of negation and the appearance of disjunctions in the AST.

### Additional Details Regarding Example Enabling Features And Perceptual Choices

Disjunction boxes may be formalized as a visual shortcut for DeMorgan which can allow recovery of safety conditions for TRC. Disjunction boxes may also be reminiscent of the “union cells” used by Relational Diagrams and prior box-based approaches going back all the way to Peirce. The formalism provided herein with respect to embodiments can actually unify and generalize the major diagrammatic approaches for disjunction that have been surveyed earlier (thus all except text-based and form-based described herein with refence to FIGS. 3A and 3B) and the formalism provided herein recovers each diagrammatic approach as a special case.
(1) DeMorgan-based disjunctions: The semantics of embodiments may fundamentally build upon DeMorgan and it is thus an instance by replacing the shortcut with its semantics.
(2) Box-based disjunctions: visual shortcuts used for embodiments may be similar to Peirce [63], Shin [70], compound spider diagrams [49], and the union cells for Relational Diagrams [39]. However, (i) boxes in embodiments may not be just a union box but can be used in any nesting depth of the AST, which can give an exponentially more succinct representation. Furthermore, (ii) boxes in embodiments are semantically justified via the DeMorgan-fuse as a visual shortcut for the actual semantics.
(3) Edge-based disjunctions: Similar to Shin [70], disjunction boxes may be allowed to not merely be adjacent, but also connected via dotted lines. This may be motivated by: (i) lines connecting the boxes can give more flexibility in the placement of the boxes and allow disjuncts to be placed in non-adjacent areas and (ii) optional lines can also allow recovery of all prior edge-based solutions: In the grammar of node-link diagrams [87]“line marks” connect “point marks” (and not other line marks). Edge-based disjunctions, however, can draw specially highlighted or annotated lines between predicates, which are lines themselves (as described herein). As a basic visual construct, lines can make a connection between entities [12]. Thus, even if not shown, the lines connected via a disjunction line require some anchor points on the predicate edges. Disjunction boxes as used in embodiments, even if infinitesimally small, can give embodiments these anchors and formal semantics via DeMorgan-fuse boxes.
(4) Form-based disjunctions: Form-based approaches of disjunction like QBE [89] are not diagrammatic. However, vertically arranged boxes (alternative choices for the same predicate are shown in different rows) have become a familiar visual pattern. In order to mirror this familiar syntax showing disjunction boxes vertically aligned boxes may be recommended (as “enabling feature”).

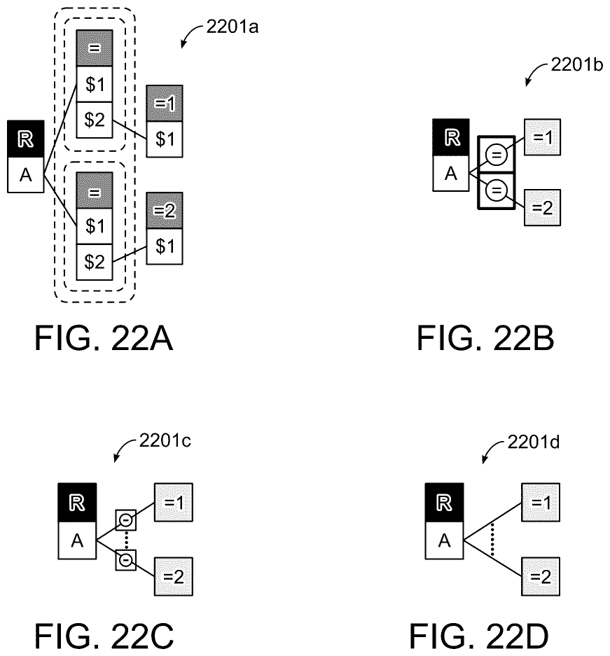

FIGS. 22B-22D illustrate graphical representations 2201b-d, respectively, of the query represented in FIG. 22A, generated using embodiments. The representations 2201b-d have different visual anchors or features, according to an example embodiment.

Example 14 (Example 7 continued). The disjunction ∃r ∈ R[r.A=1∨r.A=2] can be visualized in the spirit of edge-based disjunctions (as described herein with reference to FIG. 4D). Constants may not be semantically bound to particular negation scopes and the query can be expressed with built-in predicates as:

$$∃ r ∈ R , ∃ {c}_{1} ∈ “ = 1 ” , ∃ {c}_{2} ∈ “ = 2 ” [ ¬ ( ¬ ( ∃ {e}_{1} ∈ “ = ” [ r \cdot A = {e}_{1} \cdot \$1 ∧ {e}_{1} \cdot \$2 = {c}_{1} \cdot \$1 ] ) ∧ ¬ ( ∃ {e}_{2} ∈ “ = ” [ r \cdot A = {e}_{2} \cdot \$1 ∧ {e}_{2} \cdot \$2 = c 2 \cdot \$1 ] ) ) ]$$

FIG. 22A illustrates the atom-preserving representation 2201a as a Relational Diagram representation with anchor relations, and FIG. 22B illustrates the corresponding representation 2201b generated using an example embodiment. FIGS. 22C and 22D illustrate a process of making the anchors of the equijoins increasingly small, leading in the limit to the edge-based disjunction from FIG. 4D.

FIGS. 23A-23I illustrate representations 2301a-i of 3 queries generating using an example embodiment from textbook benchmarks that Relational Diagram functionality cannot pattern-represent.

FIGS. 23A-23C illustrate an SQL query 2301a (query 5 from [66]), AST representation 2301b of the query 2301a, and representation 2301c of the query 2301a generated using an embodiment, respectively. The query states, “Find the names of sailors who have reserved a red or a green boat.”

FIGS. 23D-23F are an SQL query 2301d (query 4 from [30]), AST representation 2301e of the query 2301d, and representation 2301f generated using an embodiment, respectively. The query states, “Make a list of project numbers for projects that involve an employee whose last name is ‘Smith’, either as a worker or as manager of the controlling department for the project.”

FIGS. 23G-23I are an SQL query 2301g (query 9 from [23]), AST representation 2301h of query 2301g, and representation 2301i generated using an embodiment, respectively. The query states, “Get part numbers for parts that either weigh more than 16 pounds or are supplied by supplier S2, or both.”

As described hereinabove with reference to FIG. 15, embodiments may be the only methodology of providing a graphical representation of a logical formula capable of representing all three of the aforementioned queries (2301a, 2301d, and 2301g) in addition to other queries within the textbook benchmarks.

### PatternVis: A Tool For Relational Pattern Visualization

An example embodiment is directed toward an interactive tool (which may be referred to herein as “PatternVis”) that can, when given a formula, e.g., an SQL query, and its schema, represent the relational pattern of the formula in an extended representation of Relational Diagrams. In particular, such an embodiment can represent groupings and aggregation in addition to the non-disjunctive fragment of Relational Diagrams.

Such an implementation may provide the following contributions, amongst others: (1) an interactive query visualization tool that can provide an unambiguous representation of nested queries with GROUP BY classes and aggregation and (2) an interface for identifying a correct output of a given aggregation query and database instance. For example, the interface may include a set of tasks involving multiple-choice questions. According to an example embodiment, users can choose to complete each task in one of three modalities (SQL only, PatternVis only, or both) and experience the varying difficulties in each modality.

Query understanding (or query reading) is a task of interpreting the intent behind a database query written in a specific query language. It may be critical for database users and various applications, including query reuse [100] and query semantics debugging [94]. It may also be increasingly important for verifying the queries written by LLMs via text-to-query interfaces [99]. However, query reading can be a difficult cognitive task [105] as it requires users to be familiar with the syntax of the query language and notice subtle details (like join predicates) which impact the query semantics.

Visualizations can help users understand complicated messages. A widely cited paper on learning styles found that “most people of college age and older (were) visual” and recommends using “schematics, graphs, and simple sketches” instead of verbal material alone [93]. Although visualizations may not always be beneficial for program understanding [103], recent user studies have provided evidence that representing logical constructs such as relational queries as diagrams instead of text can help users understand them faster and more accurately [97, 101]. Thus, a goal of formula (i.e., query) visualization can include designing diagrammatic representation systems for relational formulas that improve formula comprehension by depicting the logical structure of a given formula [99]. Another user study has shown the benefits of such diagrams for query formulation [102].

Recent computational experiments show that applying a relational bottleneck principle-focusing on object relationships—can enable rapid learning and pattern generalization in neural networks, potentially reflecting human cognition [108]. Diagrammatic representations, such as those generated by embodiments, may be a direct application of this principle, aligned with Gestalt principles that describe how the arrangement of visual elements relate to perceived relationships [109]. Thus, an advantage of logical diagrams generated by embodiments is that their overall structure emphasizes the relationship between objects involved in the query, rather than the syntax required for the query language to support the operation. This allows for efficient abstraction and generalization. The relationships between table references in a formula can be captured by the formula's relational pattern, which is the logical function the formula represents after treating each table reference as an independent base table [98]. To be effective, formula diagrams may be able to unambiguously represent all patterns of a given query language (i.e., they should be pattern-complete).

An embodiment, e.g., PatternVis, can use a visual query representation that extends Relational Diagrams [91] and can represent SQL queries with groupings, aggregations, and nested queries. PatternVis can be implemented in Python or another programming language.

FIGS. 24A and 24B illustrate graphical representations 2401a-b generated using Relational Diagram functionality (2401a) and an embodiment (2401b), respectively, and corresponding queries 2402a-b for a common problem of finding “sailors who reserved all red boots”. The query 2402a and graphical representation 2401a of FIG. 24A use a pattern from first-order logic and the query 2402b and graphical representation 2401b of FIG. 24B utilize grouping, aggregation, and nesting in a “HAVING” clause, as further described hereinbelow with respect to Example 15.

Example 15 (Universal query patterns). Consider the universal query asking for “sailors who reserved all red boats” on the sailors database Sailor(sid, sname, rating, age), Boat(bid, bname, color), Reserves(sid, bid, day) from the “cow database textbook” [104].

FIG. 24A shows a query 2402a pattern that uses only existential quantifiers and nested negation; it is thus expressible in relational calculus. FIG. 24B, on the other hand, shows a query 2402b that uses grouping and aggregation yet no negation. The query 2402b compares the count of different red boats reserved by each sailor with the total number of red boats.

In particular, these two queries 2402a-b use significantly different underlying logic to express this intention. The queries 2402a-b thus yield slightly different results. The query 2402a returns all sailors if there is not a single red boat in the database, while the query 2402b would return no sailor. With embodiments, e.g., PatternVis, patterns involving grouping, aggregation, and arbitrarily nested queries (even in the HAVING clause) can be represented and compared.

QueryVis [91] implemented an online demonstration that generated diagrams representing SQL queries. However, while QueryVis [91] supported some forms of grouping, QueryVis [91] was not relationally complete and did not support nested aggregate queries in the HAVING clause.

The original Relational Diagram [97] functionality improves certain aspects of QueryVis [91] and allows an unambiguous visual representation of first order logic (and thus any relationally complete language having the same expressiveness as relational algebra and relational calculus). On the other hand, an example embodiment, e.g., PatternVis, implements Relational Diagrams and extends them with support for grouping and aggregation.

SQLVis [102] provides a graph-based visual representation of queries. Because the SQLVis [102] system is designed to help users compose SQL queries, aspects of its visual design are tied to SQL syntax. Some logical relationships are expressed using text rather than diagrammatic elements. For instance, two tables joined by one or more predicates are depicted as connected by a single line.

DataPlay [90] is a tool that allows users to edit a query tree to receive feedback about updates to the output. Because the DataPlay [90] tool is catered towards interactive query writing rather than query representation, the visual representation does not emphasize the logic describing the relations between objects in the query. By design, the type of queries is limited to joins across foreign-primary key constraints, and there is no support for grouping.

Visual representations were used in a study by Sundin and Cutts to help users understand relational operations [107]. The authors [107] illustrated the transformation between the input and output of an operation (like projection) with icons and example databases with different numbers of columns. The focus of [107] is on transformations without negation. An example embodiment, e.g., PatternVis, may also use patterns to help users understand queries, but the patterns involve the whole query instead of individual data transformations. Embodiments may focus on logical relationships between tables and their attributes instead of example databases.

A recent survey of visual query languages [106] noted that their main weaknesses were low expressiveness, poor support for software engineering workflows, and lack of evaluations. Another recent survey of query visualizations [95] focuses on the relationally complete fragment only, yet for that fragment gives a consistent comparison by translating the same set of queries into different visualizations. Embodiments can address common issues with visual query languages while focusing on the complementary goal of query visualization, extending existing designs for a greater fragment of SQL and providing a tool where any user can input a query and quickly receive a principled diagram.

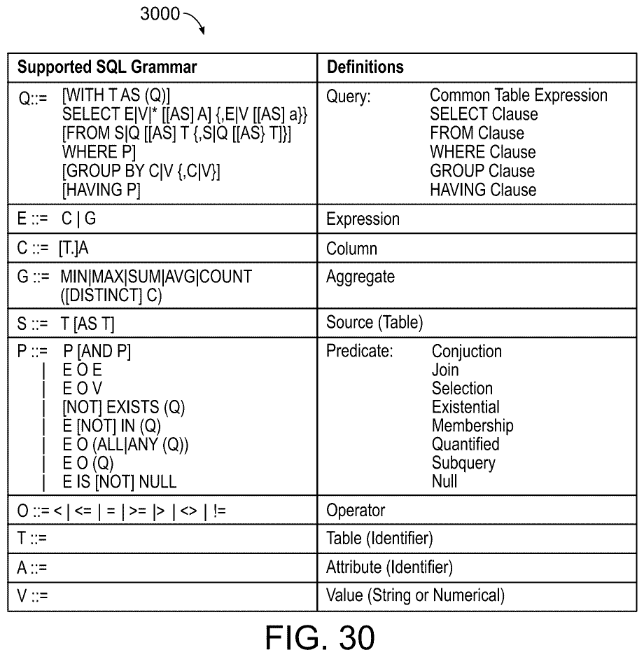

According to an example embodiment, PatternVis can be an interactive and unambiguous query visualization tool that supports the full disjunction-free fragment of relational calculus extended with nested grouping and aggregation. Embodiments can also implement additional subqueries such as derived tables (nested queries in the FROM clause) and common table expressions (CTEs), which previous work could not support [91, 97]. An example list of supported grammar is described herein with reference to FIG. 30.

The utility of relational patterns in practical applications may be further explored hereinbelow through a set of interactive activities that may enable users to experience the difficulty of understanding queries in different modalities and experience how visualizing logical patterns can help users interpret a given SQL query. Embodiments may utilize formulations as described herein, e.g., RepresentationB, to generate the graphical representations or visualizations of queries.

### Diagram Design

Identifying similar relational query patterns across languages may not be trivial, as different languages may adopt distinct paradigms (like procedural or declarative) to express the same logical pattern. In addition, a language like SQL can allow several syntactic variants to express the same query pattern. Embodiments can help users abstract from the syntax and be able to focus on the pattern alone.

The diagram design of an example embodiment may include an extension of Relational Diagrams [97], which covered tables, attributes, selection and join predicates, and negation scopes. The visual formalism can express relational operations regardless of the syntactic variant of the query. An example embodiment may build upon that design by adding visual constructs for grouping, aggregation, and arbitrary subqueries, even in the HAVING clause.

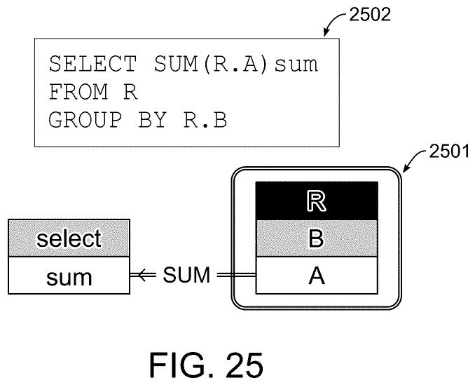

FIG. 25 illustrates an example simple query 2502 and a corresponding graphical representation 2501 with grouping and aggregation, according to an example embodiment. Previously, the QueryVis demonstration supported only a limited set of aggregation, such as the example in FIG. 25 [91, 101]. The visualization 2501 features a query that groups table R by attribute B then returns an aggregate from each group. Meanwhile, FIG. 24B shows a query using a nested query in the HAVING clause, which cannot be visualized using existing methods.

As described herein, an example embodiment may focus on disjunction-free fragments of SQL with grouping, which covers fundamental logical operations. However, it should be understood that embodiments can be extended to include disjunctions, for example, using the RepresentationB graphical representation functionality described hereinabove. The design of grouping and aggregation can be orthogonal to recent ideas on disjunction, so embodiments may incorporate new paradigms such as disjunction boxes [96] into the visualizations.

Another valuable example of the common query patterns that may be represented distinctively by the visualization design of embodiments are the four categorical propositions from logic (some/none/all/notall) [110]. These logical patterns can apply to many different contexts. For example, with the sailor schema from Example 15, new expressions like “all red boats are owned by some sailors” or “no red boats are owned by any sailors” may be found just by substituting the schema and predicates. By focusing the diagrams on the logical relations between table references of a query, the diagrams can allow a generalizable interpretation of the pattern across different relational schemas and syntactic options.

Overall, the diagram design used in an example embodiment can aim to use a minimal number of visual constructs to unambiguously represent a query's logic across any schema or syntax.

### Example Implementation

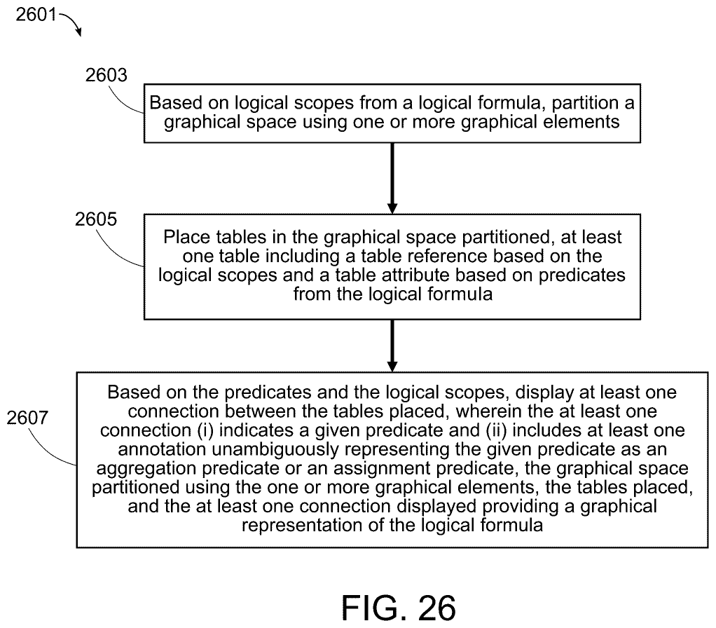

FIG. 26 illustrates a flowchart of an example embodiment of a method 2601 for providing a graphical representation, e.g., the graphical representation 2700 described herein with respect to FIG. 27B, of a logical formula, e.g., the logical formula 2701 described herein with respect to FIG. 27A. According to an example embodiment, the method 2601 may be carried out for a given logical formula by, based on logical scopes, e.g., the logical scopes 2762, 2766 of FIG. 27A, of a logical formula, partitioning 2603 a graphical space, e.g., the graphical space 2702 of FIG. 27B, using one or more graphical elements, e.g., the graphical elements 2704, 2706, 2708 of FIG. 27B.

The method 2601 further includes placing 2605 tables, e.g., the tables 2710, 2712, 2714, 2716 of FIG. 27B, in the graphical space partitioned. At least one table, e.g., the table 2712 of FIG. 27B, includes a table reference, e.g., the table reference 2718 of FIG. 27B, based on the logical scopes and a table attribute, e.g., the table 2720, based on predicates, e.g., the predicate 2768 of FIG. 27A, of the logical formula.

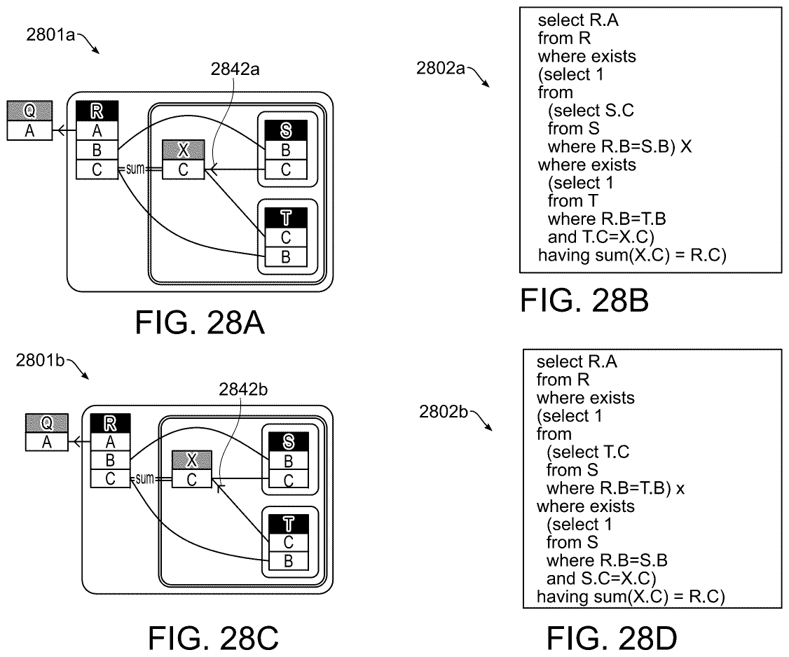

The method 2601 further includes, based on the predicates and the logical scopes, displaying 2607 at least one connection, e.g., the connections 2722, 2724, 2726, 2728, 2730 of FIG. 27B, between the tables placed. The at least one connection indicates a given predicate. Further, the at least one connection includes at least one annotation, e.g., the annotation 2736, 2732 of FIG. 27B unambiguously representing the given predicate as an aggregation predicate or an assignment predicate. For example, as illustrated with respect to assignment predicates of the annotations 2842a, 2842b described herein with respect to FIGS. 28A and 28C, an order of operation may be important with regards to an output of a query. As an additional example, annotation 2736 described herein with respect to FIG. 27B includes both an assignment predicate and an aggregation predicate. In some embodiments, an order of the predicates may be defined, e.g., an aggregation is performed prior to an assignment. The graphical space partitioned using the one or more graphical elements, the tables placed, and the at least one connection displayed provide a graphical representation of the logical formula.

FIGS. 27A and 27B illustrate a query 2701 with an aggregation and a graphical representation 2700 generated thereof, according to an example embodiment, e.g., the method 2601 of FIG. 26. Based on the method 2601 of FIG. 26, the query 2701 of FIG. 27A may be translated into the graphical representation 2700 of FIG. 27B.

The graphical representation 2700 includes a graphical space 2702 partitioned using graphical elements 2704, 2706, 2708 based on logical scopes from the logical formula 2701 of FIG. 27A. The logical scopes include an aggregation scope indicated by graphical element 2708 and existential scopes indicated by graphical elements 2704 and 2706.

The graphical representation 2700 further includes tables 2710, 2712, 2714 and 2716 placed within the graphical space 2702. The table 271θ is an output table 2710 and the table 2714 is a virtual table, which may be useful for enabling aggregation predicates. At least one table, e.g., table 2712 includes a table reference 2718 based on the logical scopes and a table attribute 2720 based on predicates from the logical formula 2701. The output table 2710 may indicate an output of the query.

The graphical representation 2700 further includes connections 2722, 2724, 2726, 2728, and 2730. The connections can unambiguously represent an aggregation predicate or an assignment predicate using annotations, for example, annotations 2732, 2734, 2736. As indicated, the annotation 2736 indicates an aggregation predicate and an assignment predicate. According to an example embodiment, aggregation predicates can include sum, group by, or having predicates.

FIGS. 28A-28D illustrate graphical representations 2801a-b and corresponding SQL queries 2802a-b of logical formulae including aggregation predicates and assignment predicates, according to an example embodiment. It may be noted that while visually similar, the queries 2802a-b return different results. Implementation of assignment predicates, e.g., annotations 2842a, 2842b, may allow defining of a precedence between alternative predicates, which is separate from hierarchies (e.g., those of logical scopes). Furthermore, the annotations 2842a, 2842b allow for interpretation of assignment scopes without ambiguity.

FIGS. 28A and 28B are a graphical representation 2801a and query 2802a, respectively, of the following query:

$$\{ Q ( A ) \vert ∃ r ∈ R [ Q \cdot A = r \cdot A ∧ ∃ x ∈ \{ X ( C ) \vert ∃ s ∈ S [ r \cdot B = s \cdot B ∧ X \cdot C = s \cdot C ] \} , {γ}_{∅} [ r \cdot C = sum ( x \cdot C ) ∧ ∃ t ∈ T [ r \cdot B = t \cdot B ∧ x \cdot C = t \cdot C ] ] ] \}$$

FIGS. 28C and 28D are a graphical representation 2801b and query 2802b, respectively, of the following query:

$$\{ Q ( A ) \vert ∃ r ∈ R [ Q \cdot A = r \cdot A ∧ ∃ x ∈ \{ X ( C ) \vert ∃ s ∈ T [ r \cdot B = t \cdot B ∧ X \cdot C = t \cdot C ] \} , {γ}_{∅} [ r \cdot C = sum ( x \cdot C ) ∧ ∃ s ∈ S [ r \cdot B = s \cdot B ∧ x \cdot C = s \cdot C ] ] ] \}$$

Use of the assignment predicate may take precedence over other connections, which may be useful for indicating, for example, an order or hierarchy of operation. The assignment predicate may be carried out, for example, prior to other predicates.

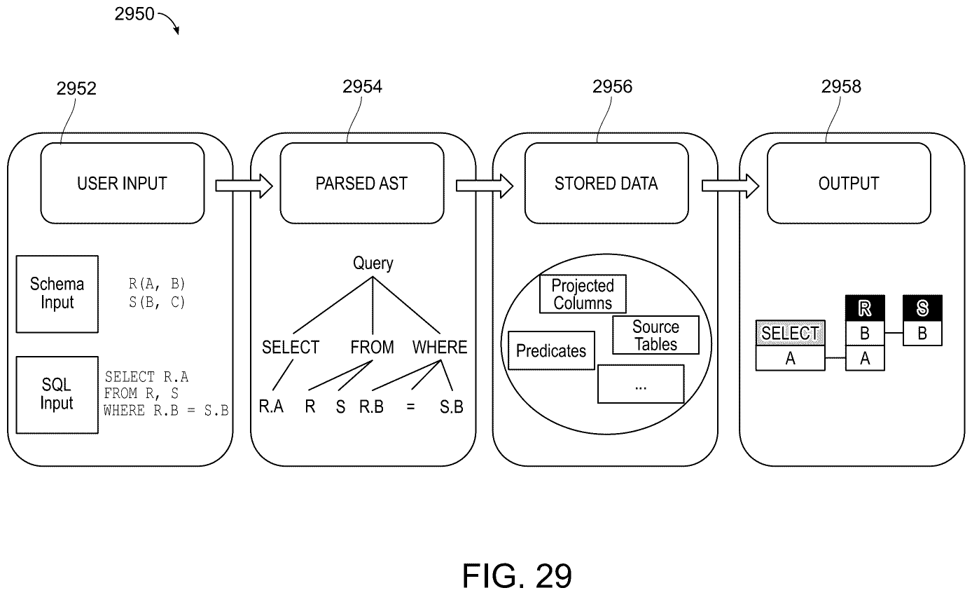

FIG. 29 illustrates an example embodiment of a workflow 2950 for processing user-input schemas and queries. Amongst other examples, the workflow 2950 may be implemented to provide the described PatternVis functionality. The workflow 2950, according to an example embodiment, includes, parsing 2952 a schema from an input string using simple regex matching assuming that the schemas come in the form “TABLE NAME (ATTR1, ATTR2, . . . )”. The parsed schema can be used to verify the validity of the given SQL query. Then, an AST which describes the structure of the elements present in the input can be generated and a SQL parser can be used to parse 2954 the AST from the input SQL query string. The AST is processed by traversing specific nodes corresponding to specific SQL query clauses. Information about the fundamental query components for its logical representation, such as join predicates and source tables, is stored 2956 in intermediate data structures. After the information is gathered, assigning 2958 of table positions in the final diagram is established by performing a breadth-first search on the (join) predicates that are stored. Tables involving predicates which are more closely connected to the attributes in the output can be assigned lower “levels” and placed closer to the left side of the diagram, with the output table having a leftmost position.

Once the necessary tables, attributes, joins, and predicates have been established, a layout method can be used to determine the positions of the elements. In an embodiment, the layout may be optimized with algorithms like Stratisfimal Layout [3] to optimize the position of elements in the diagram and minimize collisions between edges.

Embodiments can support the relationally complete disjunction-free fragment of SQL, with extensions for grouping and aggregates. Note that grouping can apply additional constraints on the contents of a query: if a column is used to group a query, then all other columns may only be further used as aggregates or the WHERE clause. Additionally, aggregates may not be permitted in the WHERE clause. An example list of supported constructs can be found in FIG. 30.

FIG. 30 illustrates a table 3000 of grammar supported by a tool for generating graphical representations of a logical formula, according to an example embodiment. The tool may be, for example, PatternVis. Additional restrictions, such as sanity conditions for SQL, may apply in addition to the grammar supported.

### Database Research May Need An Abstract Query Language

For over 40 years the appropriateness of SQL for query composition has been questioned. Due to LLMs, an increased focus may be placed on reading instead of composing queries, and on machine processing of queries. Proposed herein is the development of an Abstract Relational Query Language (ARQL) whose structure may better reflect the semantics of a query and thus better supports reasoning about the query's intent. ARQL may also serve as a meta language that enables a study of the patterns in other user-facing languages. Instead of developing specific languages for humans or machines, alternative “modalities” of the same language may be useful. Formulations for a Generalized Tuple Relational Calculus (G-TRC), which is a strict generalization of TRC that can represent complicated query patterns, are described herein. G-TRC may include 3 alternative modalities: (i) as textual language (the calculus), (ii) an Abstract Language Higraph (ALH) that replaces Abstract Syntax Trees (ASTs) for machine reasoning, and (iii) a diagrammatic representation of the ALH for human understanding. A goal of such a formulation may include facilitating semantic comparison, explanation, and debugging of queries, and supporting a more principled discussion of relational language design, both for the human and machine audience.

A number of recent efforts may question SQL as the default relational query language (QL) and suggest to either extend or completely replace it [114, 140, 144]. Some of these debates may focus on issues peripheral to core language design, such as whether set or bag semantics are more appropriate, or whether nested correlated queries are inherently hard for users to follow and should be avoided. A discussion about how different languages combine their inputs (thus the base relations) to define the same query may currently be missing from the debate. That is, how should queries be represented in a way that focuses on the relational structure they express, independent of syntactic idiosyncrasies of query languages.

At the same time, the emergence of generative AI and large language models (LLMs) may reshape how users interact with relational databases. As noted in [113], these developments potentially change how users interface with relational databases, shifting emphasis from query composition to query interpretation. Since LLMs can hallucinate or introduce errors, “effective explanation mechanisms . . . become increasingly important” [113]. This may raise a second question: How should queries written by LLMs be presented to users in a way that facilitates understanding and accurate feedback?

The challenge may not be limited to human-facing interfaces. Automated semantic similarity searching may require more suitable representations of query meaning. SQL's syntax may not align well with semantic intent, making similarity assessment challenging. In the NL2SQL domain, current benchmarks may rely on surface-level equivalence such as exact string match. Since those can fail to capture deeper semantic relationships, Floratou [125] argues for “a shift towards intent-based benchmarking frameworks.” This can raise a third question: What language abstraction is appropriate for LLMs to internally reason about query intent and semantic similarity?

The foregoing conversation may benefit from an ARQL that abstracts away from concrete syntax and design choices and focuses on basic language features shared by all relational query languages with flat input and output relations. A goal of developing such an ARQL includes a clean separation of concerns. Just as Internal Representations (IRs), like SDQL [143] and Substrait [111] can decouple parsing from optimization and code generation, a syntax-agnostic discussion of language features at a more conceptual level may be useful. This could free the conversation from distracting specifics, such as set vs. bag semantics, declarative vs. procedural styles, black-box user-defined functions, general data type issues related to typing and casting that are orthogonal to the relational model, and the many syntactic variants that SQL allows for expressing basically the same query. In general, a language-agnostic description about how data is transformed from input to output may be referred to as the relational pattern of a query [130].

An ARQL may not need to interact directly with users or machines. Instead, alternative modalities of the same language may be developed, each tailored to different purposes. These modalities can offer alternative views of a query, optimized for either human interpretation or machine reasoning.

ASTs can tend to remain too close to the concrete syntax of a language. For example, SQLGlot's AST [112] places JOINs as children of SELECT nodes, which can reflect concrete syntax rather than abstract semantic relationships. Such representations may fall short as truly abstract representations of a query.

To address this, a new form of abstraction is proposed herein: the Abstract Language Higraph (ALH). Such an embodiment can organize query components hierarchically while also incorporating edges that connect terms to their bindings, thereby drawing on the expressive power of Harel's higraphs. The ALH can shift focus from concrete syntax to the underlying semantics of the language (thus ALH instead of AST), allowing it to serve as a syntax-agnostic representation of nested relational structure. Similar to how query graphs can support optimization of conjunctive queries [139], ALHs may be useful in providing a better data structure for semantic analysis of relational queries.

Importantly, ALHs can also be rendered diagrammatically for human users. Prior user studies have shown that diagrammatic representations can help users understand relational structures faster and more reliably [129, 136]. To emphasize a key distinction: language design may not be conflated with interface usability. Whether users “like” a language may be a question of modality, not of the language core itself. Instead, modalities may be designed with target consumers in mind, i.e., human-facing modalities for accurate semantic understanding and debugging, and machine-facing modalities for tasks such as semantic similarity assessment or query transformation.

While the observation that “the idea of a single, universal language or paradigm . . . covering all data programming needs is unlikely” [113] may be generally agreed upon, it may be argued that many of these needs can be addressed at the level of modalities instead of languages. An ARQL may not be motivated to unify all QLs under a single syntax, but to enable meaningful comparisons across languages in terms of their underlying relational patterns, and different modalities can serve the respective needs of humans and machines.

Contributions of the work described herein may include: (1) A proposal that the database community develop more abstract representation of relational queries. This effort can support but is orthogonal to the development of concrete user-level QLs, and to efforts on intermediate representations. (2) A concrete formulation of such a language which may be a strict generalization of TRC called Generalized TRC (G-TRC), along with three example modalities: a calculus as textual language, an Abstract Language Higraph (ALH) targeted for machines, and as higraph diagrams targeted for humans. (3) A demonstration of G-TRC representations of running examples from recent prior art.

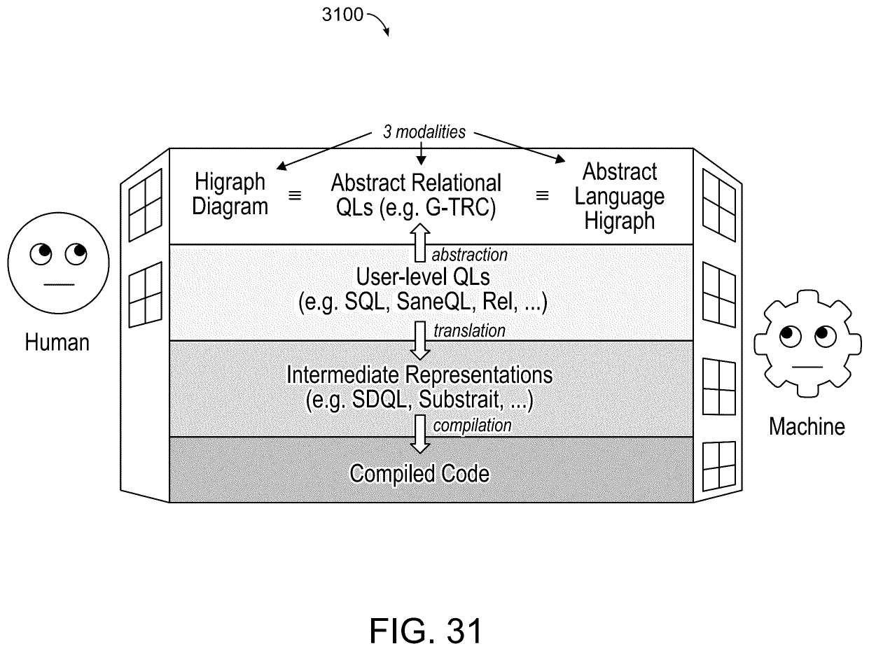

FIG. 31 is a diagram 3100 of relationships between query languages. An ARQL can abstract away from syntactic details of a query to higher-level representation(s). Similar to Intermediate Representations allowing a better query optimization, a more abstract representation can allow a better semantic understanding of a query's intent. Both humans and machines may benefit from appropriate modalities of the language. Embodiments described herein may include abstraction relational query languages.

As used herein, higraphs [133] can be a generalization of graphs that allow nodes to be nested within other nodes, forming a tree or DAG-like structure.

### Generalized Tuple Relational Calculus

Described herein are example embodiments of a formalization of G-TRC, a strict generalization of TRC that models relational query languages in a collection framework. G-TRC can act as a higher-level ARQL that can model and represent the basic relational query patterns of SQL and major recently proposed alternatives. Three alternative representations of G-TRC are disclosed: (i) as a textual QL that generalizes TRC, (ii) an Abstract Language Higraph, that is suited for machines and (iii) a diagrammatic Higraph representation, suited for humans. All three are isomorphic to each other. However, each may be better suited for different tasks.

With regards to TRC, the named calculus perspective may be a more powerful abstraction than positional placement. Codd [117]proposed to “replace positional addressing by totally associative addressing”, i.e., accessing data by named attributes and keys rather than by positional addresses. Usually, this logical independence can be equated with independence of the row numbers. However, the named perspective can also provide independence from column numbers. Several recent works from the diagrammatic representation community may be inspired by Datalog due to its powerful handling of recursion. However, nothing prevents adding recursion in the named perspective.

Ignoring notational conventions, the following is a valid TRC query according to a widely used textbook [123]:

$$\{ r \cdot A \vert r ∈ R ∧ ∃ s [ r \cdot B = s \cdot B ∧ s \cdot C = 0 ∧ s ∈ S ] \}$$

Two changes may be made: firstly, the scopes may be clarified. Whenever a relation variable is quantified, it can also bound to a relation:

$$\{ r \cdot A \vert r ∈ R , ∃ s ∈ S [ r \cdot B = s \cdot B ∧ s \cdot C = 0 ] \}$$

Secondly, stricter scoping rules may be applied. For example, variables may not be allowed in the head that are bound in the body. Instead, values may be assigned to the free variables from the head:

$$\{ Q ( A ) \vert ∃ r ∈ R , s ∈ S [ Q \cdot A = r \cdot A ∧ r \cdot B = s \cdot B ∧ s \cdot C = 0 ] \} \qquad ( 21 )$$

As a result, all bindings (e.g., s ∈ S) can now be preceded by a quantification 3 or possibly other bindings (here r ER). The extra predicate Q.A=r.A may be referred to as an assignment predicate to distinguish it from the other comparison predicates.

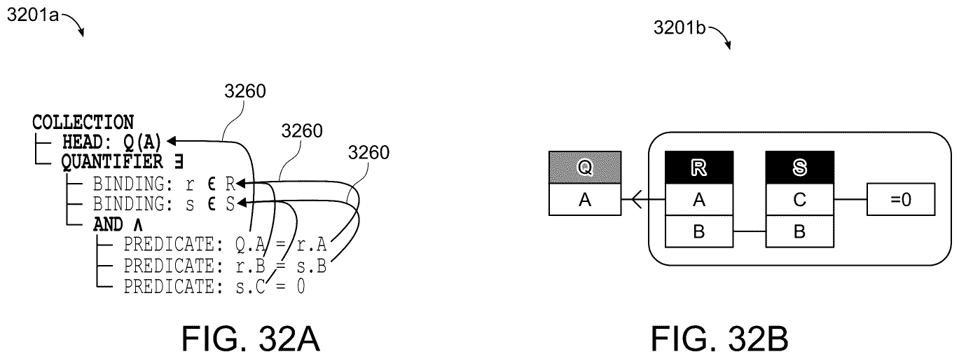

FIGS. 32A and 32B illustrate a simplified ALH 3201a and diagrammatic higraph representation 3201b, respectively, of a query, according to an example embodiment. The ALH 3201a of FIG. 32A may be a variant of an AST representation of query (21) which makes this nesting of one or more bindings under a quantifier explicit. Notice that a query (or a collection) consists of a head and a formula as body. Here, a quantification can start the body. Also shown are conceptual links, e.g., the conceptual links 3260, from predicates to the bindings of their (the predicates') range variables. Such conceptual links may typically not be shown in ASTs. However, they can reflect the data structures created after the linking step and symbol tables are created. Given confusion about what an AST may represent, the linked and hierarchal data structure described hereinabove may be preferentially referred to as an ALH.

The diagrammatic highraph representation 3201b of FIG. 32B may also be referred to as a Relational Diagram.

For computational analysis, a pointer-based hierarchical Higraph structure may be appropriate. For human consumption, a diagrammatic representation of the ALH may be used, where the attributes of a table can be represented adjacent to the table name instead of using additional edges. For the relationally complete fragment, these concepts were formalized in more detail in [128-130], which are incorporated by reference in their entirety. A user study has shown that these diagrams allow humans to recognize and reason about patterns faster than SQL. The user study was reproduced [147]. A recent tutorial [127] gives a detailed comparison of this visual formalism against prior work.

### Interpreting TRC as Set Comprehension

The formalization of G-TRC thus far was grounded in first-order logic. Relational query languages may be interpreted in a collection framework and may benefit from an interpretation that will enable G-TRC to go beyond first-order logic yet remain declarative.

A declarative specification of a set can be given by specifying elements that satisfy properties of the set. For example, for sets X and Y, the subset of their product where the former is smaller than the latter is the set {(x, y)|x<y ∧ x ∈ χ ∧ y ∈ Y}. With more stricter scoping rules described hereinabove, the foregoing subset may be written as {(a, b)| ∃x ∈ χ, y ∈ Y [x<y ∧ a=x ∧ b=y}. In a Haskell type comprehension syntax, this would may be written as [(x, y)| x←X, y←Y, x<y], with its semantics given by:

```
for x in xs:
  for y in ys:
    if x < y: yield (x, y)
```

This nested loop strategy may provide an operational definition and may be an example exemplification of conceptual evaluation strategy of SQL. This formalism of comprehension of sets may be used herein (and more generally collections) yet also deviate from it in three details: 1) A tuple may be used instead of a domain perspective. 2) An explicit notation of scoping may exist: The body can be a logical statement instead of a conjunction of properties, thus the order of shown predicates does not matter. What matters are the well-defined scopes. 3) The stricture rule on heads may be used (heads need to be kept clean). Allowing nesting in the head may be a way of defining calculations with collections and list comprehensions. For example, in Haskell creating all the squares of even numbers is canonically written as: [x*x|x←N, x mod 2==0], the squaring of numbers happens in the head. Nesting in the head can also be useful for the nested relational model, and used in extensions of Datalog, but it is not needed and even distracting for the flat (unnested) relational model.

### Composability Through Orthogonal Nesting

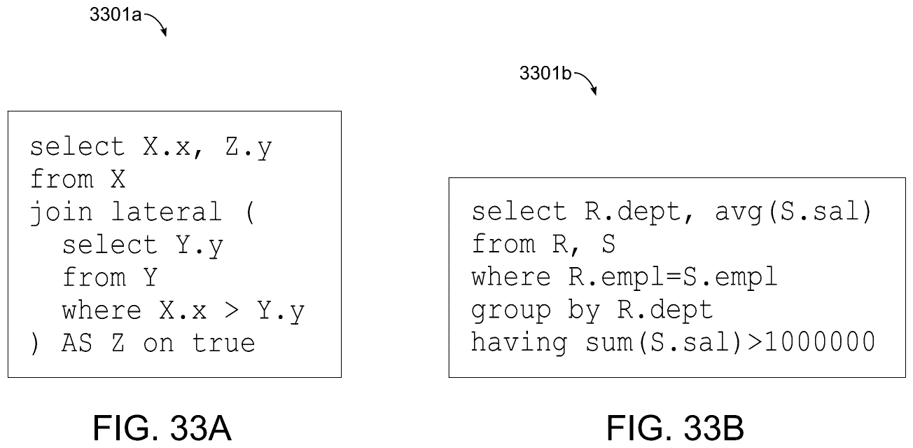

FIGS. 33A and 33B illustrate SQL queries 3301a-b that have corresponding logical formulae implemented using nested G-TRC, according to an example embodiment. The SQL query 3301a of FIG. 33A includes a lateral join, as further described hereinbelow, with relation to Query (2). FIG. 33B illustrates an SQL query 3301b of a G-TRC representation of an example query from [134].

Arbitrary nesting of comprehensions may be allowed in the body, i.e., nestings can be orthogonal: they do not interfere with or restrict the use of other constructs and are thus composable. For example, in Haskell, the following comprehension is allowed:

$$[ ( x , y ) \vert x ← X , y ← [ z \vert z ← Y , x < z ] ]$$

This expression would correspond in SQL to the lateral join shown in FIG. 33A. It can written in G-TRC as follows:

$$\{ Q ( x , y ) \vert ∃ r ∈ X , s ∈ \{ Z ( y ) \vert ∃ s ∈ Y [ Z . y = s . y ∧ s . y > r . x ] \} [ Q . x = r . x ∧ Q . y = s . y ] \} \qquad ( 22 )$$

### Grouping And Aggregates In Set Semantics

Grouping and aggregates may further be useful for generating diagrammatic representations. For example, assuming that a query requests a sum of all ages of employers in a table, the column of ages will likely have duplicate ages. This may pose a conundrum for aggregates under set semantics since projecting the table onto that column before taking the aggregate may remove duplicate ages. Prior works modeling database programming languages (DBPLs) with comprehension frameworks [115, 124, 131, 146], includes attempts to extend logical formalisms with aggregate operators [134], modeling each aggregate attribute with an individual and distinct comprehension scope. Even modern interpretations of Datalog like Souffle [35] and Rel [4] may inherit this restriction.

However, this problem may be readily resolved using formulations described herein. Klug [25] defined aggregate functions as ranging not over one column but an entire table, thus avoiding the issue of duplicates entirely (at the cost of a more complicated formalism due to technicalities). Similarly, in a collection framework, this issue of duplicates as input to aggregates is nonexistent as aggregates can be accumulated one element at a time and deduplication of the result (if needed) can be postponed until after the calculation happened. Restated, rather than extending formal logics to aggregates, defining a formal abstract calculus language that can model all formats of calculation happening across existing relational languages may be helpful for representation of aggregates as well. Calculus and first-order logic do not have to be the same. Date [9] wrote “calculus . . . provides a notation for stating the definition of that desired relation in terms of those given relations”, and “A fundamental feature of the calculus is the range variable”. This definition can also be applied to present interpretations of TRC in a collection framework. Example embodiments of formalisms described herein may be exemplified with a running example from [134]“returning the average salary for each department that pays total salary at least 106”, (FIG. 33B). Such example embodiments may include an optional grouping clause that may be added as a sibling to the binding definitions under a scope, and aggregates can be part of assignment predicates. In the higraph formalism, grouped attributes can be highlighted, and the scope can be replaced by a double-lined grouping scope. HAVING can be considered as a grouping and aggregate followed by a selection.

$$\{ Q ( dept , avg ) \vert ∃ x ∈ \{ X ( dept , avg , sum ) \vert ∃ r ∈ R , s ∈ S , {γ}_{r . dept} [ X . dept = r . dept ∧ X . avg = avg ( s . s a l ) ∧ X . sum = s u m ( s . s a l ) ] \} [ Q . dept = s . dept ∧ Q . avg = x . avg ∧ s . s u m > 1000000 ] \} \qquad ( 23 )$$

For the above example, Hella et al. [134]propose their language L_{aggr} ({<}, {Σ, AVG}) that defines an output relation p(x, q) via the following expression:

$$( ∃ y ∃ z . R ( x , y ) ∧ S ( y , z ) ) ∧ ( q = A g g {r}_{A V G} z . ( ∃ y . R ( x , y ) ∧ S ( y , z ) , z ) ) ∧ ( {Aggr}_{Σ} z . ( ∃ y . R ( x , y ) ∧ S ( y , z ) , z ) > {c}_{1 {0}^{6}} ) \qquad ( 24 )$$

This formalism can change the signature of the query (tables are used multiple times, once for each aggregate) and leads to a modified relational pattern illustrated herein with respect to FIG. 35. A similar issue arises in Rel that also needs to express both aggregates with different subqueries [114].

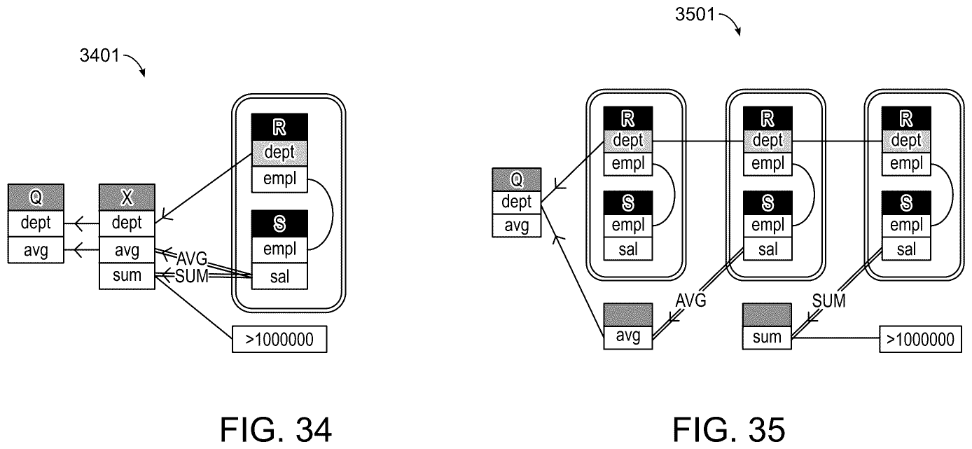

FIG. 34 illustrates a higraph graphical representation 3401 of a G-TRC query, according to an example embodiment. In particular, the representation 3401 is the higraph representation of the query from [134] illustrated as an SQL query 3301b in FIG. 33B. As described hereinabove, the query reads, “returning the average salary for each department that pays total salary at least 10⁶.”

FIG. 35 illustrates a pattern-preserving higraph graphical representation 3501 of a query, according to an example embodiment. Specifically, graphical visualization 3051 represents Query (24) 3301b described hereinabove in relation to FIG. 33B. As noted hereinabove, the formalism changes a signature of a query and introduces tables for each instance of an aggregate.

### Sets Or Bags

According to some embodiments, if bags are provided instead of sets, the language, e.g., ARQL, may not need to change. The conceptual evaluation may still work as described hereinabove: each tuple of relation 1 can still be paired with each tuple of relation 2, regardless of whether a tuple is a duplicate or not. Thus, a relational QL may not need to be designed for either sets or bags, but can rather be interpreted on either sets or bags. In some embodiments, the input could be specified in the language. However, this may not be a requirement of the language as the input can be an orthogonal decision. For example, switching to bags can be indicated by another collection type as in {{Q(A) r ∈ R[Q.A=r.A]}}instead of {Q(A) r ∈R[Q.A=r.A]}.

Whether a query is interpreted under set or bag semantics may have an effect on optimization and whether certain rewrite rules can be applied or not. For example, the following nested query

$$\{ Q ( A ) \vert ∃ r ∈ R [ ∃ s ∈ S [ Q . A = r . A ∧ r . B = s . B ] ] \}$$

can be unnested as follows, under set but not bag semantics (as duplicate s.B values would create duplicate r.A in the output):

$$\{ Q ( A ) \vert ∃ r ∈ R , s ∈ S [ Q . A = r . A ∧ r . B = s . B ] \}$$

### Recursion

G-TRC may be capable of supporting recursion. G-TRC may support recursion in the same way as Datalog, but with regard to the named perspective. Assume a parent relation with start and target P (s, t). Ancestors A(s, t) are then defined in Datalog as

$$\begin{matrix}A ( x , y ) : - P ( x , y ) \\ A ( x , y ) : - P ( x , z ) , A ( z , y )\end{matrix}$$

G-TRC can use the exact same approach and fixed-point definition:

$$\{ A ( s , t ) \vert ∃ p ∈ P [ A . s = p . s ∧ A . t = p . t ] ∨ ∃ p ∈ P , a 2 ∈ A [ A . s = p . s ∧ p . t = a 2. s ∧ a 2 . t = A . s ] \qquad ( 25 )$$

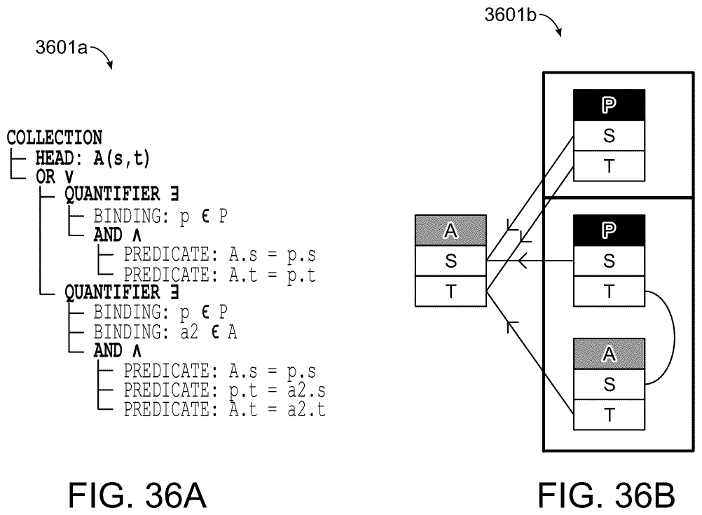

FIGS. 36A and 36B illustrate a corresponding abstract syntax tree representation 3601a and higraph representation 3601b, respectively, of a query with recursion, according to an example embodiment. In particular, the G-TRC query (25) is represented in FIGS. 36A and 36B.

### Handling Of Null Values

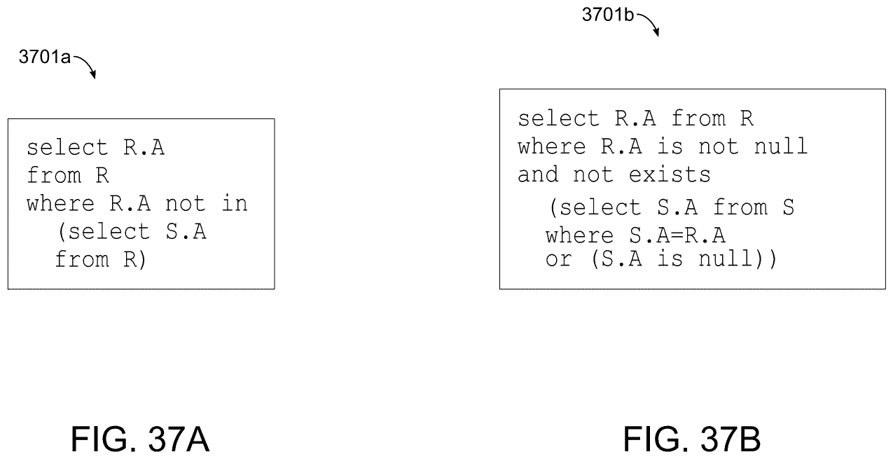

FIGS. 37A and 37B illustrate SQL queries 3701a and 3701b with null behavior, according to an example embodiment. SQL's complicated interpretation of null values may arise partially due to the syntactic variants that SQL allows. For example, the SQL query 3701a in FIG. 37A can return an empty set if S contains any row with null in the A column. However, SQL behavior with null values can be perfectly circumvented yet replicated under two-valued logic [28] with the SQL query 3701b in FIG. 37B and hence the collection framework described herein:

$$\{ Q ( A ) \vert ∃ r ∈ R [ Q . A = r . A ∧ R . A is not null ∧ ¬ ( ∃ s ∈ S [ s . A = r . A ⋁ S . A is null ] ) ] \} \qquad ( 26 )$$

### Left And Full Outer Joins

A priori, outer joins may seem not naturally expressible with plain comprehensions because comprehensions select from existing collections and drop missing matches. For example, a left join between R and S could be a union of two comprehensions:

$$\{ Q ( A , B ) \vert ∃ r ∈ R , s ∈ S [ Q . A = r . A ∧ Q . B = s . B ∧ r . A = s . B \} ⋃ Q ( A , B ) \vert ∃ r ∈ R [ Q . A = r . A ∧ Q . B = null ∧ ¬ ( s ∈ S [ r . A = s . B ] ) ] \} \qquad ( 27 )$$

According to some embodiments, comprehensions may be extended with an additional clause under the scope (similar to the grouping clauses) that algebraically models the sequence of inner, left, and full joins between the base or derived tables bound, and their precedence:

$$\{ Q ( A , B ) \vert ∃ r ∈ R , s ∈ S , left ( r , s ) \qquad ( 28 )$$

$$[ Q . A = r . A ∧ Q . B = s . B ∧ r . A = s . B \} \qquad ( 29 )$$

The inner join can be k-ary and the left and outer can be binary. Any scope without any outer join annotation may be by default inner. For example, “r ∈R, s ∈ S, t ∈ T [ . . . ]” is the same as “r ∈ R, s ∈ S, t ∈ T, inner(r, s, t) [ . . . ]”. An inner join followed by a left join can be denoted as “∃r ∈ R, s ∈ S, t ∈ T, left(r, inner(s, t)) [ . . . ]”. The join annotations described herein may be useful for modeling all types of outer join combinations, even such that are complicated to model in SQL syntax [118, 120]. Right joins can be modeled with left joins by reversing the arguments, which may not be possible in SQL's syntax (!).

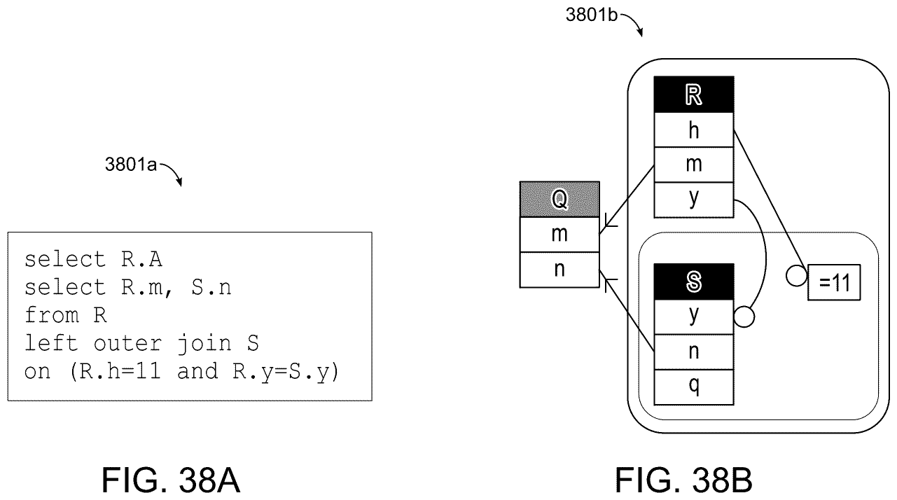

FIGS. 38A and 38B illustrate a SQL query 3801a and corresponding higraph representation 3801b, respectively, of a query with an outer join, according to an example embodiment. Outer join conditions may be indicated in the higraph with empty circles on the optional side (which may be inspired by ERD notation), as illustrated in representation 3801b of FIG. 38B. Precedence scopes, which may also cover cross joins, as illustrated in query 3801a of FIG. 38A, using an example from [118]:

$$\{ Q ( m , n ) \vert ∃ r ∈ R , s ∈ S , l e f t ( r , inner ( r . h = 11 , s ) ) [ Q . m = r . m ∧ Q . n = s . n ∧ r . y = s . y ∧ r . h = 11 ] \} \qquad ( 30 )$$

### Arithmetic Predicates And Derived Attributes

G-TRC can allow calculations. In higraphs, calculations may be represented with built-in predicates [18], also called infinite relations [22].

The ability of G-TRC to represent calculations may be demonstrated using an example from the Rel paper [114]. Rel is a derivative of Datalog, based upon Domain RC, and set-based. Matrix multiplication can be expressed as follows:

$$defMatrixMult [ \{ A \} , \{ B \} , i , j ] : sum [ [ k ] : A [ i , k ] * B [ k , j ] ]$$

In G-TRC the above statement may be written in the named perspective as:

$$\{ C ( row , col , val ) \vert ∃ a ∈ A , b ∈ B , {γ}_{a . row , b . col} [ C . row = a . row ∧ C . col = b . col ∧ C . val = sum ( a . val * b . v al ) ] \}$$

For the higraph representation, multiplication may be replaced with an infinite built-in predicate “*($1, $2, out)” and represented as follows:

$$\{ C ( row , col , val ) \vert ∃ a ∈ A , b ∈ B , f ∈ “ * ” , {γ}_{a . row , b . col} [ C . row = a , row ∧ C . col = b . col ∧ C . val = sum ( f . out ) ∧ f . \$1 = a . v a l ∧ f . \$2 = b . v al ] \} \qquad ( 31 )$$

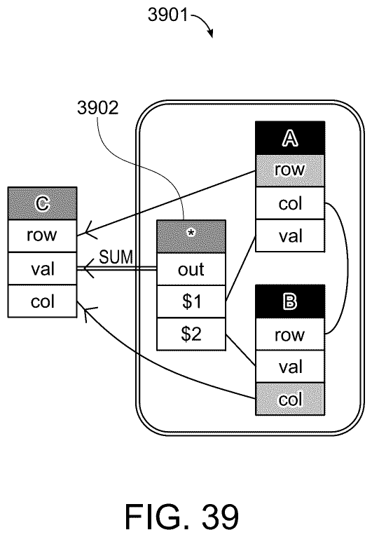

FIG. 39 illustrates a higraph representation 3901 of a query with arithmetic predicates, grouping, and aggregates, according to an example embodiment. As described hereinabove, the multiplication can be replaced with an infinite built-in predicate, as represented by a table 3902 with an asterisk.

### An Illustration Of The Count Bug

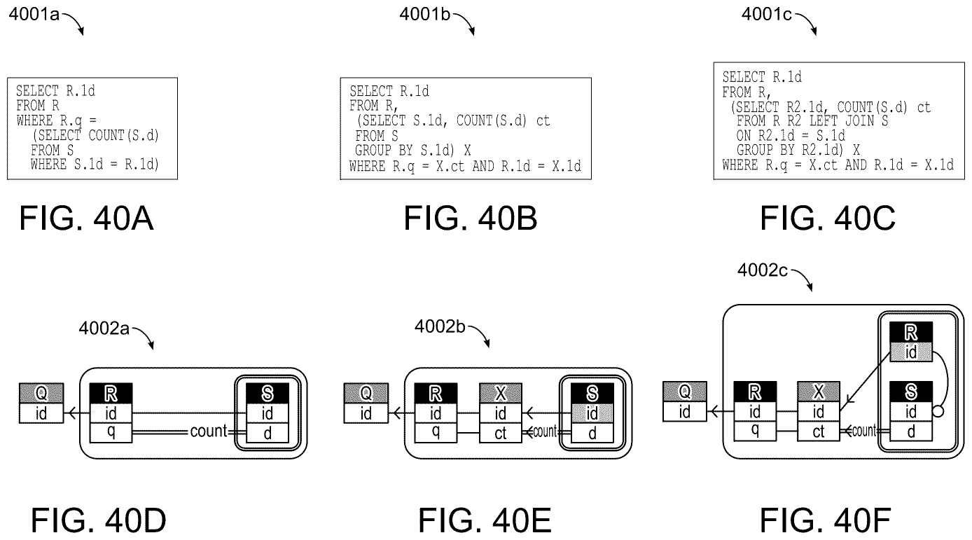

FIGS. 40A-40F illustrate representations of count bugs, according to an example embodiment. FIGS. 40A-40C show SQL queries 4001a-c of the count bugs. The count bug [126] is a famous example of an attempted reformulation of a nested correlated query like the one in FIG. 40A and replacing it with FIG. 40B. However, on an input database with R(9, 0) and empty table S, the query 4001a would return 9, whereas the query 4001b would return an empty result. The correct decorrelation happens with left join and the query 4001⊏ shown in FIG. 40C. The remaining equations and figures in this section show those queries in pattern-equivalent G-TRC representations and various modalities.

$$\{ Q ( i d ) \vert ∃ r ∈ R [ Q . i d = r . i d ∧ ∃ s ∈ S , γ ∅ [ r . i d = s . i d ∧ r . q = c o u n t ( s . d ) ] ] \} \qquad ( 32 )$$

$$Q ( id ) \vert ∃ r ∈ R , x ∈ \{ X ( id , ct ) \vert ∃ s ∈ S , {r}_{2} ∈ R , {γ}_{{γ}_{2}} . id , left ( y , s ) [ X . id = {r}_{2} . id ∧ X . ct = count ( s . d ) ∧ {r}_{2} . id = s . id ] \} [ Q . id = r . id ∧ r . id = x . it ∧ r . q = x . ct ] \} \qquad ( 33 )$$

$$\{ Q ( id ) \vert ∃ r ∈ R , x ∈ \{ X ( id , ct ) \vert ∃ s ∈ S , γ s . id [ X . id = s . id ∧ X . ct = count ( s . d ) ] \} [ Q . id = r . id ∧ r . id = x . id ∧ r . q = x . ct ) ] ] \} \qquad ( 34 )$$

FIGS. 40D-40F illustrate higraph graphical representations 4002a-c corresponding to the SQL queries 4001a-c of FIGS. 40A-40C, respectively.

FIG. 41 illustrates an abstract language higraph representation 4100 of the query 4001⊏ of FIG. 40C which is also represented by visualization 4002c of FIG. 40F.

### Delineation From Related Work

Presented hereinbelow are statements (indicated by an underline) that may be representative of general attitudes within the field of query languages and representations thereof, along with accompanying statements regarding how the language and representations disclosed hereinabove may intersect or relate to other efforts within the field.

The flat relational model is obsolete. Functionality should move to an Entity-Relational Data model ERDs [1211, relational maps [1221, databases as output [1411, or at least a nested relational model [1161. While the aforementioned directions may have merit, the language and representations presented herein may be more modest. Rather than replacing or extending the relational model, the present work aims to complement current practices. SQL remains widely used, and when inputs and outputs are in 1NF, nesting of intermediate results adds no expressive power [137].

SQL is bad. A new language, like SaneQL [1401, Rel [1141, or a pipe/dataflow syntax [1441 should be created. While the foregoing statement may or may not be true, the goal of the language presented herein may be orthogonal thereto: but a goal is orthogonal: rather than propose yet another query language or extension, a relational reference language (a relational meta language) is presented for comparing other languages based on their relational patterns. Usability may not be an immutable property of a language alone but also of its modality. To instantiate this perspective, a generalization of TRC is presented with three modalities: a core textual calculus, a machine-oriented ALH, and a user-facing diagrammatic form.

Ultimately, questions about usability may be analyzed with task-oriented, reproducible user studies [129, 147], a direction currently underexplored in the database community.

Is this then another Intermediate Representation?A goal of the relational (meta) language presented herein may be substantially different from intermediate representations (IRs) like Semiring Dictionaries [143], Substrait [111], and relational maps [122], which are typically data-structure-centric, closely tied to execution models, and designed to support optimization. In contrast, G-TRC may move toward a more abstract representation that decouples from both data layout and syntax, focusing instead on the semantic structure of relational queries.

Is this about logical expressiveness with aggregates?While the addition of aggregate functions to logic has traditionally been studied in terms of logical expressiveness [137], the focus of G-TRC may include pattern expressiveness. For that purpose, embodiments of the reference language presented herein include a comprehension-based calculus that supports aggregate queries with the exact same relational patterns as SQL.

Higraph visualization implementations [142] may be extended with outer joins, disjunctions, and arithmetic predicates.

Embodiments of diagrammatic representations of queries as disclosed herein may be useful for a broad range of applications. For example, embodiments of diagrammatic representations may be helpful for training machine learning algorithms by conveying relational patterns within data or information. Embodiments may be also be helpful for both humans and machines to understand relational information of queries or data. In some embodiments, diagrammatic representations may allow humans or computer software to better comprehend and debug, e.g., automatically, queries. Other embodiments may be useful for abstracting queries or extracting semantic intent from queries to enable machine-based models to better understand, for example, natural language queries.

### Computer Support

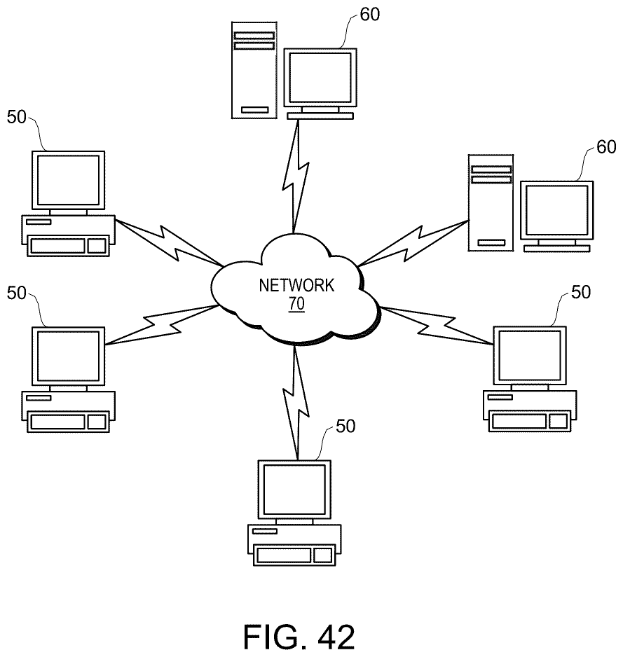

FIG. 42 is a schematic view of a computer network in which embodiments may be implemented. Client computer(s)/devices 50 and server computer(s) 60 provide processing, storage, and input/output (I/O) devices executing application programs and the like. Client computer(s)/device(s) 50 can also be linked through communications network 70 to other computing devices, including other client device(s)/processor(s) 50 and server computer(s) 60. The communications network 70 can be part of a remote access network, a global network (e.g., the Internet), cloud computing servers or service, a worldwide collection of computers, local area or wide area networks, and gateways that currently use respective protocols (e.g., TCP/IP, Bluetooth®, etc.) to communicate with one another. Other electronic device/computer network architectures are also suitable.

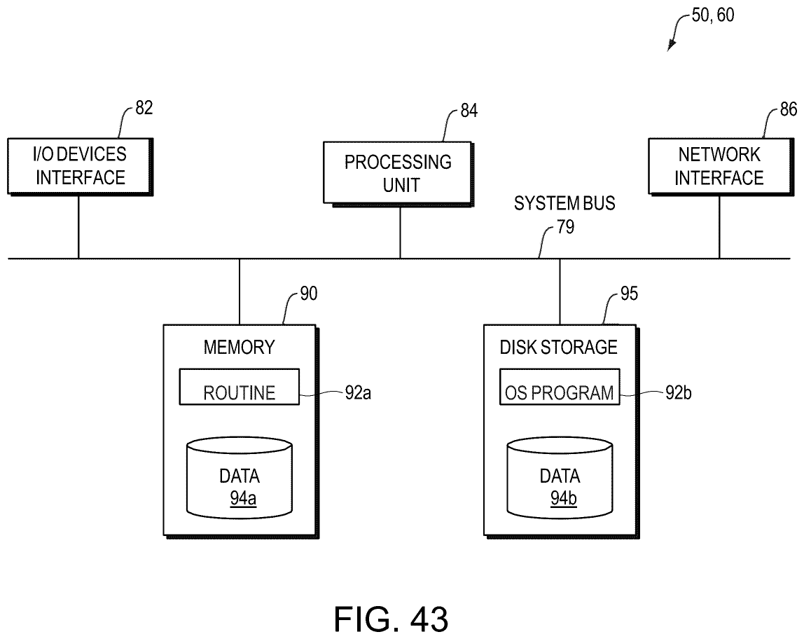

FIG. 43 is a block diagram illustrating an example embodiment of a computer node (e.g., client processor(s)/device(s) 50 or server computer(s) 60) in the computer network 70 of FIG. 42. Each computer node 50, 60 contains system bus 79, where a bus is a set of hardware lines used for data transfer among components of a computer or processing system. The system bus 79 is essentially a shared conduit that connects different elements of a computer system (e.g., processor, disk storage, memory, I/O ports, network ports, etc.) that enables transfer of information between the elements. Attached to the system bus 79 is an I/O devices interface 82 for connecting various input and output devices (e.g., keyboard, mouse, display(s), printer(s), speaker(s), etc.) to the computer node 50, 60. A network interface 86 allows the computer node to connect to various other devices attached to a network (e.g., the network 70 of FIG. 42). A memory 90 provides volatile storage for computer software instructions 92a and data 94a used to implement embodiments of the present disclosure (e.g., the method 101 of FIG. 1, the method 2601 of FIG. 26, etc.). A disk storage 95 provides non-volatile storage for the computer software instructions 92b and data 94b used to implement an embodiment of the present disclosure. A central processor unit (CPU) 84 is also attached to the system bus 79 and provides for execution of computer instructions.

In an embodiment, the processor routines 92a-92b and data 94a-94b are a computer program product (generally referenced as 92), including a non-transitory, computer readable medium (e.g., a removable storage medium such as DVD-ROM(s), CD-ROM(s), diskette(s), tape(s), etc.) that provides at least a portion of the software instructions for the disclosure methods. The computer program product 92 can be installed by any suitable software installation procedure, as is well known in the art. In another embodiment, at least a portion of the software instructions may also be downloaded over a cable, communication, and/or wireless connection. In other embodiments, the disclosure programs are a computer program propagated signal product embodied on a propagated signal on a propagation medium (e.g., a radio wave, an infrared wave, a laser wave, a sound wave, or an electrical wave propagated over a global network such as the Internet, or other network(s)). Such carrier medium or signals provide at least a portion of the software instructions for the present disclosure routines/program 92.

In alternative embodiments, the propagated signal is an analog carrier wave or digital signal carried on the propagated medium. For example, the propagated signal may be a digitized signal propagated over a global network (e.g., the Internet), a telecommunications network, or other networks (such as the network 70 of FIG. 42). In one embodiment, the propagated signal is a signal that is transmitted over the propagation medium over a period of time, such as the instructions for a software application sent in packets over a network over a period of milliseconds, seconds, minutes, or longer. In another embodiment, the computer readable medium of the computer program product 92 is a propagation medium that the computer system 50 may receive and read, such as by receiving the propagation medium and identifying a propagated signal embodied in the propagation medium, as described above for computer program propagated signal product.

Generally speaking, the term “carrier medium” or transient carrier encompasses the foregoing transient signals, propagated signals, propagated medium, storage medium, and the like.

In other embodiments, the program product 92 may be implemented as a so-called Software as a Service (SaaS), or other installation or communication supporting end-users.

Embodiments or aspects thereof may be implemented in the form of hardware including but not limited to hardware circuitry, firmware, or software. If implemented in software, the software may be stored on any non-transient computer readable medium that is configured to enable a processor to load the software or subsets of instructions thereof. The processor then executes the instructions and is configured to operate or cause an apparatus to operate in a manner as described herein.

Further, hardware, firmware, software, routines, or instructions may be described herein as performing certain actions and/or functions of the data processors. However, it should be appreciated that such descriptions contained herein are merely for convenience and that such actions in fact result from computing devices, processors, controllers, or other devices executing the firmware, software, routines, instructions, etc.

It should be understood that the flow diagrams, block diagrams, and network diagrams may include more or fewer elements, be arranged differently, or be represented differently. But it further should be understood that certain implementations may dictate the block and network diagrams and the number of block and network diagrams illustrating the execution of the embodiments be implemented in a particular way.

Accordingly, further embodiments may also be implemented in a variety of computer architectures, physical, virtual, cloud computers, and/or some combination thereof, and, thus, the data processors described herein are intended for purposes of illustration only and not as a limitation of the embodiments.

The teachings of all patents, published applications, and references cited herein are incorporated by reference in their entirety.

While example embodiments have been particularly shown and described, it will be understood by those skilled in the art that various changes in form and details may be made therein without departing from the scope of the embodiments encompassed by the appended claims.

### CITED REFERENCES

[1] Serge Abiteboul, Richard Hull, and Victor Vianu. 1995. Foundations of Databases. Addison-Wesley. http://webdam.inria.fr/Alice/
[2] Azza Abouzied, Joseph M. Hellerstein, and Avi Silberschatz. 2012. DataPlay: interactive tweaking and example-driven correction of graphical database queries. In UIST. ACM, 207-218. doi:10.1145/2380116.2380144
[3] Azza Abouzied, Joseph M. Hellerstein, and Avi Silberschatz. 2012. Playful Query Specification with DataPlay. PVLDB 5, 12 (2012), 1938-1941. doi:10.14778/2367502.2367542
[4] Active Query Builder. 2019. https://www.activequerybuilder.com/.
[5] Michele Angelaccio, Tiziana Catarci, and Giuseppe Santucci. 1990. Query by diagram: A fully visual query system. J. Vis. Lang. Comput. 1, 3 (1990), 255-273. doi:10.1016/S1045-926X(05)80009-6
[6] Marcelo Arenas, Pablo Barcelo, Leonid Libkin, Wim Martens, and Andreas Pieris. 2022. Database Theory: Querying Data. Open source at https://github.com/pdmbook/community.
[7] Eirik Bakke and David R. Karger. 2016. Expressive Query Construction through Direct Manipulation of Nested Relational Results. In SIGMOD. ACM, 1377-1392. doi:10.1145/2882903.2915210
[8] David Barker-Plummer, Jon Barwise, and John Etchemendy. 2011. Language, Proof, and Logic: Second Edition (2nd ed.). Center for the Study of Language and Information/SRI. https://www.gradegrinder.net/Products/lpl-index.html
[9] Jacques Bertin. 1981. Graphics and graphic information-processing. de Gruyter. https://doi.org/10.1515/9783110854688
[10] Filippo Bonchi, Alessandro Di Giorgio, Nathan Haydon, and Pawel Sobocinski. 2024. Diagrammatic Algebra of First Order Logic. arXiv:2401.07055 (2024). arXiv:2401.07055 https://arxiv.org/abs/2401.07055.
[11] Robert Brijder, Floris Geerts, Jan Van den Bussche, and Timmy Weerwag. 2019. MATLANG: Matrix operations and their expressive power. SIGMOD Rec. 48, 1 (2019), 60-67. doi:10.1145/3371316.3371331
[12] Stuart K. Card, Jock D. Mackinlay, and Ben Shneiderman (Eds.). 1999. Readings in information visualization: using vision to think. Morgan Kaufmann. https://dl.acm.org/doi/book/10.5555/300679
[13] Tiziana Catarci, Maria Francesca Costabile, Stefano Levialdi, and Carlo Batini. 1997. Visual Query Systems for Databases: A Survey. J. Vis. Lang. Comput. 8, 2 (1997), 215-260. doi:10.1006/jvlc.1997.0037
[14] Tiziana Catarci and Giuseppe Santucci. 1994. Query by Diagram: A Graphical Environment for Querying Databases. In SIGMOD. 515. doi:10.1145/191839.191.976
[15] Tiziana Catarci, Giuseppe Santucci, and Michele Angelaccio. 1993. Fundamental Graphical Primitives for Visual Query Languages. Inf. Syst. 18, 2 (1993), 75-98. doi:10.1016/0306-4379(93)90006-M
[16] Stefano Ceri, Georg Gottlob, and Letizia Tanca. 1989. What you Always Wanted to Know About Datalog (And Never Dared to Ask). IEEE TKDE 1, 1 (1989), 146-166. doi:10.1109/69.43410
[17] Donald D. Chamberlin. 2024. 50 Years of Queries. Commun. ACM 67, 8 (2024), 110-121. doi:10.1145/3649887
[18] Peter P. Chen. 1976. The Entity-Relationship Model—Toward a Unified View of Data. ACM Trans. Database Syst. 1, 1 (1976), 9-36. doi:10.1145/320434.320440
[19] E. F. Codd. 1972. Relational Completeness of Data Base Sublanguages. Research Report/RJ/IBM/San Jose, California RJ987 (1972). https://citeseerx.ist.psu.edu/document?doi=6a048dc38250ffce49c5e6a5040b4c91ca05e83d
[20] Thomas M. Connolly and Carolyn E. Begg. 2015. Database Systems: A Practical Approach to Design, Implementation and Management, Global Edition (5 ed.). Pearson Addison Wesley. https://www.pearson.com/en-gb/subject-catalog/p/database-systems-a-practical-approach-to-design-implementation-andmanagement-global-edition/P200000003964/
[21] Wikipedia contributors. 2024. Tuple Relational Calculus Wikipedia, The Free Encyclopedia. https://en.wikipedia.org/wiki/Tuple_relational_calculus [Online;accessed June-2024].
[22] Jonathan Danaparamita and Wolfgang Gatterbauer. 2011. QueryViz: Helping Users Understand SQL queries and their patterns. In EDBT. ACM, 558-561. doi:10.1145/1951365.1951440
[23] Christopher J. Date. 2003. An introduction to database systems (8 ed.). Pearson-/Addison Wesley Longman. https://dl.acm.org/doi/10.5555/861613
[24] C. J. Date and Hugh Darwen. 2000. Foundation for future database systems: the third manifesto (2nd ed ed.). Addison-Wesley Professional. https://dl.acm.org/doi/10.5555/556540
[25] Frithjof Dau. 2009. The Advent of Formal Diagrammatic Reasoning Systems. In ICFCA (International Conference on Formal Concept Analysis) (LNCS, Vol. 5548). Springer, 38-56. doi:10.1007/978-3-642-01815-2_3
[26] Robert Demolombe. 1992. Syntactical Characterization of a Subset of Domain-Independent Formulas. J. ACM 39, 1 (1992), 71-94. doi:10.1145/147508.147520
[27] Amol Deshpande. 2025. Beyond Relations: A Case for Elevating to the Entity-Relationship Abstraction. In CIDR. www.cidrdb.org. https://www.vldb.org/cidrdb/papers/2025/p15-deshpande.pdf
[28] Alin Deutsch, Nadime Francis, Alastair Green, Keith W. Hare, Bei Li, Leonid Libkin, Tobias Lindaaker, Victor Marsault, Wim Martens, Jan Michels, Filip Murlak, Stefan Plantikow, Petra Selmer, Oskar van Rest, Hannes Voigt, Domagoj Vrgoc, Mingxi Wu, and Fred Zemke. 2022. Graph Pattern Matching in GQL and SQL/PGQ. In SIGMOD. 2246-2258. doi:10.1145/3514221.3526057
[29] Stephan Diehl. 2007. Software visualization: visualizing the structure, behaviour, and evolution of software. Springer, Berlin. http://www.loc.gov/catdir/toc/fy0802/2007923067.html
[30] Ramez Elmasri and Sham Navathe. 2015. Fundamentals of database systems (7 ed.). Addison Wesley. https://dl.acm.org/doi/book/10.5555/2842853
[31] Herbert Enderton and Herbert B Enderton. 2001. A mathematical introduction to logic. Elsevier. doi:10.1016/C2009-0-22107-6
[32] George Englebretsen. 1996. Review of Sun-Joo Shin, The Logical Status of Diagrams. Modern Logic 6, 3 (1996), 322-330. https://projecteuclid.org/jour nals/modern-logic/volume-6/issue-3/Review-of-Sun-Joo-Shin-The-Logical-Status-of-Diagrams/rml/1204835743. full
[33] Leonhard Euler. 1802. Letters of Euler to a German princess, on different subjects in physics and philosophy addressed to a German Princess, Letters 103-106 (2^{nd} ed.). Translated by Henry Hunter. https://archive.org/details/letterseulertoa00e ulegoog/page/396/mode/2up.
[34] Nadime Francis, Alastair Green, Paolo Guagliardo, Leonid Libkin, Tobias Lindaaker, Victor Marsault, Stefan Plantikow, Mats Rydberg, Petra Selmer, and Andres Taylor. 2018. Cypher: An Evolving Query Language for Property Graphs. In SIGMOD. 1433-1445. doi:10.1145/3183713.3190657
[35] Martin Gardner. 1958. Logic Machines and Diagrams. McGraw-Hill. https: //archive.org/details/logicmachinesdia00mart [36] Wolfgang Gatterbauer. 2011. Databases will visualize queries too. Slide deck VLDB′ 11. https://gatterbauer.name/download/vldb2011_Database_Query_Visualization_presentation.pdf
[37] Wolfgang Gatterbauer. 2023. A Tutorial on Visual Representations of Relational Queries. PVLDB 16, 12 (2023), 3890-3893. doi:10.14778/3611540.3611578 Tutorial page: https://northeastern-datalab.github.io/visual-query-representationtutorial/.
[38] Wolfgang Gatterbauer. 2024. A Comprehensive Tutorial on over 100 Years of Diagrammatic Representations of Logical Statements and Relational Queries. In ICDE. IEEE. doi:10.1 109/ICDE60146.2024.00407 Tutorial page: https://northeastern-datalab.github.io/diagrammatic-representation-tutorial/.
[39] Wolfgang Gatterbauer and Cody Dunne. 2024. On The Reasonable Effectiveness of Relational Diagrams: Explaining Relational Query Patterns and the Pattern Expressiveness of Relational Languages. Proc. ACM Manag. Data 2, 1 (2024), 61:1-61:27. doi:10.1145/3639316
[40] Wolfgang Gatterbauer and Cody Dunne. 2025. Relational Diagrams and the Pattern Expressiveness of Relational Languages. SIGMOD Record 54, 1 (2025). https://sigmodrecord.org/?smd_process_download=1&download_id=14010
[41] Wolfgang Gatterbauer, Cody Dunne, H. V. Jagadish, and Mirek Riedewald. 2022. Principles of Query Visualization. IEEE Data Eng. Bull. 45, 3 (2022), 47-67. http://sites.computer.org/debull/A22sept/p47.pdf
[42] Allen Van Gelder and RodneyW. Topor. 1991. Safety and Translation of Relational Calculus Queries. ACM Trans. Database Syst. 16, 2 (1991), 235-278. doi:10.1145/114325.103712.
[43] Michael Genesereth and Eric J. Kao. 2017. Introduction to Logic (3rd ed.). Morgan & Claypool Publishers. http://intrologic.stanford.edu/homepage/index.html
[44] Janice Glasgow, N. Hari Narayanan, and B. Chandrasekaran. 1995.

Diagrammatic Reasoning: Cognitive and Computational Perspectives. MIT Press, Cambridge, MA, USA. https://dl.acm.org/doi/10.5555/546459
[45] Thomas R. G. Green and Marian Petre. 1996. Usability Analysis of Visual Programming Environments: A ‘Cognitive Dimensions’ Framework. Journal of Visual Languages & Computing 7, 2 (1996), 131-174. doi:10.1006/jvlc.1996.0009
[46] Nathan Haydon and Pawel Sobocinski. 2020. Compositional Diagrammatic First-Order Logic. In 11th International Conference on the Theory and Application of Diagrams (Diagrams 2020) (LNCS, Vol. 12169). Springer, 402-418. doi:10.1007/978-3-030-54249-8_32
[47] Marti A. Hearst. 2023. Show It or Tell It?Text, Visualization, and Their Combination. Commun. ACM 66, 10 (2023), 68-75. doi:10.1145/3593580
[48] John Howse. 2008. Diagrammatic Reasoning Systems. In ICCS (International Conference on Conceptual Structures) (LNCS, Vol. 5113). Springer, 1-20. doi:10.1007/978-3-540-70596-3_1.
[49] John Howse, Gem Stapleton, and John Taylor. 2005. Spider Diagrams. LMS Journal of Computation and Mathematics 8 (2005), 145-194. https://doi.org/10.1112/S1461157000000942 London Mathematical Society.
[50] Yannis E. Ioannidis. 1996. Visual User Interfaces for Database Systems. ACM Comput. Surv. 28, 4es (1996), 137. doi:10.1145/242224.242399
[51] Hannu Jaakkola and Bernhard Thalheim. 2003. Visual SQL—High-Quality ERBased Query Treatment. In ER (Workshops) (LNCS). Springer, 129-139. doi:10.1007/978-3-540-39597-3_13
[52] Oxford Languages. 2024. Diagram. https://www.google.com/search?q=diagram
[53] Jens Lemanski, Mikkel Willum Johansen, Emmanuel Manalo, Petrucio Viana, Reetu Bhattacharjee, and Richard Burns (Eds.). 2024. 14th International Conference on Diagrammatic Representation and Inference (Diagrams 2024). LNCS, Vol. 14981.Springer. doi:10.1007/978-3-031-71291-3
[53] Aristotelis Leventidis, Jiahui Zhang, Cody Dunne, Wolfgang Gatterbauer, H. V. Jagadish, and Mirek Riedewald. 2020. QueryVis: Logic-based Diagrams help Users Understand Complicated SQL Queries Faster. In SIGMOD. 2303-2318. doi:10.1145/3318464.3389767
[54] Leonid Libkin. 2003. Expressive power of SQL. Theor. Comput. Sci. 296, 3 (2003), 379-404. doi:10.1016/S0304-3975(02)00736-3
[55] Kenneth Manders. 2008. Diagram-Based Geometric Practice. In The Philosophy of Mathematical Practice. Oxford University Press. doi:10.1093/acprof:oso/9780199296453.003.0004
[57] Scott McCloud. 1993. Understanding Comics: The Invisible Art. Tundra. https://archive.org/details/understanding-comics
[58] Merriam-Webster.com. 2024. Diagram. https://www.merriam-webster.com/dictionary/diagram
[59] Microsoft Access. 2019. https://products.office.com/en-us/access.
[60] Daphne Miedema and George Fletcher. 2021. SQLVis: Visual Query Representations for Supporting SQL Learners. In Symposium on Visual Languages and Human-Centric Computing (VL/HCC). IEEE, 1-9. doi:10.1109/VL/HCC51201.2021.9576431
[61] Lil Mohan and Rangasami L. Kashyap. 1993. A Visual Query Language for Graphical Interaction with Schema-Intensive Databases. TKDE 5, 5 (1993), 843-858. https://doi.org/10.1 109/69.243513
[62] Charles Sanders Peirce. 1906. Prolegomena to an Apology for Pragmaticism, autograph manuscript, unnumbered sheet, circa 1906. https://library.harvard.edu/collections/charles-s-peirce-papers MS AM 1632 (292a) p. 44. Courtesy of the Houghton Library, Harvard University..
[63] Charles Sanders Peirce. 1933. Collected Papers. Vol. 4. Harvard University Press. https:/archive.org/details/collectedpaperso0000unse_r5j9/
[64] pgAdmin. 2019. https://www.pgadmin.org/.
[65] QueryScope. 2019. https://sqldep.com/.
[66] Raghu Ramakrishnan and Johannes Gehrke. 2002. Database Management Systems (3 ed.). McGraw-Hill, Inc., USA. https://dl.acm.org/doi/book/10.5555/560733
[67] Don D. Roberts. 1973. The Existential Graphs of Charles S. Peirce. The Hague: Mouton. doi:10.1515/9783110226225
[67] Nicole Schweikardt, Thomas Schwentick, and Luc Segoufin. 2010. Database theory: query languages (2 ed.). Chapman & Hall/CRC, 19. doi:10.5555/1882723.1882742
[68] Martina Seidl, Marion Scholz, Christian Huemer, and Gerti Kappel. 2015. UML @Classroom—An Introduction to Object-Oriented Modeling. Springer. https://doi.org/10.1007/978-3-319-12742-2
[70] Sun-Joo Shin. 1995. The Logical Status of Diagrams. Cambridge University Press. doi:10.1017/CB09780511574696
[71] Sun-Joo Shin. 2002. The Iconic Logic of Peirce's Graphs. The MIT Press. doi:10.7551/mitpress/3633.001.0001
[72] Avi Silberschatz, Henry F. Korth, and S. Sudarshan. 2020. Database System Concepts (7 ed.). McGraw-Hill Book Company. https://www.db-book.com/db7/index.html
[73] John F. Sowa. 2008. Chapter 5 Conceptual Graphs. In Handbook of Knowledge Representation, Frank van Harmelen, Vladimir Lifschitz, and Bruce Porter (Eds.). Foundations of Artificial Intelligence, Vol. 3. Elsevier, 213-237. https://doi.org/10.1016/S1574-6526(07)03005-2
[74] John F. Sowa. 2011. Peirce's tutorial on existential graphs. Semiotica 2011, 186 (2011), 347-394. https://doi.org/10.1515/semi.2011.060
[75] SQL Server Management Studio. 2019. https://www.microsoft.com/en-us/sqlserver/sql-server-downloads.
[76] SQLvis. 2021. Visualization explanation. https://github.com/Giraphne/sqlvis
[77] Gem Stapleton. 2013. Delivering the Potential of Diagrammatic Logics. In Proceedings of the First International Workshop on Diagrams, Logic and Cognition (DLAC 2013). CEUR. https://ceur-ws.org/Vol-1132/paperl.pdf
[78] Bernhard Thalheim. 2007. Tutorial Visual SQL: An ER-Based Introduction to Database Programming. Slide deck Christian-Albrechts-Universitat zu Kiel.
[79] Bernhard Thalheim. 2013. Visual SQL as the Alternative to Linear SQL. Slide deck Christian-Albrechts-Universitat zu Kiel.
[80] Silvia De Toffoli. 2022. What are mathematical diagrams?Synthese 200, 86 (2022). https://doi.org/10.1007/s11229-022-03553-w
[81] Rodney Topor. 2018. Safety and Domain Independence. In Encyclopedia of Database Systems, 2nd ed, Ling Liu and M. Tamer Ozsu (Eds.). Springer. doi:10.1007/978-1-4614-8265-9_1255
[82] Rodney W. Topor. 1987. Domain-Independent Formulas and Databases. Theor. Comput. Sci. 52 (1987), 281-306. doi:10.1016/0304-3975(87)90113-7
[83] Edward R. Tufte. 1986. The Visual Display of Quantitative Information. Graphics Press, Cheshire, CT, USA. https://dl.acm.org/doi/book/10.5555/33404
[84] Jeffrey D. Ullman. 1988. Principles of Database and Knowledge-base Systems, Vol. I. Computer Science Press, Inc. https://dl.acm.org/doi/book/10.5555/42790
[85] John Venn. 1880. I. On the diagrammatic and mechanical representation of propositions and reasonings. The London, Edinburgh, and Dublin Philosophical Magazine and Journal of Science 10, 59 (1880), 1-18. doi:10.1080/14786448008626877 https://doi.org/10.1080/14786448008626877.
[86] Giorgio Vinciguerra, Guang Yang, Wolfgang Gatterbauer, and Cody Dunne. 2025. Reproducibility Report for ACM SIGMOD 2024 Paper: ‘On The Reasonable Effectiveness of Relational Diagrams’. In Reproducibility Reports for SIGMOD 2025 (SIGMOD/PODS '24). ACM, 60-63. doi:10.1145/3687998.3717044
[87] ColinWare. 2020. Information Visualization: Perception for Design (4 ed.). Morgan Kaufmann Publishers Inc. https://doi.org/10.1016/C2016-0-02395-1
[88] Colin Ware. 2021. Visual Thinking for Information Design (2 ed.). Morgan Kaufmann. https://doi.org/10.1016/C2016-0-01395-5
[89] Moshe M. Zloof 1977. Query-by-Example: A Data Base
[90] Azza Abouzied, Joseph Hellerstein, and Avi Silberschatz. 2012. DataPlay: interactive tweaking and example-driven correction of graphical database queries. In UIST. 207-218. doi:10.1145/2380116.2380144
[91] Jonathan Danaparamita and Wolfgang Gatterbauer. 2011. QueryViz: helping users understand SQL queries and their patterns. In EDBT. 558-561. doi:10.1145/1951365.1951440
[92] Sara Di Bartolomeo, Mirek Riedewald, Wolfgang Gatterbauer, and Cody Dunne. 2021. Stratisfimal Layout: A modular optimization model for laying out layered node-link network visualizations. IEEE TVCG (VIS′21) 28, 1 (2021), 324-334. doi:10.1 109/TVCG.2021.3114756
[93] Richard M. Felder and Linda K. Silverman. 1988. Learning and teaching styles in engineering education. Engr. Education 78, 7 (1988), 674-681. https://www.academia.edu/download/31039406/LS-1988.pdf
[94] Sneha Gathani, Peter Lim, and Leilani Battle. 2020. Debugging Database Queries: A Survey of Tools, Techniques, and Users. In CHI '20. 1-16. doi:10.1145/3313831.3376485
[95] Wolfgang Gatterbauer. 2024. A Comprehensive Tutorial on over 100 Years of Diagrammatic Representations of Logical Statements and Relational Queries. In ICDE. IEEE, 5387-5392. doi:10.1109/ICDE60146.2024.00407 Tutorial page: https://northeastern-datalab.github.io/diagrammatic-representation-tutorial/.
[96] Wolfgang Gatterbauer. 2024. A Principled Solution to the Disjunction Problem of Diagrammatic Query Representations. doi:10.48550/arXiv.2412.08583arXiv:2412.08583 [cs.DB]
[97] Wolfgang Gatterbauer and Cody Dunne. 2024. On The Reasonable Effectiveness of Relational Diagrams: Explaining Relational Query Patterns and the Pattern Expressiveness of Relational Languages. PACMMOD 2, 1, Article 61 (March 2024),27 pages. doi:10.1145/3639316
[98] Wolfgang Gatterbauer and Cody Dunne. 2025. Relational Diagrams and the Pattern Expressiveness of Relational Languages. SIGMOD Rec. 54, 1 (2025), 80-88. https://sigmodrecord.org/?smd_process_download=1&download_id=14010
[99] Wolfgang Gatterbauer, Cody Dunne, H. V. Jagadish, and Mirek Riedewald. 2022. Principles of Query Visualization. IEEE Data Eng. Bull. 45, 3 (2022), 47-67. http://sites.computer.org/debull/A22sept/p47.pdf
[100] Nodira Khoussainova, Magdalena Balazinska, Wolfgang Gatterbauer, YongChul Kwon, and Dan Suciu. 2009. A Case for A Collaborative Query Management System. In CIDR. https://doi.org/10.48550/arXiv.0909.1778
[101] Aristotelis Leventidis, Jiahui Zhang, Cody Dunne, Wolfgang Gatterbauer, H. V. Jagadish, and Mirek Riedewald. 2020. QueryVis: Logic-based Diagrams help Users Understand Complicated SQL Queries Faster. In SIGMOD. 2303-2318. doi:10.1145/3318464.3389767
[102] Daphne Miedema and George Fletcher. 2021. SQLVis: Visual Query Representations for Supporting SQL Learners. In VL/HCC. IEEE, 1-9. doi:10.1 109/VL/HCC51201.2021.9576431
[103] Marian Petre. 1995. Why looking isn't always seeing: readership skills and graphical programming. CACM 38, 6 (1995), 33-44. doi:10.1145/203241.203251
[104] Raghu Ramakrishnan and Johannes Gehrke. 2002. Database Management Systems (3 ed.). McGraw-Hill, Inc., USA. https://dl.acm.org/doi/book/10.5555/560733
[105] P. Reisner. 1977. Use of Psychological Experimentation as an Aid to Development of a Query Language. IEEE Transactions on Software Engineering SE-3, 3 (1977), 218-229. doi:10.1109/TSE.1977.231131
[106] Edson Silva, Robson Fidalgo, Mircio Ferro, and Natalia Franco. 2023. Visual query languages to design complex queries: a systematic literature review. Software and Systems Modeling 22, 4 (2023), 1217-1249. doi:10.1007/s10270-022-01071-4
[107] Lovisa Sundin and Quintin Cutts. 2019. Is it feasible to teach query programming in three different languages in a single session?A study on a pattern-oriented tutorial and cheat sheets. In UKICER. ACM, Article 7, 7 pages. doi:10.1145/3351287.3351293
[108] Taylor W Webb, Steven M Frankland, Awni Altabaa, Simon Segert, Kamesh Krishnamurthy, Declan Campbell, Jacob Russin, Tyler Giallanza, Randall O'Reilly, John Lafferty, et al. 2024. The relational bottleneck as an inductive bias for efficient abstraction. Trends in Cognitive Sciences 28, 9 (2024), 829-843. doi:10.1016/j.tics.2024.04.001
[109] Max Wertheimer. 1938. Gestalt theory. In A source book of Gestalt psychology,W. D. Ellis (Ed.). Kegan Paul, Trench, Trubner & Company, 1-11. doi:10.1037/11496-001
[110] Wikipedia contributors. 2025. Categorical Proposition Wikipedia, The Free Encyclopedia. https://en.wikipedia.org/wiki/Categorical_proposition [Online;accessed March-2025].
[111] [n. d.]. Substrait: Cross-Language Serialization for Relational Algebra. https://substrait.io/
[112] 2025. sqlglot Abstract Syntax Tree (AST) Viewer. https://sqlglot-ast-viewer.streamlit.app/Accessed: 2025-08-05.
[113] Ailamaki et al. 2025. The Cambridge Report on Database Research. CoRRabs/2504.11259 (2025). doi:10.48550/ARXIV.2504.11259
[114] Aref et al. 2025. Rel: A Programming Language for Relational Data. In Companion of SIGMOD/PODS 2025. 283-296. doi:10.1145/3722212.3724450
[115] Buneman et al. 1994. Comprehension Syntax. SIGMOD Rec. 23, 1 (1994), 87-96. doi:10.1145/181550.181564
[116] Carey et al. 2024. SQL++: We Can Finally Relax!. In ICDE. 5501-5510. doi:10.1 109/ICDE60146.2024.00438
[117] Codd. 1982. Relational Database: A Practical Foundation for Productivity. CACM 25, 2 (1982), 109-117.
[118] Colgan. 2023. Outerjoins in Oracle. https://blogs.oracle.com/optimizer/post/outerjoins-in-oracle
[119] Date. 2004. An introduction to database systems (8 ed.). Pearson/Addison Wesley Longman. https://dl.acm.org/doi/10.5555/861613
[120] David. 1999. Advanced ANSI SQL data modeling and structure processing. Artech House, Boston.
[121] Deshpande. 2025. Beyond Relations: A Case for Elevating to the Entity-Relationship Abstraction, In CIDR. CoRR. doi:10.48550/ARXIV.2505.03536
[122] Dittrich. 2025. How to get Rid of SQL, Relational Algebra, the Relational Model, ERM, and ORMs in a Single Paper—A Thought Experiment. CoRR (2025). doi:10.48550/ARXIV.2504.12953
[123] Elmasri and Navathe. 2015. Fundamentals of database systems (7 ed.). AddisonWesley. https://dl.acm.org/doi/book/10.5555/2842853
[124] Fegaras and Maier. 2000. Optimizing object queries using an effective calculus.TODS 25, 4 (2000), 457-516. http://portal.acm.org/citation.cfm?id=377674.377676
[125] Floratou et al. 2024. NL2SQL is a solved problem . . . Not!. In CIDR. www.cidrdb. org.https://www.cidrdb. org/cidr2024/papers/p74-floratou.pdf
[126] Ganski and Wong. 1987. Optimization of Nested SQL Queries Revisited. In SIGMOD. 23-33. doi:10.1145/38713.38723
[127] Gatterbauer. 2024. A Comprehensive Tutorial on over 100 Years of Diagrammatic Representations of Logical Statements and Relational Queries. In ICDE. IEEE. Tutorial page: https://northeastern-datalab.github.io/diagrammatic-representation-tutorial/.
[128] Gatterbauer. 2024. A Principled Solution to the Disjunction Problem of Diagrammatic Query Representations. doi:10.48550/ARXIV.2412.08583
[129] Gatterbauer and Dunne. 2024. On The Reasonable Effectiveness of Relational Diagrams: Explaining Relational Query Patterns and the Pattern Expressiveness of Relational Languages. PACMMOD 2, 1, Article 61 (2024). doi:10.1145/3639316
[130] Gatterbauer and Dunne. 2025. Relational Diagrams and the Pattern Expressiveness of Relational Languages. SIGMOD Record 54, 1 (2025), 80-88. https://sigmodrecord.org/?smd_process_download=1&download_id=14010
[131] Grust and Scholl. 1999. How to Comprehend Queries Functionally. J. Intell. Inf. Syst. 12, 2-3 (1999), 191-218. doi:10.1023/A:1008705026446
[132] Guagliardo et al. 2025. Queries with External Predicates. In ICDT (LIPIcs, Vol. 328). 22:1-22:20. doi:10.4230/LIPICS.ICDT.2025.22
[133] Harel. 1988. On Visual Formalisms. Commun. ACM 31, 5 (1988), 514-530.
[134] Hella et al. 2001. Logics with aggregate operators. JACM 48, 4 (2001), 880-907. doi:10.1145/502090.502100
[135] Klug. 1982. Equivalence of Relational Algebra and Relational Calculus Query Languages Having Aggregate Functions. JACM 29, 3 (1982), 699-717. doi:10.1145/322326.322332
[136] Leventidis et al. 2020. QueryVis: Logic-based Diagrams help Users Understand Complicated SQL Queries Faster. In SIGMOD. 2303-2318. doi:10.1145/3318464.3389767
[137] Libkin. 2003. Expressive power of SQL. Theor. Comput. Sci. 296, 3 (2003), 379-404. doi:10.1016/S0304-3975(02)00736-3
[138] Libkin and Peterfreund. 2023. SQL Nulls and Two-Valued Logic. In PODS. 11-20. doi:10.1145/3584372.3588661
[139] Moerkotte. [n. d.]. Building query compilers. https://pi3.informatik.unimannheim.de/-moer/querycompiler.pdf
[140] Neumann and Leis. 2024. A Critique of Modern SQL and a Proposal Towards a Simple and Expressive Query Language. In CIDR. https://www.cidrdb.org/cidr2024/papers/p48-neumann.pdf
[141] Nix and Dittrich. 2025. Extending SQL to Return a Subdatabase. Proc. ACM Manag. Data 3, 3 (2025), 154:1-154:26. doi:10.1145/3725291
[142] Sabale and Gatterbauer. 2025. PatternVis: A Tool for Relational Pattern Visualization. In Companion of the SIGMOD 2025. 227-230. doi:10.1145/3722212.3725128
[143] Shaikhha et al. 2022. Functional collection programming with semi-ring dictionaries. PACMPL (OOPSLA1) 6 (2022), 1-33. doi:10.1145/3527333
[144] Shute et al. 2024. SQL has problems.We can fix them: Pipe syntax in SQL. PVLDB 17, 12 (2024), 4051-4063. doi:10.14778/3685800.3685826
[145] Souffle. 2023. https://souffle-lang.github.io/rules.
[146] Trinder. 1991. Comprehensions, a Query Notation for DBPLs. In DBPL3. 55-68.https://dl.acm.org/doi/10.5555/135260.135271
[147] Vinciguerra et al. 2025. Reproducibility Report for ACM SIGMOD 2024 Paper: ‘On The Reasonable Effectiveness of Relational Diagrams’. In Reproducibility Reports of SIGMOD 2024. 60-63. doi:10.1145/3687998.3717044

What is claimed is:

1. A method of providing a graphical representation of a logical formula, the method comprising:
based on logical scopes from a logical formula, partitioning a graphical space using one or more graphical elements;
placing tables in the graphical space partitioned, at least one table placed including a table reference based on the logical scopes and a table attribute based on predicates from the logical formula; and
based on the predicates and the logical scopes, displaying at least one connection between the tables placed, wherein the at least one connection indicates a given predicate and wherein logical scope of the given predicate is independent of endpoints of the at least one connection, the graphical space partitioned using the one or more graphical elements, the tables placed, and the at least one connection displayed providing a graphical representation of the logical formula.

2. The method of claim 1, further comprising at least one of:
parsing the logical formula to (i) extract the logical scopes and (ii) determine a hierarchy of the logical scopes, wherein the partitioning is based on the logical scopes and the hierarchy;
identifying the tables from the logical formula; and
identifying the predicates from the logical formula.

3. The method of claim 1, further comprising:
translating an initial logical formula into the logical formula, the logical formula being well-formed, and wherein the graphical representation is unambiguously translatable into the logical formula.

4. The method of claim 1, wherein:
the at least one connection includes at least one annotation.

5. The method of claim 4, further comprising:
based on the predicates and the logical scopes, identifying the endpoints of the at least one connection and the logical scope of the given predicate and adding the at least one annotation to the at least one connection displayed based on the endpoints and logical scope of the given predicate identified.

6. The method of claim 5, wherein:
the adding the at least one annotation includes positioning, based on the endpoints and the logical scope of the given predicate identified, the at least one annotation in the graphical space partitioned.

7. The method of claim 4, wherein the at least one annotation includes:
a label, an anchor, a line style, or an arrowhead.

8. The method of claim 4, wherein the at least one annotation indicates the given predicate is:
a join predicate, a selection predicate, an aggregation predicate, or an assignment predicate.

9. The method of claim 1, further comprising:
applying a non-constitutive simplification to the graphical representation provided, the non-constitutive simplification unambiguously preserving semantics of the graphical representation.

10. The method of claim 1, wherein:
a given table placed includes a constant based on the predicates from the logical formula.

11. The method of claim 1 further comprising:
using the graphical representation, translating the logical formula from a first language to a second language.

12. The method of claim 1, wherein:
the at least one connection displayed represents a logical relationship between a first table and a second table of the tables placed.

13. The method of claim 1, wherein each logical scope is an existential scope, a negation scope, a disjunction scope, or an aggregation scope.

14. The method of claim 1, wherein each predicate is a selection predicate, a join predicate, an aggregation predicate, or an assignment predicate.

15. The method of claim 1, wherein each table placed is a base table, a virtual table, or an output table.

16. The method of claim 1, wherein:
the graphical representation preserves a semantic and a relational pattern of the logical formula.

17. The method of claim 1, wherein:
the graphical representation uses a higraph notation, the higraph notation including a Unified Modeling Language (UML) notation diagram.

18. The method of claim 1, wherein at least one of:
the logical formula includes a disjunction; and
the logical formula is a Structured Query Language (SQL) statement.

19. A computer implemented system for providing a graphical representation of a logical formula, the system comprising:
a processor; and
a memory with computer code instructions stored thereon, the processor and the memory, with the computer code instructions, being configured to cause the computer implemented system to:
based on logical scopes from a logical formula, partition a graphical space using one or more graphical elements;
place tables in the graphical space partitioned, at least one table placed including a table reference based on the logical scopes and a table attribute based on predicates from the logical formula; and
based on the predicates and the logical scopes, display at least one connection between the tables placed, wherein the at least one connection indicates a given predicate and wherein logical scope of the given predicate is independent of endpoints of the at least one connection, the graphical space partitioned using the one or more graphical elements, the tables placed, and the at least one connection displayed providing a graphical representation of the logical formula.

20. A method of providing a graphical representation of a logical formula, the method comprising:
based on logical scopes from a logical formula, partitioning a graphical space using one or more graphical elements;
placing tables in the graphical space partitioned, at least one table placed including a table reference based on the logical scopes and a table attribute based on predicates from the logical formula; and
based on the predicates and the logical scopes, displaying at least one connection between the tables placed, wherein the at least one connection (i) indicates a given predicate and (ii) includes at least one annotation unambiguously representing the given predicate as an aggregation predicate or an assignment predicate, the graphical space partitioned using the one or more graphical elements, the tables placed, and the at least one connection displayed providing a graphical representation of the logical formula.
